(19) United States
(12) Patent Application Publication
(10) Pub. No.: US 2019/0089193 A1
(43) Pub. Date: Mar. 21, 2019

(54) SYSTEMS AND METHODS FOR TRACKING CONSUMPTION MANAGEMENT EVENTS

(71) Applicant: ELUTIONS Inc., Tampa, FL (US)

(72) Inventors: Nitin Ranjan, Saint Petersburg, FL (US); David J. Mader, Dousman, WI (US)

(73) Assignee: Elutions IP Holdings S.à.r.l., Luxembourg (LU)

(21) Appl. No.: 15/709,230

(22) Filed: Sep. 19, 2017

Related U.S. Application Data
(63) Continuation of application No. 15/708,113, filed on Sep. 18, 2017.

(51) Int. Cl. H02J 13/00; G05B 19/042

(52) U.S. Cl. CPC H02J 13/0003; G06F 3/04847; G05B 2219/23258; G05B 19/0426

(57) ABSTRACT

Systems and methods for managing resource consumption. A plurality of event records may be stored, corresponding, respectively, to a plurality of consumption management events. Each event record of the plurality of event records may comprise: information indicative of a current state of the corresponding consumption management event; and information indicative of a time at which the corresponding consumption management event moved into the current state from a prior state. A state transition diagram may be displayed based on at least one event record of the plurality of event records, wherein: the state transition diagram comprises a plurality of states and a plurality of transitions; the plurality of states comprises a first state and a second state; and the plurality of transitions comprises a transition from the first state to the second state.

### RELATED APPLICATIONS

This application is a continuation claiming the benefit under 35 U.S.C. § 120 of U.S. application Ser. No. 15/708,113, filed on Sep. 18, 2017, entitled “SYSTEMS AND METHODS FOR CONFIGURING DISPLAY LAYOUT,” bearing Attorney Docket No. E0533.70002US00. Application Ser. No. 15/708,113 was filed on the same day as International Application No. PCT/US17/52115, entitled “SYSTEMS AND METHODS FOR MANAGING RESOURCE CONSUMPTION,” bearing Attorney Docket No. E0533.70000WO00, and International Application Serial No. PCT/US17/52092, entitled “SYSTEMS AND METHODS FOR DISPLAYING RESOURCE SAVINGS,” bearing Attorney Docket No. E0533.70001WO00. Each of these applications is hereby incorporated by reference in its entirety.

### BACKGROUND

Increasingly, both public and private enterprises rely on computer systems to monitor and control resource consumption of various equipment such as heating, ventilation, and air conditioning (HVAC), refrigeration, lighting, and/or mechanical load. These computer systems process vast amounts of data (e.g., sensor data received in real time from individual assets) to identify opportunities for resource conservation. For example, a recommendation may be made to operate an asset in a different manner, so that less energy may be used while maintaining a certain level of service. Such a recommendation may be implemented automatically, or may be reviewed and approved by a human user prior to implementation.

An effective consumption management system may significantly reduce an enterprise's environmental footprint, as well as operating costs.

### SUMMARY

In some embodiments, a consumption management system is provided, comprising: at least one storage medium storing data associated with a hierarchical display layout, the hierarchical display layout comprising first, second, and third areas, wherein each of the second and third areas is nested within the first area; and at least one processor programmed to: detect a display size; determine a size of the first area based at least in part on the detected display size; and determine a size of the second area based at least in part on a size of the first area and stored data associated with the second area.

In some embodiments, a consumption management system is provided, comprising: at least one storage medium storing a plurality of event records corresponding, respectively, to a plurality of consumption management events, wherein each event record of the plurality of event records comprises: information indicative of a current state of the corresponding consumption management event; and information indicative of a time at which the corresponding consumption management event moved into the current state from a prior state; at least one processor programmed to cause a state transition diagram to be displayed based on at least event record of the plurality of event records, wherein: the state transition diagram comprises a plurality of states and a plurality of transitions; the plurality of states comprises a first state and a second state; and the plurality of transitions comprises a transition from the first state to the second state.

In some embodiments, a method is provided, as performed by either of the above systems.

In some embodiments, at least one computer-readable storage medium is provided, storing executable instructions that, when executed, cause at least one processor to perform the above method.

### BRIEF DESCRIPTION OF DRAWINGS

FIG. 1 shows an illustrative consumption management system 100, in accordance with some embodiments.

FIGS. 2A-2B show, respectively, an illustrative virtual meter 210 and an illustrative virtual meter 252, in accordance with some embodiments.

FIGS. 3A-3F show an illustrative object tree 300 for organizing resource consumption data, in accordance with some embodiments.

FIG. 4 shows an illustrative state transition diagram 400 for a consumption management event, in accordance with some embodiments.

FIG. 5 shows an illustrative home page 500 for a user interface of a consumption management system, in accordance with some embodiments.

FIG. 6A shows an illustrative layout 600 that may be used for one or more pages within a user interface of a consumption management system, in accordance with some embodiments.

FIG. 6B shows an illustrative hierarchical grid 610, in accordance with some embodiments.

FIG. 6C shows an illustrative tree 630 representing a recursive process for constructing a hierarchical grid, in accordance with some embodiments.

FIG. 6D shows an illustrative process 640 for configuring a layout, in accordance with some embodiments.

FIGS. 6E-6G show, respectively, illustrative layouts 650, 652, and 654, in accordance with some embodiments.

FIGS. 7A-7H show, respectively, illustrative pages 700A-H of a savings center, in accordance with some embodiments.

FIGS. 8A-8L show, respectively, illustrative pages 800A-L of an events center, in accordance with some embodiments.

FIGS. 9A-9J show, respectively, illustrative pages 900A-J of a sites center, in accordance with some embodiments.

FIGS. 10A-10C show, respectively, illustrative pages 1000A-C of an intelligence center, in accordance with some embodiments.

FIGS. 11A-11J show, respectively, illustrative pages 1100A-J of a trend viewer dashboard, in accordance with some embodiments.

FIGS. 12A-12D show, respectively, illustrative pages 1200A-D of a heat map dashboard, in accordance with some embodiments.

FIGS. 13A-B show, respectively, illustrative pages 1300A-B of a correlation analysis dashboard, in accordance with some embodiments.

FIG. 14 shows, schematically, an illustrative computer 10000 on which any aspect of the present disclosure may be implemented.

### DETAILED DESCRIPTION

The inventors have recognized and appreciated various technical challenges in building a consumption management system.

For instance, the inventors have recognized and appreciated that some consumption management systems are designed to monitor and control specific types of equipment (e.g., HVAC, refrigeration, lighting, mechanical load, etc.). Such a system may be able to handle only a certain type of input data (e.g., operating parameters of HVAC equipment), and it may be impractical to extend such a system to handle another type of input data (e.g., operating parameters of mechanical equipment). As a result, an enterprise that operates different types of equipment may have to use disparate consumption management systems.

The inventors have recognized and appreciated that it may be desirable to provide a more scalable consumption management system. Accordingly, in some embodiments, techniques may be provided for modeling various types of equipment in a unified manner. For instance, techniques may be provided for processing and storing data from multiple, disparate sources in a unified manner. One or more of these techniques may allow a consumption management system to be deployed in any vertical (e.g., telecommunication, cloud computing, retail, public utility, education, hospitality, manufacturing, transportation, etc.) to manage any type of resource consumption (e.g., electricity, gas, water, etc.).

The inventors have further recognized and appreciated that some consumption management systems provide recommendations without quantifying expected benefits. As a result, there may be little guarantee that resource consumption would actually be reduced by implementing a recommendation. Moreover, even if resource consumption would be reduced by implementing a recommendation, there may be no indication of how much reduction could be expected. Without such information, a user may not be able to make an informed decision on whether to implement the recommendation.

Accordingly, in some embodiments, techniques are provided for quantifying expected cost savings associated with a proposed measure to manage consumption. The inventors have recognized and appreciated that it may be efficient to identify opportunities to reduce consumption and simultaneously calculate expected cost savings. For instance, in some embodiments, a rules engine may apply one or more rules to identify opportunities to reduce consumption, and may output proposed measures for reducing consumption, along with estimated cost savings. In this manner, a user may be able to make informed decisions on whether to implement the proposed measures. Furthermore, in some embodiments, actual savings may be determined after one or more proposed measures have been implemented, and may be compared with the estimated savings output by the rules engine. This comparison may be used to adapt one or more rules used by the rules engine (e.g., using one or more machine learning techniques), so that more accurate estimates of savings may be produced in the future.

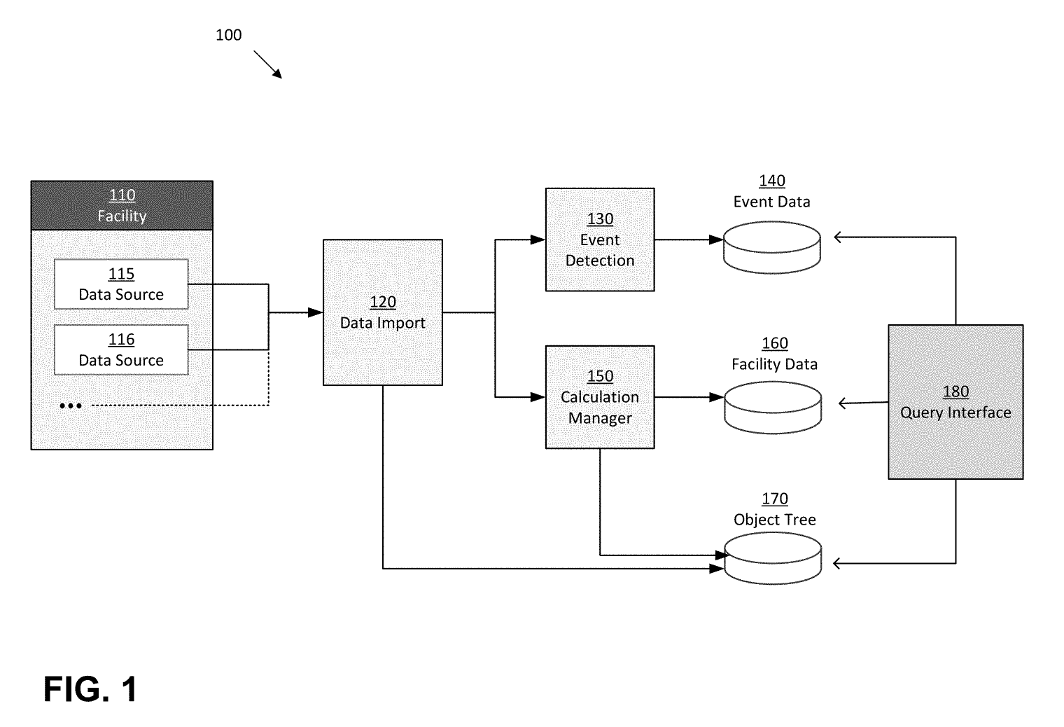

FIG. 1 shows an illustrative consumption management system 100, in accordance with some embodiments. In the example of FIG. 1, the consumption management system 100 imports data from data sources 115, 116, . . . of a facility 110. The consumption management system may check, correct, perform calculations on, and/or otherwise process the imported data to produce structured data that may be readily accessed via a query interface 180, which may include an application programming interface (API) and/or a user interface. For instance, in some embodiments, a query engine may be provided for querying one or more databases in the consumption management system 100.

In some embodiments, the consumption management system 100 may maintain one or more data stores. As an example, the consumption management system 100 may maintain an object tree 170, which may be a hierarchical data structure for organizing data in a logical manner that facilitates rapid retrieval. As another example, the consumption management system 100 may maintain a facility data store 160, which may include data assembled from various data sources, such as data imported from the data sources 115, 116, . . . , and/or one or more quantities derived from the imported data. As yet another example, the consumption management system 100 may maintain an event data store 140, which may indicate, based on the imported data, identified resource consumption recommendations with associated quantified expected benefits. As explained further below, the inventors have recognized and appreciated various benefits provided by maintaining data stores such as the object tree 170, the facility data store 160, and/or the event data store 140. However, it should be appreciated that aspects of the present disclosure are not limited to the use of any particular one of these data stores.

In some embodiments, the consumption management system 100 may be hosted on one or more computing devices that are located remotely from the facility 110. For instance, the consumption management system 100 may receive data from the data sources 115, 116, . . . via one or more networks (e.g., the Internet). In some embodiments, one or more communications to and/or from the consumption management system 100 may be encrypted to protect privacy. For example, a secure tunnel may be established between the consumption management system 100 and a local network at the facility 110 (e.g., using a virtual private network technology). However, it should be appreciated that aspects of the present disclosure are not limited to the use of any secure tunnel. For instance, in some embodiments, one or more components of the consumption management system 100 may be hosted on one or more computing devices on a local network at the facility 110.

In the example of FIG. 1, the facility 110 may be a site operated by an enterprise (e.g., utility company, healthcare organization, university, cloud computing provider, retail chain, etc.), and may include one or more parts of a building, an entire building, and/or a plurality of buildings where one or more pieces of energy consuming equipment may be located. For instance, the facility 110 may include a water treatment plant, a hospital, a university campus, a data center, a grocery store, a factory, a bakery, a farm, etc. The data sources 115, 116, . . . may provide various types of data collected from the facility 110. Such data may be indicative of one or more aspects of operation of the facility 100.

Although not shown in FIG. 1, the consumption management system 100 may, in some embodiments, receive data from one or more facilities other than the facility 110. Each such facility may be operated by a same enterprise or different enterprises, and may include any suitable combination of one or more data sources.

In some embodiments, a data source may include a sensor installed at the facility 110. The sensor may obtain data from an environment at the facility 110, and may produce data indicative of that environment. Examples of sensors include, but are not limited to, an electrical load sensor, temperature sensor, motion sensor, air flow meter, chemical detector (e.g., ozone monitor, carbon monoxide detector, etc.), current detector, voltage detector, hygrometer, barometer, etc., and suitable combinations thereof. It will be appreciated that such a sensor may be coupled to equipment having one or more properties that are sensed by the sensor. For instance, an electrical load sensor may be coupled to an electrical meter, and may read an electrical load present within the meter and produce data indicative of said load.

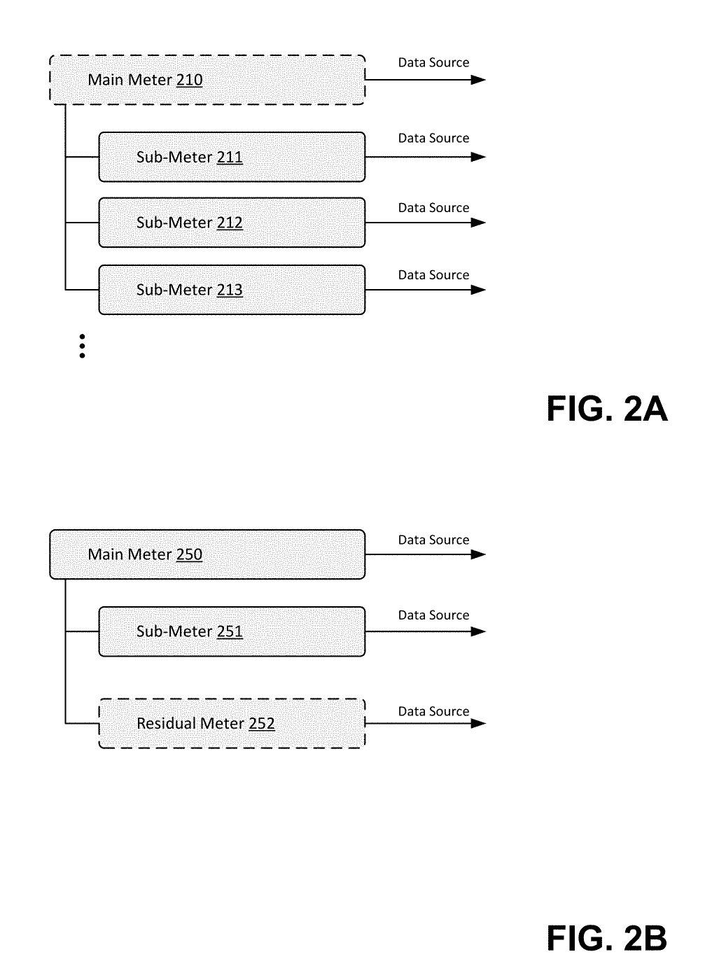

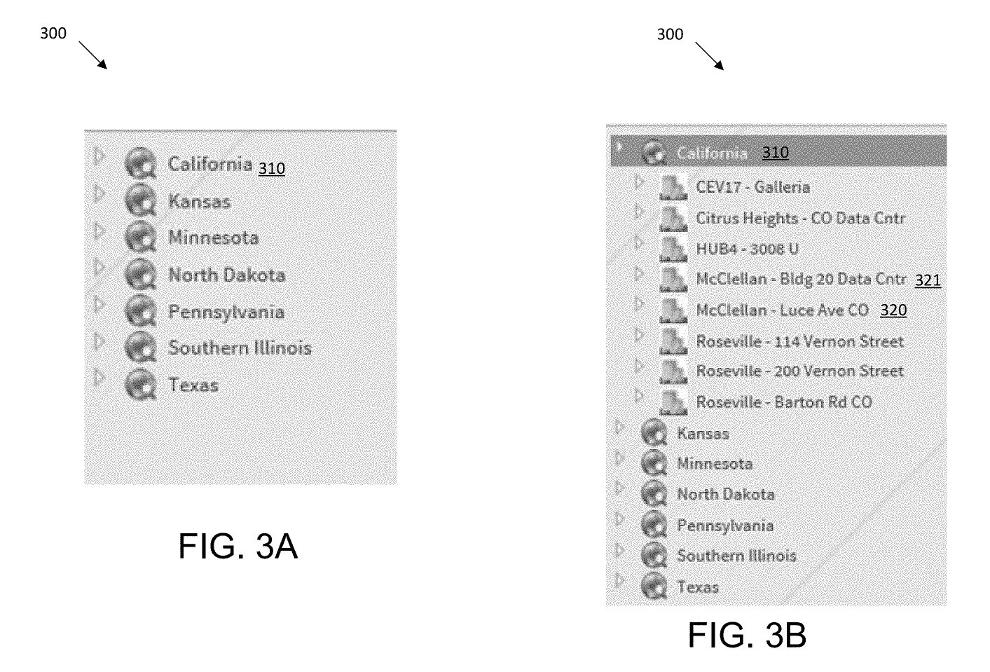

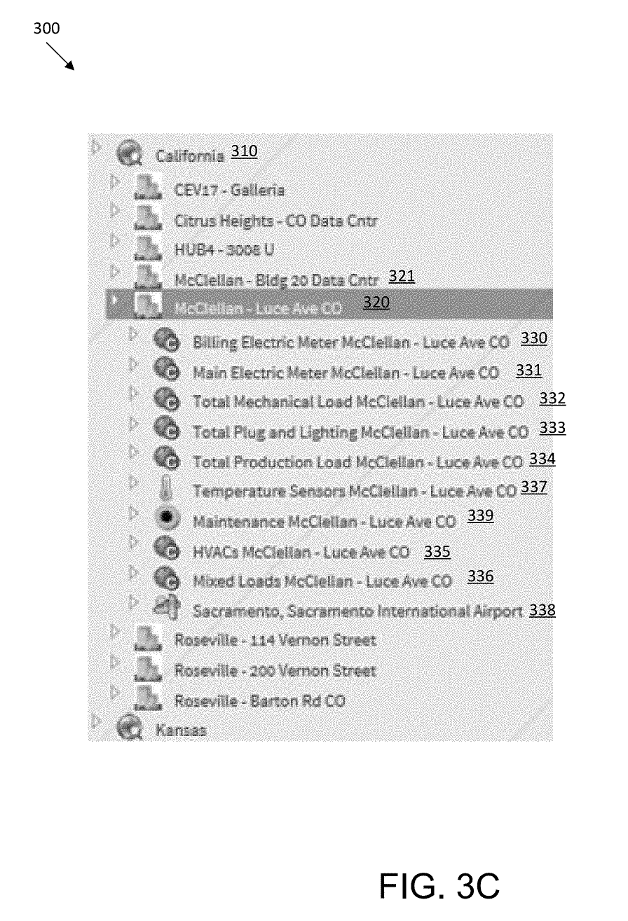

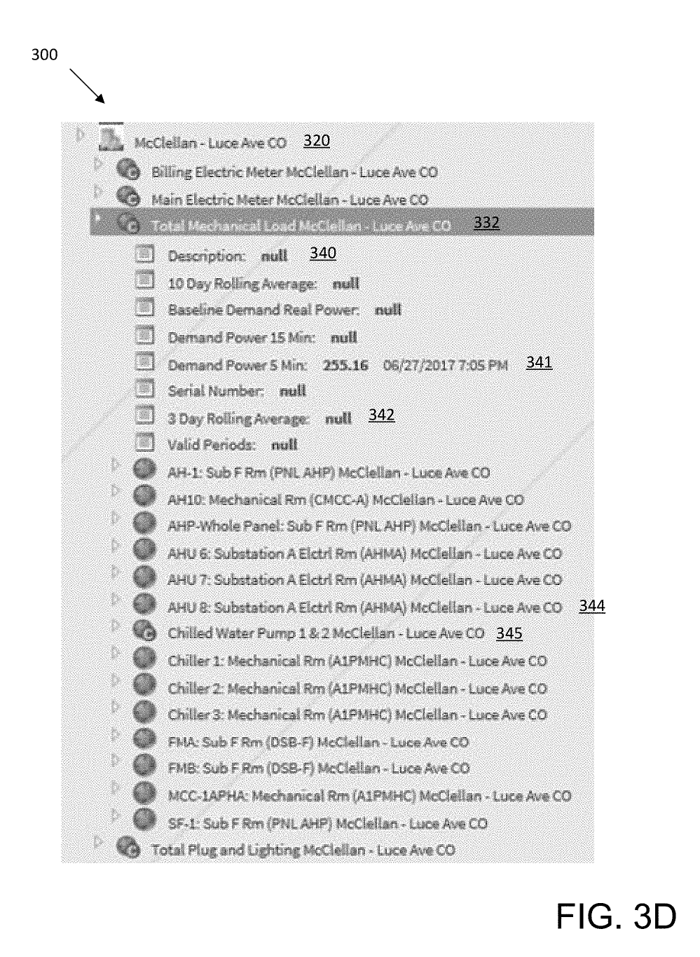

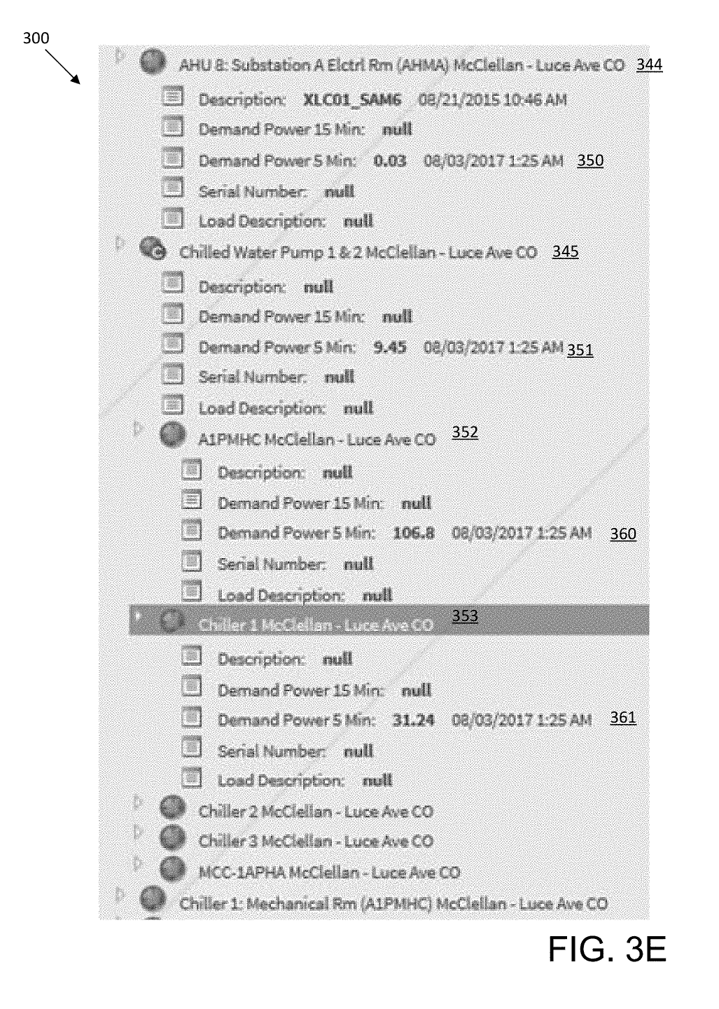

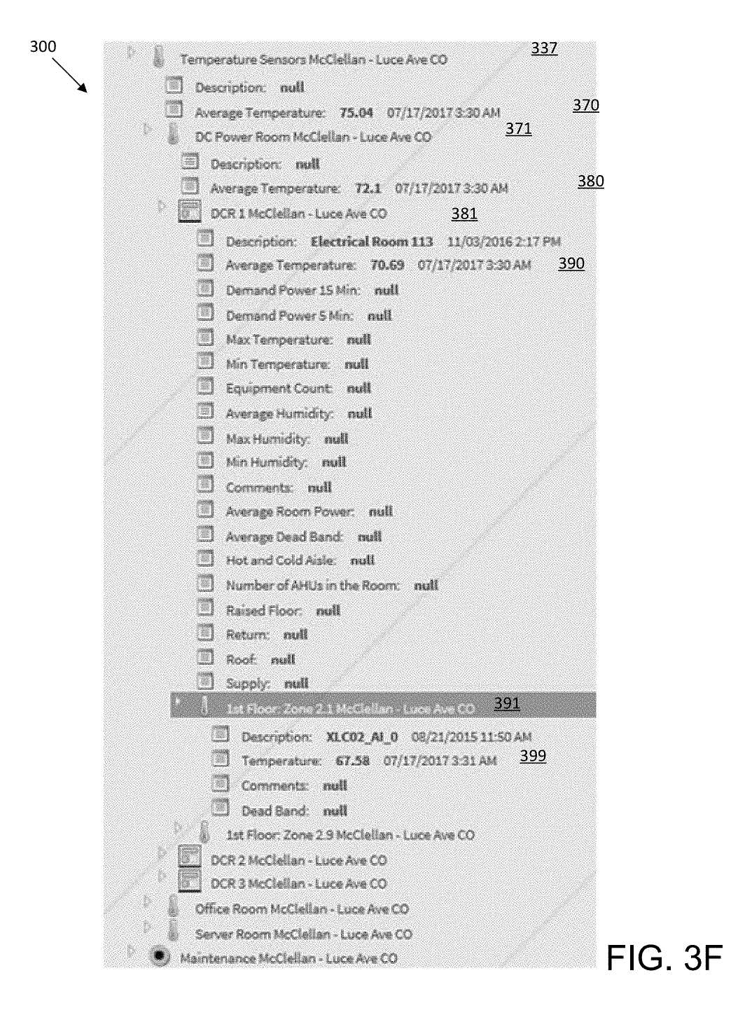

The inventors have recognized and appreciated that availability of more data may provide a fuller picture of what is happening at a facility. This may allow a consumption management system to perform analysis in a more fine grained manner, which may in turn lead to improved energy efficiency. However, the inventors have also recognized and appreciated that over-instrumentation may be costly, and may increase data volume and/or complexity. Increased data volume and/or complexity may prevent a consumption management system from performing certain analyses in real time, which may delay recommendations that would have reduced resource consumption. Accordingly, in some embodiments, sensors may be deployed in a structured manner to facilitate efficient processing and/or storage of data. Examples of structured deployment of sensors are discussed below in connection with FIGS. 2B, 3A-3F.

In some embodiments, the facility 110 may include one or more computing devices configured to interface with, respectively, one or more of the data sources 115, 116, . . . For instance, the data sources 115, 116, . . . may produce data in differing formats and/or transmit data using differing protocols. Examples of native formats include, but are not limited to, Comma Separated Values (CSV) files, Remote Terminal Unit (RTU) data, etc. Examples of protocols include, but are not limited to HTTP, HTTPs, TCP/IP, serial communication protocols, BACnet, Modbus TCP/IP, etc. Accordingly, a computing device at the facility 110 may execute selected driver software, and/or include selected hardware, to receive and/or appropriately interpret data from a certain data source.

In some embodiments, a plurality of drivers may process native data from, respectively, a plurality of data sources that utilize different data formats and/or different transmission protocols, and may produce data having a common format (e.g., a data record format containing multiple data fields), for example, using appropriate interface protocols. Thus, the drivers may convert native data from disparate sources into standardized data, which may be more readily consumed by the consumption management system 100. In this manner, the consumption management system 100 may be programmed to execute on incoming data irrespective of how, or by what device, the data was produced. Such an approach may reduce a need for the consumption management system 100 to perform specialized data handling, which in turn may allow the consumption management system 100 to be deployed for any resource type, any enterprise, and/or any vertical.

In the example of FIG. 1, the consumption management system 100 includes a data import module 120, an event detection module 130, and a calculation manager module 150. Any one or more of these modules may be executed by one or more computing devices at the facility 110, or at a different physical location. For instance, in some embodiments, a server (or a cluster of servers) may execute the modules 120, 130, and 150.

In some embodiments, the data import module 120 may be programmed to cleanse data received from the data sources 115, 116, . . . For instance, the data import module 120 may be programmed to check and/or correct incoming data to ensure that data passed to one or more downstream modules meets some appropriate standard of validity. As an example, a data validity check may comprise application of one or more appropriate validity rules to determine whether a valid data value is provided for a data field. Examples of validity rules include, but are not limited to, rules relating to expected data type, expected data range (e.g., temperature values below −50° C., a weight less than zero, a negative power demand, a value that is more than some number, say, 10, standard deviation away from a rolling average such as a 3-day average or a 10-day average, etc., may be considered invalid), presence of expected data values, sudden change in data values (e.g., increase between consecutive samples larger than certain threshold, say, 200%, may be considered invalid), etc., and suitable combinations thereof.

In some embodiments, the data import module 120 may be programmed to take one or more corrective actions in response to identifying an invalid or missing data value (also referred to herein as a “defect”). As one example, an invalid or missing data value in a data field may be addressed by contacting an appropriate data source and attempting to correct or recover the data value, if possible. As another example, an invalid or missing data value in a data field may be addressed using a selected constant value for that data field (e.g., some nominal value for the data field). As another example, an invalid or missing data value in a data field may be addressed using a value produced by interpolating (or otherwise predicting from) other data values of the same data field (e.g., from one or more data values produced earlier and/or one or more data values produced later).

As another example, an invalid or missing data value may be addressed using an historically-appropriate value based on an expectation that the data value would have, if present and valid, been similar to historical observations. For instance, an invalid or missing data value may be addressed using a data value obtained for the same data field at an earlier time, such as the same time a day earlier, or a week earlier. In some embodiments, an historically-appropriate value may be used, in some embodiments, only when certain conditions are met, such as when the earlier time was similar in some manner to a time of the invalid or missing data value based on one or more external factors (e.g., correct a resource consumption data value with a historical data value only when the weather is similar on both days). For instance, a linear regression expression on degree days or opening hours may be used, or a previous time period may be selected that has similar conditions (e.g., no more than a maximum allowed difference for each correlated parameter).

It should be appreciated that aspects of the present disclosure are not limited to taking any particular type of corrective action, or any corrective action at all. In some embodiments, an appropriate corrective action may be selected based on one or more factors, such as a type of a data field exhibiting a defect and/or a type of the defect.

In the example of FIG. 1, the data import module 120 is programmed to populate one or more hierarchical data structures, such as the object tree 170, based on data received from the data sources 115, 116, . . . The inventors have recognized and appreciated that, while one or more databases may be used to store the received data, database queries may be slow, which may negatively impact response time of the consumption management system 100. For instance, when a user requests certain information (e.g., average daily resource consumption over a certain past period of time for a certain load type, such as refrigeration, in a certain geographical region), the consumption management system 100 may query one or more databases to retrieve relevant data (e.g., hourly consumption values for individual refrigeration units in all sites in the specified geographical region within the specified period of time), and perform one or more calculations on retrieved data to provide the requested information (e.g., aggregating hourly consumption values for individual refrigeration units into daily consumption values, then aggregating across all refrigeration units at each site, then aggregating across all sites in the specified geographical region, and then averaging over the specified period of time). It may take the consumption management system 100 quite some time to respond (e.g., several seconds or tens of seconds) due to a large number of database queries and/or calculations that may be performed. Accordingly, in some embodiments, a hierarchical data structure may be used organize data in a manner that facilitates rapid retrieval.

The inventors have recognized and appreciated certain commonalities in how resources are consumed across different enterprises in different verticals. For instance, regardless of which vertical an enterprise is in, the enterprise may include one or more sites, which may be grouped by geographical location (e.g., country, region, state, county, city, neighborhood, etc.). A site may consume one or more types of resources (e.g., gas, electricity, water, etc.), and may include one or more buildings. A building may house one or more pieces of resource consuming equipment, which may be grouped based on load type (e.g., lighting, refrigeration, HVAC, mechanical load, etc.). A piece of resource consuming equipment (also referred to herein as an “asset”) may have one or more associated properties, such as a static property (e.g., name, serial number, installation date, etc.), a dynamic property (e.g., for a boiler, supply temperature, return temperature, set point, demand power, etc.), and/or a derived property (e.g., cumulative energy consumption in current day, week, month, year, or some other suitable period). Thus, in some embodiments, a hierarchical data structure, such as the object tree 170 in the example of FIG. 1, may be used to model resource consumption within an enterprise, regardless of which vertical the enterprise is in.

The inventors have recognized and appreciated that a hierarchical data structure may be accessed more efficiently than a database. Furthermore, the inventors have recognized and appreciated that a derived property of an asset may be updated as relevant data is received through the data import module 120. In this manner, a most up-to-date value of the derived property may always be available, so there may be no need to calculate such a value when a user request is received. One or both of these techniques (i.e., hierarchical data structure and/or derived property) may be used to reduce response time of the consumption management system 100. However, it should be appreciated that neither technique is required.

In the example of FIG. 1, the calculation manager module 150 may be programmed to perform one or more calculations based on data values received from the data import module 120, and to store results of said calculations in the facility data store 160. Additionally, or alternatively, the calculation manager module 150 may store results of calculations in the object tree 170. For instance, in some embodiments, the calculation manager module 150 may calculate a most up-to-date value of a derived property of an asset in the object tree 170, as discussed above. Additionally, or alternatively, the calculation manager module 150 may perform aggregations by traversing the object tree 170 (e.g., aggregating consumption of all refrigeration units within a building, site, region, etc.).

The calculation manager module 150 may be programmed to calculate any suitable type of derived quantity. For instance, the calculation manager module 150 may be programmed to evaluate a function of one or more data fields. This may include accessing current values of the one or more data fields, and performing one or more arithmetic operations on those values and/or one or more constant values. For instance, a derived quantity Q may be calculated by the calculation manager module 150 as:

Q=0.3×(Value of Data Field A)+(Value of Data Field B).

In some embodiments, a data field value used by the calculation manager module 150 to calculate a derived quantity may itself also be a derived quantity. For instance, a derived normalized electricity consumption value may be calculated by the calculation manager module 150 by dividing a data value indicating electricity consumption for a given physical space by a data value indicating a size of the physical space (e.g., producing a value in units of kWh/m2), where the data value indicating electricity consumption for the physical space may itself be calculated by the calculation manager module 150 as a sum of electricity consumption of all electrical appliances located in the physical space.

The inventors have recognized and appreciated that the calculation manager module 150 may be used, in some embodiments, to ensure that certain performance indicators (such as the normalized electricity consumption value discussed above) are constantly (or periodically) updated as new data arrives, so that most up-to-date values of the performance indicators are always readily available. This may reduce response time of the consumption management system 100 by reducing on-the-fly calculations when a user requests such performance indicators (e.g., to determine how efficiently aspects of an enterprise's operation are functioning).

In some embodiments, the calculation manager module 150 may be programmed to calculate and/or store historical data for one or more data fields. For instance, it may be desirable to track data values produced by one or more of the data sources 115, 116, . . . over a period of time (e.g., past week, month, year, etc., or some other suitable period). Such data values may be stored in the facility data store 160 as received from the data import module 120. Additionally, or alternatively, derived data values may be calculated and stored as historical data. For example, the calculation manager module 150 may access hourly values of electricity consumption recorded within a past week for a given physical space, and may sum those values to yield a cumulative consumption value for the past week. The cumulative consumption value (which may be stored as a derived quantity, or merely utilized in a present calculation) may be divided by 7 (representing days in a week), and by a data value indicating a size of the physical space, to produce a normalized daily average consumption value (e.g., in units of kWh/Day/m2).

In the example of FIG. 1, the event detection module 130 is programmed to compare received data values with predetermined set points to determine whether an anomaly has occurred. In some embodiments, a set point may represent a desired operating state of an asset. For instance, the set point may be chosen to improve resource utilization. An anomaly may be triggered if the asset is programmed to operate above (or below) the set point. When an anomaly is identified, an event is generated in event data 140, which comprises information about the anomalous event.

As referred to herein, an anomaly encompasses any observance of one or more data values that are in some way unexpected given historical or otherwise anticipated values of the relevant data fields. Any number of set points for a data field may be set based on such expectations so that, if values of the data field deviate from the defined set point(s), event detection module 130 may produce an event comprising details about said deviation. Multiple types of anomalies and therefore multiple set points may be set for a given data field or combination of data fields. For example, a data field representing a water flow rate through a pump may have a set point set so that if the water flow rate falls to zero (or close to zero), event detection module 130 may generate an event indicating that the pump may be inoperable. In addition, a set point may be set for the same data field as a range of water flow rates that represent nominal flow values for the pump. If the water flow rate is measured to be outside of this range, event detection module 130 may generate an event indicating an anomaly in the water flow rate that is different from the event indicating a potentially inoperable pump.

According to some embodiments, the event detection module 130 executes a rules engine that examines incoming data values to determine what occurred that gave rise to the anomaly whilst also calculating cost savings associated with correction of the anomaly. The rules engine may be configured based on expected cost savings for a particular customer so that the conditions that, when evaluated, determine that an anomaly has occurred also calculate expected cost savings associated with correction of the anomaly based on these conditions. For instance, based on the above example of a water pump, when the rules engine determines that the water flow rate has fallen to zero, the expected savings may be simultaneously calculated based on the expected cost of replacing or repairing the water pump, whereas when the rules engine alternatively determines that the water flow rate is measured to be outside of the range set point, the expected savings may be simultaneously calculated based on how much money would be saved were the water flow rate adjusted to be within the range. In the latter case, calculations of expected savings may, for example, take into account expected effects on other parts of the facility that are causally linked with the water pump (e.g., up- or downstream parts), costs of performing adjustments on the system, expected changes in lifetime of the pump, etc.

In the example of FIG. 1, the query interface 180 may be programmed to access the object tree 170, the facility data store 160, and/or the event data store 140. For instance, the query interface 180 may include a query API that may be used by other components of the consumption management system 100 to run queries against stored data.

In some embodiments, the query interface 180 may include one or more user interfaces configured to allow a user to browse some or all of the stored data. For instance, the query interface 180 may include a web-based thin client programmed to provide various user interfaces via a web browser. A web server may formulate a query based on user input received via the web browser and one or more networks, issue the query via the query API, and transmit a result of the query to the web browser via the one or more networks. The web browser may present the result to the user. Additionally, or alternatively, the query interface 180 may include a mobile device app programmed to provide various user interfaces. The mobile device app may formulate a query based on user input, transmit the query via one or more networks to the query API, receive a result of the query via the one or more networks, and present the result to the user.

In some embodiments, access to the object tree 170, the facility data store 160, and/or the event data store 140 may be controlled via one or more suitable access control mechanisms. For instance, a first enterprise may have multiple facilities. A user at a certain facility may be granted access only to data pertaining to that facility, whereas a user at a headquarters may be granted access to data pertaining to all facilities within the first enterprise. On the other hand, a user from a second enterprise may be granted access only to data pertaining to the second enterprise, and may not be granted access to any data pertaining to the first enterprise.

Although various details of implementation are shown in FIG. 1 and discussed above, it should be appreciated that aspects of the present disclosure are not limited to the use of any particular component, or combination of components, or to any particular arrangement of components. For instance, it should be appreciated that the object tree 170, the facility data store 160, and/or the event data store 140 may be stored within a same database, in any number of different databases, or represented in any other suitable manner, such as by storing data in flat files (e.g., XML files). Furthermore, each component may be implemented in any suitable manner, such as using one or more parallel processors operating at a same location or different locations.

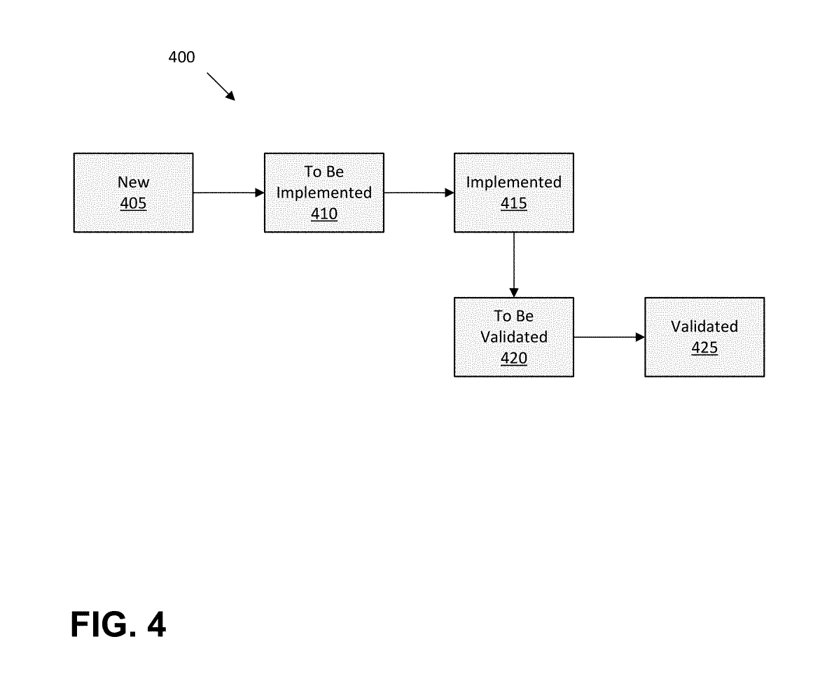

FIGS. 2A-2B show, respectively, an illustrative virtual meter 210 and an illustrative virtual meter 252, in accordance with some embodiments. In the example of FIG. 2A, a sensor may be installed at each of a plurality of lighting units to measure electricity consumption of that unit. These sensors may correspond, respectively, to sub meters 211, 212, 213, . . . shown in FIG. 2A. A virtual lighting meter, shown as main meter 210 in FIG. 4A, may be obtained by summing electricity consumption measurements from the individual lighting units. In some embodiments, values provided by the virtual lighting meter may be stored in an object tree, as discussed in detail in connection with FIGS. 3A-3F.

In the example of FIG. 2B, an electric panel may serve a refrigeration unit and multiple lighting units. A first sensor may be installed to measure electricity consumption of the electric panel (i.e., combined electricity consumption of the refrigeration unit and the multiple lighting units), and a second senor may be installed to measure electricity consumption of the refrigeration unit alone. The first and second sensors may correspond, respectively, to main meter 250 and sub meter 251 shown in FIG. 2B. A virtual lighting meter, shown as residual meter 252 in FIG. 2B, may then be obtained by subtracting the refrigeration unit's electricity consumption measurement from the combined consumption measurement. However, it should be appreciated that aspects of the present disclosure are not limited to the use of a virtual meter to obtain a consumption value, as in some embodiments a site may have a main switch board feeding all equipment of a certain type (e.g., mechanical, lighting, etc.), and a sensor may be installed at the main switch board to obtain a consumption value for that equipment type.

In some embodiments, a virtual data source (e.g., the illustrative virtual meter 210 in the example of FIG. 2A, or the illustrative virtual meter 252 in the example of FIG. 2B) may be calculated by one or more computing devices located at a facility (e.g., executing appropriate driver software). Alternatively, or additionally, a virtual data source may be calculated by a component of a consumption management system (e.g., the illustrative calculation manager module 150 in the example of FIG. 1), which may execute on one or more computing devices located remotely from the facility.

The inventors have recognized and appreciated that virtual data sources may be used to provide flexibility in how data is collected and/or analyzed. For instance, in the example of FIG. 2B, there may be a large number of individual lighting units, and it may be costly to install a sensor at each lighting unit. Therefore, it may be more cost effective to measure the combined electricity consumption of the refrigeration unit and the multiple lighting units, and then subtract the electricity consumption of the refrigeration unit, even though the combined electricity consumption measurement, by itself, may be not useful to a consumption management system (e.g., because the combined electricity consumption measurement mixes two different consumption categories, refrigeration and lighting). Moreover, the use of a virtual data source may improve transparency. For instance, a component of a consumption management system that uses a virtual data source may be unaffected by changes in how the virtual data source is implemented. However, it should be appreciated that aspects of the present disclosure are not limited to the use of a virtual data source.

FIGS. 3A-3F show an illustrative object tree 300 for organizing resource consumption data, in accordance with some embodiments. For instance, the object tree 300 may be a portion of the illustrative object tree 170 in the example of FIG. 1, and may be used to model resource consumption within an enterprise.

As discussed above, the inventors have recognized and appreciated certain commonalities in how resources are consumed across different enterprises in different verticals. The inventors have further recognized and appreciated that these commonalities may be exploited to provide a hierarchical structure that may be easily adapted for any enterprise in any vertical. For instance, an enterprise may operate one or more sites, which may be grouped by geographical region. Accordingly, in the example of FIG. 3A, the object tree 300 includes a plurality of nodes corresponding respectively to different geographical regions, such as a node 310 corresponding to California. In some embodiments, each node corresponding to a geographical region may have one or more child nodes corresponding, respectively, to different sites located in that region. For instance, in the example of FIG. 3B, the node 310 has a plurality of child nodes corresponding, respectively, to different sites located in California, such as a node 320 corresponding to a site named “McClellan—Luce Ave CO.”

The inventors have recognized and appreciated that sites within the object tree 300 may be organized in a manner that matches an enterprise's organizational structure (e.g., grouped by geographical region), so that a user already familiar with the enterprise's organizational structure may be able to quickly find a site within the object tree 300. However, it should be appreciated that aspects of the present disclosure are not limited to grouping sites in any particular manner, or any grouping at all. For instance, in some embodiments, one or more sites may be found at a top level of an object tree (e.g., arranged in alphabetical order based on site name).

Furthermore, in some embodiments, a corporate branch within the enterprise's organizational structure may include multiple buildings or multiple groups of buildings, each of which may be represented by a different node in the object tree. For instance, in the example shown in FIG. 3C, the node 320 (“McClellan—Luce Ave CO”) and a node 321 (“McClellan—Bldg 20 Data Cntr”) may represent, respectively, different buildings at a same corporate branch (“McClellan”).

As discussed in connection with FIG. 1, the inventors have recognized and appreciated that a hierarchical data structure such as the object tree 300 shown in FIGS. 3A-3F may be used to organize information and facilitate rapid retrieval. Accordingly, in some embodiments, the node 320 (“McClellan—Luce Ave CO”) may have a plurality of child nodes representing different types of information of interest. For instance, there may be a “Billing Electric Meter” node 330 and a “Main Eletric Meter” node 332 corresponding, respectively, to electricity consumption at the site “McClellan—Luce Ave CO” as reported by a meter connected to a system of a resource provider (e.g., a utility company), and by a meter connected to a system of an enterprise operating the site or a consumption reduction service provider.

The inventors have recognized and appreciated it may be beneficial to break down total resource consumption into different categories based on a purpose for which resource is consumed (e.g., lighting, refrigeration, HVAC, mechanical load, etc.). This may allow a user to gain deeper insight into how resources are consumed, and to make different decisions for different categories of consumption. Accordingly, in the example of FIG. 3C, the node 320 (“McClellan—Luce Ave CO”) has a plurality of child nodes corresponding, respectively, to different load categories. For instance, there may be a “Total Mechanical Load” node 332 corresponding to consumption by mechanical equipment, a “Total Plug and Lighting” node 333 corresponding to consumption via electrical outlets, as well as consumption by lighting units, a “Total Production Load” node 334 corresponding to consumption by production equipment (e.g., assembly lines in a factory, ovens in a bakery, etc.), and an “HVACs” node 335 corresponding to consumption by HVAC equipment.

It should be appreciated that aspects of the present disclosure are not limited to tracking consumption by any particular load category, or by any load category at all. For instance, in the example of FIG. 3C, the node 320 (“McClellan—Luce Ave CO”) has a child node 336 (“Mixed Loads”) corresponding to consumption by multiple pieces of equipment belonging to different load categories. Such a node may be created for any suitable reason. As an example, there may be one physical meter measuring collective consumption by the multiple pieces of equipment, and it may be too costly to install separate meters to segregate the different load categories. As another example, a user may simply wish to track these pieces of equipment together for administrative purposes. Thus, a piece of equipment may be tracked under different child nodes of the node 320 (“McClellan—Luce Ave CO”). For instance, a same piece of mechanical equipment may be tracked under the node 336 (“Mixed Loads”), as well as the node 332 (“Total Mechanical Load”).

The inventors have further recognized and appreciated it may be beneficial to maintain data relating to one or more aspects of a site's operation. For example, such data may be used to identify opportunities to reduce resource consumption while maintaining a desired state of operation. Accordingly, in some embodiments, one or more sensors and/or interfaces to existing instruments may be installed at a site to collect measurements. Data obtained from these measurements may be stored in the object tree 300 for ready access. For instance, in the example of FIG. 3C, the node 320 has a child node 337 (“Temperature Sensors”) corresponding to temperature sensors installed at the site “McClellan—Luce Ave CO.”

It should be appreciated that aspects of the present disclosure are not limited to the use of any particular type of sensor or other instrument. In some embodiments, measurements may be collected using different types of sensors having different functionalities (e.g., for measuring temperature, humidity, pressure, etc.), and the node 320 (“McClellan—Luce Ave CO”) may have different child nodes corresponding, respectively, to the different types of sensors (e.g., a temperature sensors node, a humidity sensors node, a pressure sensors node, etc.). However, it should be appreciated that aspects of the present disclosure are not limited to grouping sensors and/or other instruments by functionality, as any other suitable grouping may be used, or no grouping at all.

The inventors have further recognized and appreciated it may be beneficial to maintain data relating to one or more variables that may impact resource consumption. For example, such data may be used to accurately determine savings resulting from implementing one or more consumption reduction measures. Accordingly, in some embodiments, the node 320 may have different child nodes corresponding, respectively, to different types of variables that may impact resource consumption at the site “McClellan—Luce Ave CO.” For instance, in the example of FIG. 3C, the node 320 has a child node 338 (“Sacramento—Sacramento International Airport”) corresponding to weather conditions reported by a weather station located near the site “McClellan—Luce Ave CO.” Although not shown, other types of variables (e.g., production volume, rates charged by utility companies, etc.) may be tracked in addition to, or instead of, weather.

In some embodiments, there may be a “Maintenance” node 339, which may store all data from various data sources. In this manner, a failure may be readily identified (e.g., a particular sensor that failed to provide a meaningful output).

In some embodiments, each child node of the node 320 (“McClellan—Luce Ave CO”) may have one or more associated properties, such as a static property, a dynamic property, and/or a derived property. A static property may have a value that is not expected to change over time, such as name, serial number, installation date, etc. A dynamic property may be expected to have different values over time, such as demand power. Such values may be updated continually based on information received from data sources such as the illustrative data sources 115, 116, . . . in the example of FIG. 1. A derived property may have values derived in any suitable manner, for example, based on one or more values of static properties, dynamic properties, and/or other derived properties in the object tree 300, and/or values persisted in a data store such as the illustrative facility data store 160 in the example of FIG. 1.

In the example of FIG. 3D, the node 332 (“Total Mechanical Load”) has a plurality of static properties (e.g., “Description” 340) and a plurality of derived properties (e.g., “Demand Power 5 Min” 341 and “3 Day Rolling Average” 342 of demand power). A derived property may be computed from data available from the object tree 300. However, it should be appreciated that these properties are shown and described solely for purposes of illustration, as aspects of the present disclosure are not limited to tracking any particular property.

In some embodiments, the node 332 (“Total Mechanical Load”) may correspond to a physical meter measuring consumption of all mechanical equipment at the site “McClellan—Luce Ave CO.” The inventors have recognized and appreciated that installation of such a meter may require significant electrical work (e.g., re-wiring), and therefore may be costly or even impractical. Accordingly, in some embodiments, the node 332 (“Total Mechanical Load”) may instead correspond to a virtual meter that is a sum of a plurality of sub-meters, and may have a plurality of child nodes corresponding, respectively, to the plurality of sub-meters. In the example of FIG. 3D, the node 332 (“Total Mechanical Load”) has a plurality of child nodes including a node 344 (“AHU 8: Substation A Elctrl Rm (AHMA)”) corresponding to a sub-meter for a particular room at the site “McClellan—Luce Ave CO,” and a node 345 (“Chilled Water Pump 1 & 2”) corresponding to a sub-meter for two chilled water pumps at the site “McClellan—Luce Ave CO.”

In some embodiments, the node 344 (“AHU 8: Substation A Elctrl Rm (AHMA)”) may correspond to a physical meter measuring consumption of all mechanical equipment located in the associated room, and may have one or more static, dynamic, and/or derived properties. In the example of FIG. 3E, the node 344 (“AHU 8: Substation A Elctrl Rm (AHMA)”) has a plurality of properties including a dynamic property “Demand Power 5 Min” 350, which may be updated based on data received from the physical meter corresponding to the node 344 (“AHU 8: Substation A Elctrl Rm (AHMA)”).

By contrast, in the example of FIG. 3E, the node 345 (“Chilled Water Pump 1 & 2”) corresponds to a virtual meter that is a sum of a plurality of sub-meters. Thus, in addition to a plurality of static, dynamic, and/or derived properties (e.g., a derived property “Demand Power 5 Min” 351), the node 345 (“Chilled Water Pump 1 & 2”) may have a plurality of child nodes corresponding, respectively, to the plurality of sub-meters. For instance, the node 345 (“Chilled Water Pump 1 & 2”) may have five child nodes, including a node 352 (“A1PMHC”) and a node 353 (“Chiller 1”).

In some embodiments, each child node of the node 345 (“Chilled Water Pump 1 & 2”) may have one or more static, dynamic, and/or derived properties. For instance, in the example of FIG. 3E, the node 352 (“A1PMHC”) has a plurality of properties including a dynamic property “Demand Power 5 Min” 360, which may be updated based on data received from a physical meter corresponding to the node 352 (“A1PMHC”). Likewise, the node 353 (“Chiller 1”) has a plurality of properties including a dynamic property “Demand Power 5 Min” 361, which may be updated based on data received from a physical meter corresponding to the node 353 (“Chiller 1”).

The inventors have recognized and appreciated various advantages of a hierarchical data structure such as the object tree 300 shown in FIGS. 3A-3F. For instance, the object tree 300 may be constructed to reflect a logical organization that may be intuitive to a user. In some embodiments, a user interface may be provided (e.g., by the illustrative query interface 180 in the example of FIG. 1) according to the object tree 300. Such a user interface may allow a user to easily “zoom in” from a higher level in the object tree 300 to a lower level (e.g., from region to site, to particular load category, to sub-meter, and then to physical meter or individual asset). Likewise, a user may be able to easily “zoom out” from a lower level in the object tree 300 to a higher level.

The inventors have further recognized and appreciated that a hierarchical data structure such as the object tree 300 shown in FIGS. 3A-3F may be used to facilitate aggregation of data. For instance, instead of storing raw data in a database and performing on-demand queries to aggregate data, certain statistics of interest may be stored in the object tree 300 and may be constantly or periodically updated as new data arrives. In this manner, the statistics of interest may be readily available, which may improve response time when a user requests certain information.

In some embodiments, updating a statistic may involve a traversal of the object tree 300, aggregating relevant values from leaf nodes upwards to a node of interest. As an example, to update the derived property “Demand Power 5 Min” 341 of the node 332 (“Total Mechanical Load”), demand power values may be accessed from all leaf nodes under the node 332 (“Total Mechanical Load”). For instance, demand power values may be accessed from all five child nodes of the node 345 (“Chilled Water Pump 1 & 2”), including the dynamic property “Demand Power 5 Min” 360 of the node 352 (“A1PMHC”) and the dynamic property “Demand Power 5 Min” 361 of the node 353 (“Chiller 1”). These values may be summed and stored as the derived property “Demand Power 5 Min” 351 of the node 345 (“Chilled Water Pump 1 & 2”). This may in turn be aggregated with the dynamic property “Demand Power 5 Min” 350 of the node 344 (“AHU 8: Substation A Elctrl Rm (AHMA)”), as well as demand power values from other child nodes of the node 332 (“Total Mechanical Load”), to provide a value for the derived property “Demand Power 5 Min” 341 of the node 332 (“Total Mechanical Load”).

In some embodiments, total demand power for a site may be obtained by aggregating demand power values from different load categories that are present at the site. Likewise, total demand power for a geographical region may be obtained by aggregating demand power values from different sites located in that region.

The inventors have recognized and appreciated that, when a derived property is updated, it may be beneficial to store one or more immediate results in the object tree 300. For instance, as discussed above, a sum of demand power values from all five child nodes of the node 345 (“Chilled Water Pump 1 & 2) may be stored as the derived property “Demand Power 5 Min” 351, even though an ultimate goal is to update the derived property “Demand Power 5 Min” 341 of the node 332 (“Total Mechanical Load”). In this manner, when the derived property “Demand Power 5 Min” 351 is needed for another purpose, its value may simply be looked up from the object tree 300, without having to repeat the computation already performed (unless the value has become stale). In some embodiments, a derived property may be re-computed in response to detecting and correcting an error in a data source from which the derived property depends.

Referring to FIG. 3F, the node 337 (“Temperature Sensors”) may have one or more static, dynamic, and/or derived properties (e.g., a derived property “Average Temperature” 370), and/or one or more child nodes (e.g., a “DC Power Room” node 371) corresponding, respectively, to different areas within the site “McClellan—Luce Ave CO.” Each child node may in turn have one or more static, dynamic, and/or derived properties, and/or one or more child nodes corresponding, respectively, to different sub-areas. For instance, in the example of FIG. 3F, the node 371 (“DC Power Room”) has a plurality of properties including a derived property “Average Temperature” 380, and a plurality of child nodes including a child node 381 (“DCR 1”). The child node 381 (“DCR 1”) in turn has a plurality of properties including a derived property “Average Temperature” 390, and a plurality of child nodes corresponding, respectively, to different physical temperature sensors. For example, a child node 391 (“1st Floor—Zone 2.1”) corresponds to a physical temperature sensor, and has a plurality of properties including a dynamic property “Temperature” 399, which may be updated based on data received from the physical temperature sensor.

As with resource consumption data, the inventors have recognized and appreciated that arranging sensor data in a hierarchical manner may advantageously allow a user to easily “zoom in” or “zoom out” to view relevant information at different levels. Also, relevant information (e.g., average temperature) may be aggregated by traversing the hierarchical structure, for example, from physical temperature sensor readings (e.g., the dynamic property “Temperature” 399 of the node 391), to sub-area averages (e.g., the derived property “Average Temperature” 390 of the node 381), to area averages (e.g., the derived property “Average Temperature” 380 of the node 371), and then to site average (e.g., the derived property “Average Temperature” 370 of the node 337). One or more of the intermediate values may be stored for later use.

Although consumption data is organized based on load category in the illustrative object tree 300, it should be appreciated that aspects of the present disclosure are not so limited. In some embodiments, consumption data may be organized based on equipment type (e.g., AC units, heating furnaces, pumps, water heaters, lighting fixtures, refrigerators, ovens, etc.) in addition to, or instead of, load category. Accordingly, a hierarchical structure similar to the illustrative object tree 300 may be constructed that includes nodes corresponding respectively to different equipment types (e.g., an “AC Units” child node, a “Water Heaters” child node, a “Pumps” child node, etc.) This may advantageously allow aggregation of consumption data by equipment type (e.g., total demand power from all AC units). However, it should be appreciated that aspects of the present disclosure are not limited to organizing consumption data based on equipment type.

Furthermore, although examples are provided relating to consumption of electricity, a consumption management system may manage one or more other types of resources in addition to, or instead of, electricity. For instance, the illustrative object tree may be augmented to include a “Billing Gas Meter” node corresponding to total natural gas consumption, a “Billing Water Meter” corresponding to total water consumption, etc., in addition to the “Billing Electric Meter” node 330. Pieces of equipment that consume natural gas, water, etc. may be organize in any suitable manner (e.g., by load category, equipment type, location, sub-meter, etc.).

The inventors have further recognized and appreciated that a hierarchical data structure such as the object tree 300 shown in FIGS. 3A-3F may be used to reduce instrumentation, which may reduce costs, and/or data volume and/or complexity. For instance, certain asset types (e.g., lighting) may include units that are too numerous to monitor individually. Such units may be represented collectively in the object tree 300, and only one sensor may be installed to monitor collective behavior of all of the units. For instance, with reference to FIG. 3C, the node 333 (“Total Plug and Lighting”) may be a leaf node, and may have one or more properties but no child node.

Although various advantages of a hierarchical data structure is discussed above, it should be appreciated that aspects of the present disclosure are not limited to the use of a hierarchical data structure. Also, details of implementation are shown in FIGS. 3A-3F and described above solely for purposes of illustration. Aspects of the present disclosure are not limited to any particular design of an object tree (e.g., a number of levels, what is represented logically by each level, what data is stored, etc.).

FIG. 4 shows an illustrative state transition diagram 400 for a consumption management event, in accordance with some embodiments. For instance, a consumption management event (or “event” for short) may be detected by the illustrative event detection module 130 in the example of FIG. 1, and a corresponding record may be stored in the illustrative event data store 140 in the example of FIG. 1. Such a record may include one or more proposed measures for reducing resource consumption, and/or expected savings that may result from implementing the one or more consumption reduction measures.

In some embodiments, an event may transition through multiple states. For instance, in the example shown in FIG. 4, a newly detected event may begin in a state 405 (“New”), where the event may await a user's review. Once the user reviews and approves the event for implementation, the event may transition into a state 410 (“To Be Implemented”).

Implementation of a proposed consumption reduction measure may involve one or more actions such as upgrading one or more pieces of equipment (e.g., replacing fluorescent light fixtures with LED light fixtures that are more energy efficient), adjusting one or more operating parameters (e.g., temperature set points on thermostats), adjusting one or more operating schedules (e.g., when to turn pumps on/off), etc. Such an action may be performed by one or more employees of an enterprise operating a site at which the event is detected. However, that is not required, as in some embodiments one or more resource consumption consultants working for a third party vendor (e.g., a vendor that provides resource consumption consulting services via the illustrative consumption management system 100 in the example of FIG. 1) may take part in the implementation in addition to, or instead of, the one or more site employees.

In the example shown in FIG. 4, an event in the state 410 (“To Be Implemented”) may transition to a state 415 (“Implemented”) once the one or more proposed measures associated with the event have been implemented. In some embodiments, a user who did not take part in the implementation may verify that the one or more proposed measures have been correctly implemented. While the user performs this verification, the event may reside in a state 420 (“To Be Validated”), and may transition to a state 425 (“Validated”) once the validation is completed successfully.

The inventors have recognized and appreciated a state transition diagram such as the illustrative state transition diagram 400 may be used to track progress of implementation of consumption reduction measures. For instance, statistics may be collected regarding how long events reside in various states. Such statistics may be used to identify and correct potential workflow issues (e.g., insufficient staffing). However, it should be appreciated that aspects of the present disclosure are not limited to the use of any particular state transition diagram to track consumption management events, or any state transition diagram at all.

The inventors have recognized and appreciated that a consumption management system may provide a large amount of data and/or a large number of functionalities. Using a conventional user interface with a single entry point, a user may need to traverse a series of links to navigate to a page that displays a desired piece of information and/or provides a desired functionality. The inventors have further recognized and appreciated that different users within an enterprise may have different organizational roles, and therefore may need to access different information and/or different functionalities provided by the consumption management system. Accordingly, in some embodiments, a user interface may be provided that has multiple entry points leading, respectively, to multiple centers designed for users with different objectives.

The inventors have recognized and appreciated that when a user accesses a consumption management system, the user may be attempting to accomplish a particular mission. For instance, a user may wish to review performance of consumption reduction measures. Accordingly, in some embodiments, a landing page for a savings center may be provided that displays a summary of salient information regarding resource savings resulting from the consumption reduction measures and how such savings are quantified. This may allow the user to gain, at one glance, a high level understanding of how effective the measures are in reducing consumption.

The inventors have recognized and appreciated that, after viewing a summary of salient information, a user may wish to drill down and view more detailed information. Therefore, it may be beneficial to identify what detailed information the user is likely to request, and to provide user interface features that allow the user to access such information quickly and easily. For instance, after reviewing a resource savings summary displayed at a landing page of a savings center, a user may wish to compare actual and/or potential savings against certain predetermined targets. Then, the user may wish to view a breakdown of how the actual savings and/or the potential savings are determined. Then, the user may wish to view further breakdowns that illustrate how various adjustments impact the actual savings. Accordingly, in some embodiments, a menu flow may be provided to direct the user to relevant information in an intuitive, story-like manner. Such a menu flow may match an expected workflow of the user and thereby improve productivity.

The inventors have recognized and appreciated that, increasingly, users are accessing a user interface of a consumption management system using mobile devices having various screen sizes. Furthermore, when a user uses a desktop device, the user may frequently resize a web browser window so that multiple windows can be viewed simultaneously. The inventors have further recognized and appreciated that, if displayed items are shrunken accordingly when a smaller display is used, it may be difficult for the user to discern information due to reduced font size, cluttered graphics, etc. On the other hand, if the displayed items are not shrunken, one or more items may be pushed off the display, and the user may have to scroll to see certain information. Accordingly, in some embodiments, selection, arrangement, and/or sizing of items displayed may be updated automatically depending on a display size. For instance, when a user resizes a web browser window (e.g., by changing height, width, and/or aspect ratio), one or more items may be added and/or removed. Additionally, or alternatively, sizing of one or more items, and/or relative placement between two or more items, may be adjusted. In this manner, the display may remain uncluttered, and the user may be able to see important pieces of information all at once (e.g., without scrolling), even when display size becomes small.

In some embodiments, dynamic selection, arrangement, and/or sizing of displayed items may be implemented using a plurality of hierarchical grids. For example, there may be at least three hierarchical grids, which may be defined, respectively, for small, medium, and large display sizes. A hierarchical grid may be constructed recursively, for example, by dividing a canvas via a sequence of column splits and/or row splits, resulting in a plurality of areas each occupied by a respective user interface feature (e.g., text block, image, map, table, graph, etc.)

In some embodiments, an area in a hierarchical grid may have a fixed size, or may be sized based on a size of a parent area, a size of a sibling area, and/or a size of a child area. As one example, a size of an area may be a selected proportion of a size of a parent area. As another example, a size of an area may be a difference between a size of a parent area and a total size of one or more sibling areas. As yet another example, a size of an area may be a total size of one or more child areas.

The inventors have recognized and appreciated it may be desirable to track progress of implementation of consumption reduction measures. For instance, statistics may be collected regarding for how long events reside in various event states. Such statistics may be used to identify and correct potential workflow issues (e.g., insufficient staffing). Accordingly, in some embodiments, a tracking dashboard may be provided to illustrate movement of consumption management events through various event states. This may allow a user to easily discern useful information such as how many events are currently in a state, how much time an average event spends in that state, how many events moved from that state to another state during a selected period of time, etc.

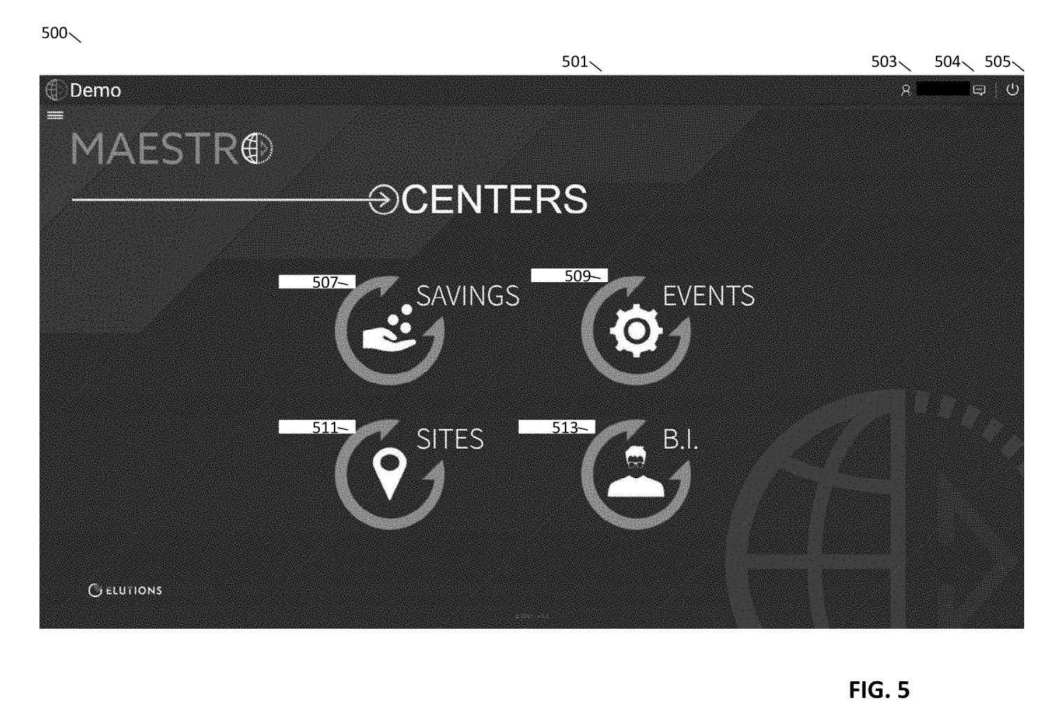

FIG. 5 shows an illustrative home page 500 for a user interface of a consumption management system, in accordance with some embodiments. In this example, the home page display 500 has an upper menu 501 that includes a user information section 503, a notification icon 504, and a logout icon 505. Beneath the upper menu 501 there may be four selectable icons: a savings icon 507, an events icon 509, a sites icon 511, and an intelligence icon 513.

In some embodiments, the user information section 503 may display an indication of an identity of a user who is currently logged in. Examples of suitable indications include, but are not limited to, a name of the user, a username registered with the consumption management system, an email address, etc. Thus, different users within an enterprise may have different logins, and the consumption management system may customize aspects of a user interface based on the identity of the user who is logged. However, that is not required, as in some embodiments, a single login may be created for an enterprise and shared by all users affiliated with the enterprise.

In some embodiments, the consumption management system may log one or more activities of the user, and may analyze the logged activities to learn what information the user is likely to request and/or what actions the user likely to perform. This may allow the consumption management system to dynamically adapt one or more pages presented to the user to improve productivity.

In some embodiments, different permissions may be configured for different users, for example, depending on each user's organizational role. For instance, users may be allowed to access information on a need-to-know basis. Additionally, or alternatively, some users may be allowed to reconfigure one or more aspects of the user interface, while other users may only be allowed to use the user interface.

In the example shown in FIG. 5, the user notification section 504 displays a visual indicium that one or more notifications have been generated by the consumption management system for a user who is currently logged in. The user may click or otherwise select the visual indicium to bring up a list of pending notifications. Additionally, or alternatively, the user may mouse over the visual indicium to see how many notifications are pending.

In some embodiments, a user may configure one or more conditions for causing the consumption management system to send notifications. For example, the consumption management system may be configured to send a notification based on events such as anomalous resource usage at a certain site, from a certain type or piece of equipment, of a certain magnitude, etc. In some embodiments, the consumption management system may be configured to filter events that have been detected and send notifications only for certain events (e.g., events that occur within a certain time frame). However, it should be appreciated that any suitable condition or combination of conditions may be used for triggering notifications, as aspects of the present disclosure are not so limited.

In the example shown in FIG. 5, a user may activate the four icons 507, 509, 511, and 513 (shown near a center of the home page 500) to access additional pages of the user interface of the consumption management system. Each of these icons may lead to a respective center designed to assist the user in completing a certain mission. Such a center may include a landing page that presents a summary of the most salient information for the associated mission. Additionally, or alternatively, the landing page may include one or more features that allow the user to view more detailed information and/or take appropriate action, for example, by providing one or more links for navigating to other pages within the center. These pages may be organized to match an expected workflow of the user, thereby reducing an amount of time and/or cognitive effort that the user needs to expend to locate a piece of desired information or to perform a desired action.

In some embodiments, the savings icon 507, when selected, may take a user to a landing page for a savings center. This landing page may display information related to performance of consumption reduction measures. For instance, the landing page may inform the user how much resource was saved due to implementation of one or more consumption reduction measures (e.g., an amount of resource actually consumed after implementation of the one or more consumption reduction measures, versus an amount of resource that would have been consumed had the one or more consumption reduction measures not been implemented). Additionally, or alternatively, the landing page may, for one or more consumption reduction measures that were recommended but not actually implemented, inform the user how much more resource would have been saved had those measures been implemented.

In some embodiments, one or more pieces of information displayed in a savings center (e.g., baseline consumption, actual savings, potential savings, etc.) may be provided by a baseline module of the consumption management system. The baseline module may perform one or more calculations following one or more guidelines provided in the International Performance Measurement and Verification Protocol (1PMVP), which is developed by the Efficiency Valuation Organization (EVO), and outlines recommended practices for measuring and verifying resource savings. The calculations may be performed on one or more pieces of information retrieved from one or more data stores of the consumption management system (e.g., the illustrative object tree 170 and/or the illustrative facility data store 160 in the example of FIG. 1), and/or any other suitable source.

In some embodiments, the events icon 509, when selected, may take a user to a landing page for an event center. This landing page may display information related to one or more events detected by the consumption management system. As discussed in connection with FIG. 4, an event may include one or more proposed measures for reducing resource consumption, and/or expected savings that may result from implementing the one or more consumption reduction measures. Such an event may progress through one or more states (e.g., awaiting approval, approved but awaiting implementation, implemented but awaiting validation, validated, etc.). The event center landing page may provide a summary of events and/or their statuses.

In some embodiments, the sites icon 511, when selected, may take a user to a landing page for a site center. This landing page may display information related to one or more sites monitored by the consumption management system. For instance, resource consumption information may be displayed, broken down by load category (e.g., production, lighting, mechanical load, HVAC, etc.), geographical region (e.g., continent, country, state, county, city, etc.), etc.

In some embodiments, the intelligence icon 513, when selected, may take a user to a landing page for an intelligence center. This landing page may display information that facilitates decision making, such as whether to implement one or more proposed consumption reduction measures. For instance, information may be displayed relating to actual or expected values of the consumption reduction measures (e.g., costs associated with implementing the consumption reduction measures vs. benefits resulting from the consumption reduction measures), how quickly such values are realized, etc. In this manner, the user may be able to make informed decisions, and choose to implement measures that are more likely to lead to greater reduction in resource consumption.

Although various user interface features are shown in the figures and described herein, it should be appreciated that aspects of the present disclosure are not limited to the use of any particular user interface feature. Furthermore, a user interface for a consumption management system may be presented in any suitable manner, for example, via a web browser, a desktop application, a mobile device application, etc. A user may interact with one or more user interface features using any one or more suitable input devices, such as a mouse, a keyboard, a touchscreen, a microphone, etc.

The inventors have recognized and appreciated that, while different centers may cater to different user missions, it may be beneficial to provide a common look-and-feel across the different centers. For instance, a user may be accustomed to working in a first center, but may occasionally visit a second center to review additional information. Therefore, it may be beneficial to provide a common layout across the two centers, so that less time and/or cognitive effort may be needed on the part of the user to navigate through the second center to access the desired information.

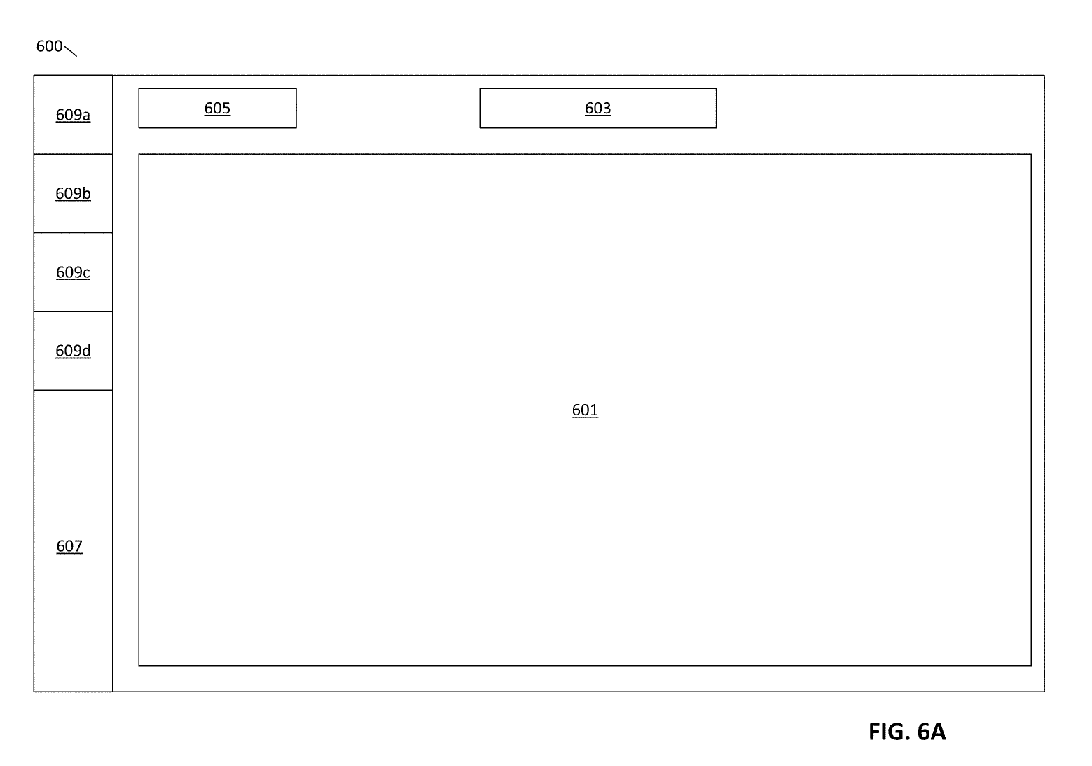

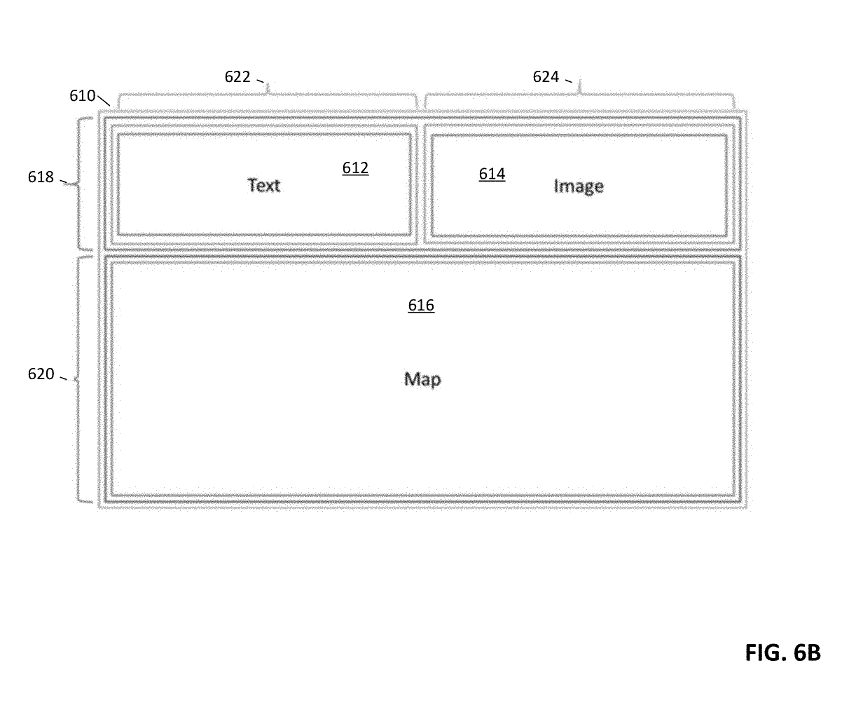

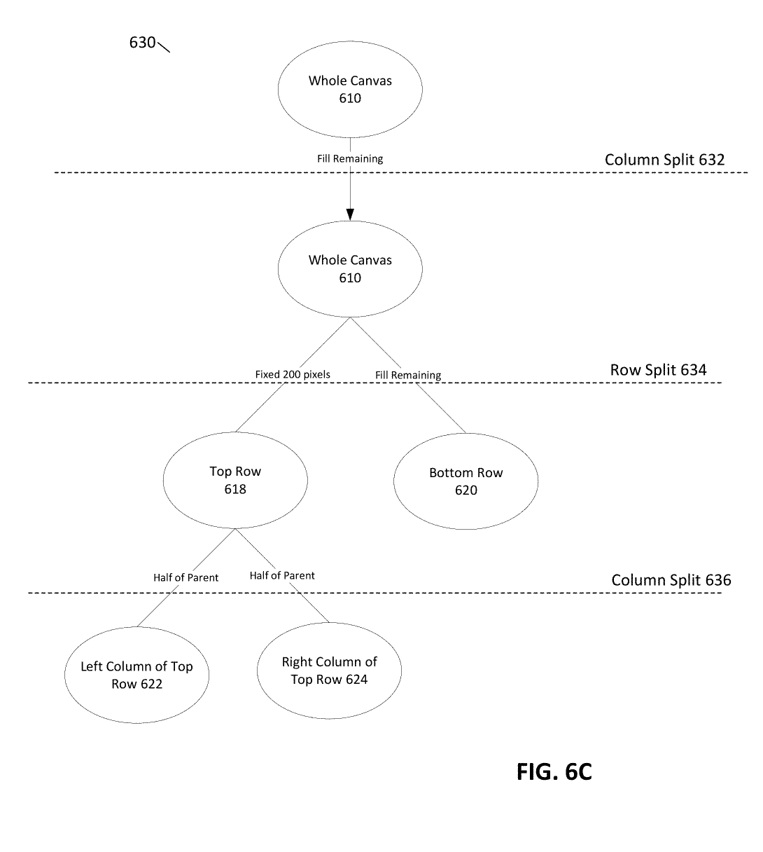

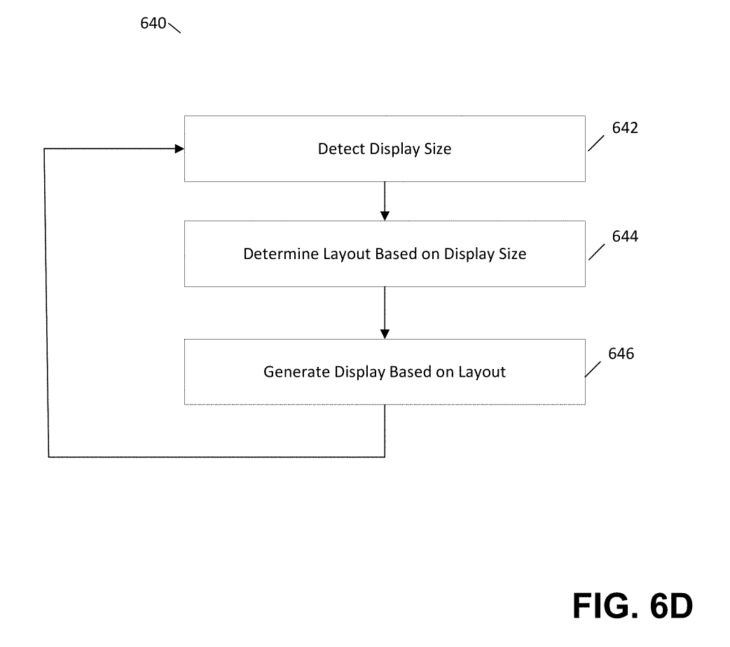

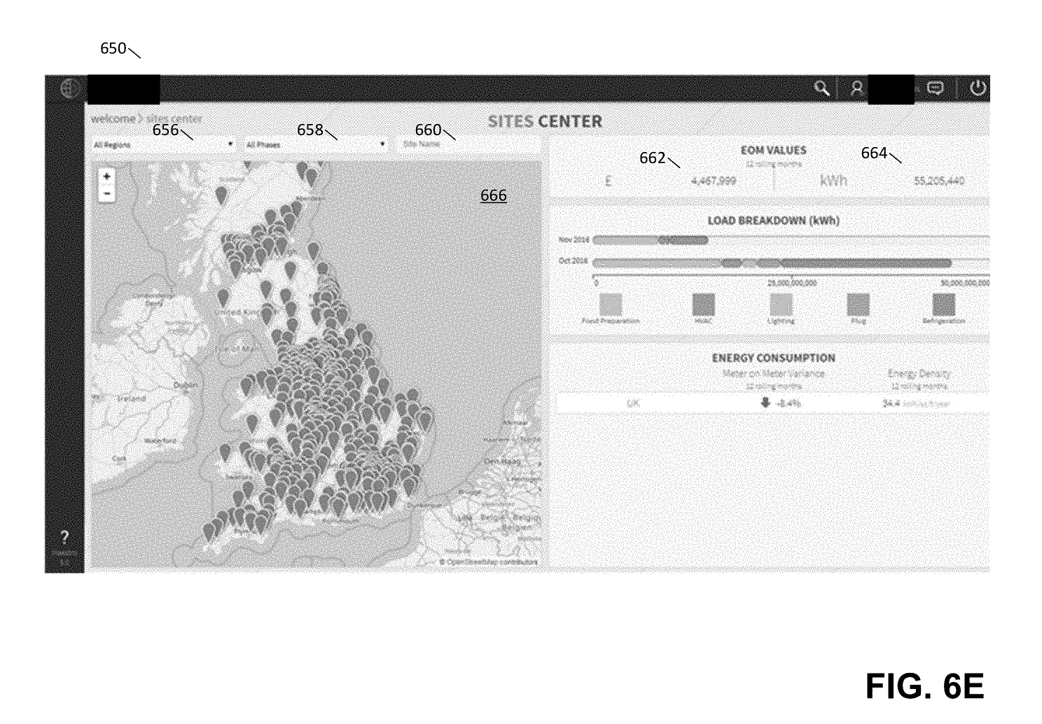

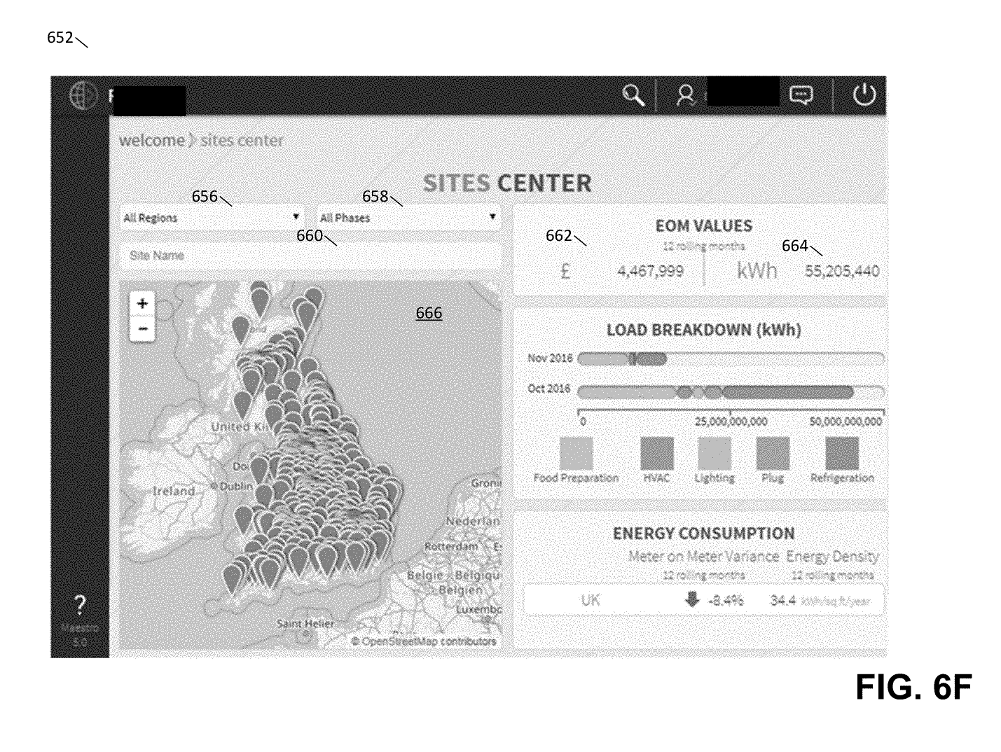

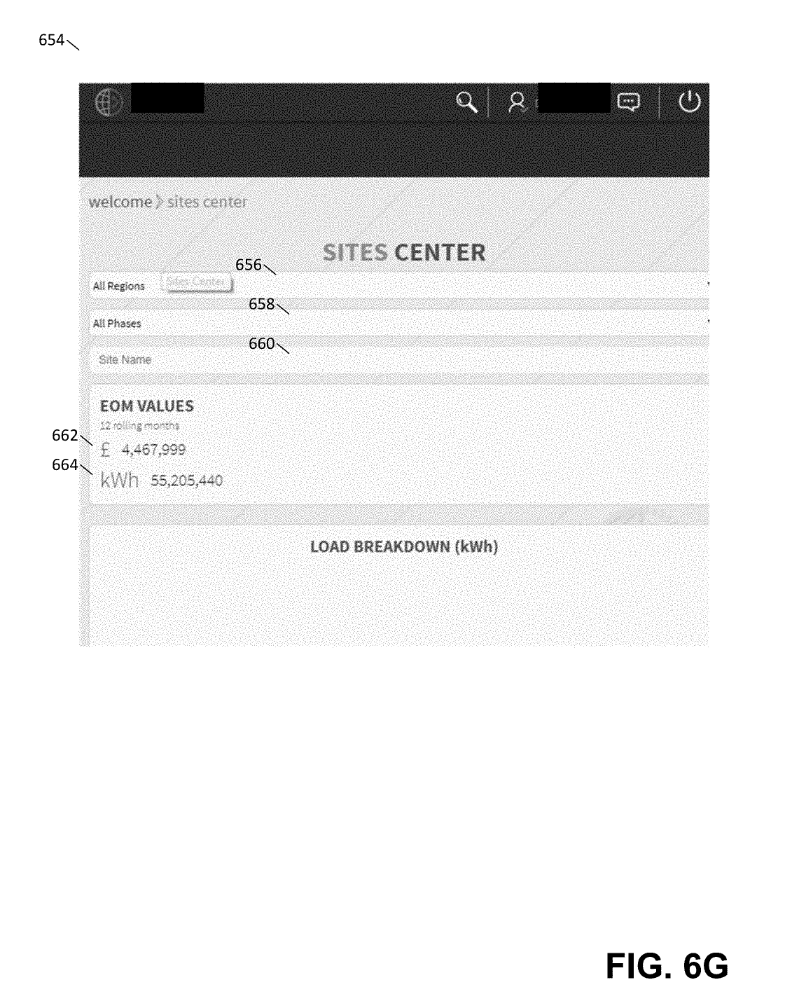

FIG. 6A shows an illustrative layout 600 that may be used for one or more pages within a user interface of a consumption management system, in accordance with some embodiments. For instance, the layout 600 may be used for a savings center, an event center, a site center, and/or an intelligence center (e.g., as discussed above in connection with FIG. 5).

In the example of FIG. 6A, the layout 600 includes a main display area 601, a title area 603, a breadcrumbs area 605, and a side menu 607. The main display area 601 may be used to present information in any suitable format (e.g., via one or more graphs, tables, icons, text blocks, numbers, etc.), and a title may be provided in the title area 603 to indicate of a nature of the information presented (e.g., by identifying a center, a dashboard within the center, etc.).

In some embodiments, a user may navigate through the user interface of the consumption management system in different ways. As an example, the breadcrumbs area 605 may displays a path through which the user has navigated to reach a current page. This may allow the user to quickly return to a higher level page (e.g., the illustrative home page 500 in the example of FIG. 5, a landing page for a center, etc.) when the user has completed a certain task and is ready to begin a next task. As another example, the user may select an item displayed in the main display area 601 (e.g., an icon, an entry in a table, a bar in a bar graph, a slice in a pie chart, etc.) to navigate to a page relating to the selected item. As yet another example, the user may select one or more menu items from the side menu 607.

In the example shown in FIG. 6A, menu items 609a-d of the side menu 607 may be used to navigate to different dashboards within a center, and/or to a different center. For instance, there may be a menu item for each dashboard within a center that a user is currently in. Additionally, or alternatively, the user may mouse over a menu item to bring up a sub-menu of different centers and/or different dashboard within a center. In some embodiments, the sub-menu may be hierarchical. For instance, there may be a first level comprising one or more centers, and a second level comprising one or more dashboards for each of the one or more centers.

In some embodiments, one or more elements of the layout 600 may automatically refresh when a user navigates from one page to another, but an arrangement of the elements may remain unchanged. For instance, if the user navigates from a page in one center to a page in a different center, content in the main display area 601 may be updated, and one or more menu items in the side menu 607 may also be updated to correspond, respectively, to one or more dashboards of the destination center. Likewise, the title area 603 and the breadcrumb area 605 may be updated to reflect the destination page. Relative placement of the main display area 601, the title area 603, the breadcrumbs area 605, and/or the side menu 607 (including the menu items 609a-d), and/or dimensions of these elements, may remain unchanged. In this manner, the user may be able to navigate using less cognitive effort because the user is already familiar with the layout 600.

The inventors have recognized and appreciated that, increasingly, users are accessing the user interface of the consumption management system using mobile devices having various screen sizes. Furthermore, when a user uses a desktop device, the user may frequently resize a web browser window so that multiple windows can be viewed simultaneously. The inventors have further recognized and appreciated that, if displayed items are shrunken accordingly when a smaller display is used, it may be difficult for the user to discern information due to reduced font size, cluttered graphics, etc. On the other hand, if the displayed items are not shrunken, one or more items may be pushed off the display, and the user may have to scroll to see certain information.

Accordingly, in some embodiments, selection, arrangement, and/or sizing of items displayed in the main display area 601 may be updated automatically depending on a display size. For instance, when a user resizes a web browser window (e.g., by changing height, width, and/or aspect ratio), one or more items may be added and/or removed. Additionally, or alternatively, sizing of one or more items, and/or relative placement between two or more items, may be adjusted. In this manner, the main display area 601 may remain uncluttered, and the user may be able to see important pieces of information all at once (e.g., without scrolling), even when the display size becomes small.

FIG. 6B shows an illustrative hierarchical grid 610, in accordance with some embodiments. The hierarchical grid 610 may be used to arrange one or more items in the main display area 601 of the illustrative grid 600 in the example of FIG. 6A, for instance, to facilitate dynamic selection, arrangement, and/or sizing of items.

In the example of FIG. 6B, the hierarchical grid 610 includes a canvas divided into a plurality of areas. For instance, the canvas may be the illustrative grid 600 in the example of FIG. 6A, and each area may be occupied by a respective item to be shown in the main display area 601, such as a text block occupying area 612, an image occupying area 614, and a map occupying area 616.

In some embodiments, a plurality of areas in the hierarchical grid 610 may be arranged in columns and rows. For instance, in the example of FIG. 6B, the canvas may be divided into two rows, 618 and 620. The row 618 may be further divided into two columns, 622 and 624. The areas 612 and 614 may be located in the row 618, where the area 612 may be located in the column 622, and the area 614 may be located in the column 624. The area 616 may be located in the row 620, where there may be no column division.

FIG. 6C shows an illustrative tree 630 representing a recursive process for constructing a hierarchical grid, in accordance with some embodiments. For instance, a root node of the tree 630 may represent the whole canvas of the illustrative hierarchical grid 610 in the example of FIG. 6B, and each level in the tree 630 may represent either a column split or a row split.

In some embodiments, a hierarchical grid may be constructed via a sequence of alternating column splits and row splits. For instance, in the example shown in FIG. 6C, the illustrative hierarchical grid 610 is constructed via a column split 632, followed by a row split 634, followed by another column split 636. However, it should be appreciated that aspects of the present disclosure are not limited to any particular sequence of column splits and row splits. For instance, in some embodiments, a sequence may begin with a row split, instead of a column split. Additionally, or alternatively, a sequence may include consecutive column splits and/or consecutive row splits.

In the example shown in FIG. 6C, the column split 632 may be a trivial split, in the sense that there is only child node, which again represents the whole canvas. This may be implemented using a “Fill Remaining” constructor. The inventors have recognized and appreciated that the use of a trivial split may allow all hierarchical grids to be constructed in a unified manner, for example, all starting with a column split. This may simplify programming, but is not required, as in some embodiments a hierarchical grid may be constructed starting with a row split.

In the example shown in FIG. 6C, the row split 634 may result in two child nodes representing, respectively, the illustrative rows 618 and 620 in the example of FIG. 6B. The row 618 may be constructed using a “Fixed Height” constructor (e.g., fixed height of 200 pixels), whereas the row 620 may be constructed using a “Fill Remaining” constructor, so that a height of the row 620 may be a difference between a height of the whole canvas and the fixed height specified for the row 618.

It should be appreciated that aspects of the present disclosure are not limited to the use of a two-way split, as in some embodiments a node may have more than two child nodes. For instance, a row may be split into three or more columns, where one column may be constructed using the “Fill Remaining” constructor,

Similarly, the column split 636 may result in two child nodes representing, respectively, the illustrative columns 622 and 624 in the example of FIG. 6B. The columns 622 and 624 may be constructed using a “Proportion of Parent” constructor (e.g., half of parent), so that each may have a width that is equal to half of a width of the row 618. However, it should be appreciated that aspects of the present disclosure are not limited to splitting a parent into halves, as in some embodiments a parent area may be divided into thirds, fourths, fifths, etc., or any suitable equal or unequal proportions (e.g., as specified using fractions or real numbers).

In some embodiments, a height of a row (or a width of a column) constructed using a “Fill Remaining” constructor may be automatically updated when a display size is changed (e.g., when a user resizes a browser window), whereas a height of a row (or a width of a column) constructed using a “Fixed Height” (or “Fixed Width”) constructor may stay the same. Likewise, a height of a row (or a width of a column) constructed using a “Proportional to Parent” constructor may be automatically updated when a display size is changed (e.g., when a user resizes a browser window). For instance, a change in a display size may cause a change in a size of the canvas represented by the root node of the tree 630, and such a change may be propagated down the tree 630 (e.g., by calculating a new size of a child node based on a new size of a parent node according to a constructor used to define the child node). In this manner, a hierarchical grid may be made to respond dynamically to display size changes.

However, it should be appreciated that aspects of the present disclosure are not limited to the use of any particular constructor, as any suitable constructor or combination of constructors may be used. For instance, in some embodiments, a minimum size or a maximum size may be provided for a dynamic constructor such as “Fill Remaining” or “Proportional to Parent.” Additionally, or alternatively, a parent with two or more children with fixed sizes may take a size that is a sum of the children's sizes.

In some embodiments, leaf nodes in the tree 630 may represent areas in which individual items (e.g., text blocks, images, maps, tables, graphs, etc.) may be placed. Each item may be automatically expanded or shrunken to match a size of the corresponding area. For instance, the map occupying the area 616 may be automatically resized according to a size of the area 616 as allocated by constructors in the tree 630, and likewise for the text block occupying the area 612 and the image occupying the area 614. However, that is not required, as in some embodiments, a size of an item may remain unchanged, while a parent and/or one or more siblings may be adapted.

Although detailed examples of hierarchical grids and methods for constructing same are shown in FIGS. 6B-6C and discussed herein, it should be appreciated that such details are provided solely for purposes of illustration, and aspects of the present disclosure are not so limited. For instance, aspects of the present disclosure are not limited to the use of a rectangular canvas, or rectangular areas. A canvas of any shape and size may be recursively divided into areas of any shapes and sizes, via any suitable number of divisions. Furthermore, aspects of the present disclosure are not limited to the use of a column split or a row split, as a division may be performed in any suitable manner.

FIG. 6D shows an illustrative process 640 for configuring a layout, in accordance with some embodiments. For example, the process 640 may be used to configure a layout of one or more items in the main display area 601 of the illustrative layout 600 in the example of FIG. 6A, for instance, to facilitate dynamic selection, arrangement, and/or sizing of items.

At act 642, a display size may be detected. In some embodiments, information relating to a device that is being used by a user to access a user interface of a consumption management system may be determined from one or more communications received from the user's device. For instance, device make, model, and/or serial number may be determined, and may be used to identify a corresponding display size. Additionally, or alternatively, display size may be determined based on information received from a software application that is being used by the user to access the user interface, such as a web browser (e.g., Chrome, Internet Explorer, Firefox, etc.) or a mobile device app (e.g., a mobile device app developed by a vendor providing a consumption management system).

At act 644, a layout may be determined based on the display size detected at act 642, for example, by selecting the layout from a plurality of candidate layouts. For instance, there may be three candidate layouts corresponding, respectively, to small, medium, and large display sizes. Each candidate layout may include one or more items arranged in a suitable manner, for instance, using a respective hierarchical grid constructed as discussed in connection with FIGS. 6B-6C.

In some embodiments, a layout may be selected by comparing the display size detected at act 642 to one or more thresholds. For instance, a layout designed for small display size may be used when the display size detected at act 642 has a width less than 768 pixels, a layout designed for medium display size may be used when the display size detected at act 642 has a width greater than or equal to 768 pixels but less than 1200 pixels, and a layout designed for large display size may be used when the display size detected at act 642 has a width greater than or equal to 1200 pixels. However, it should be appreciated that aspects of the present disclosure are not limited to the use of any particular number of candidate layouts, or any particular threshold for selecting a layout.

At act 646, a display may be generated based on the layout determined at act 644, for example, by selecting, arranging, and/or sizing one or more items (e.g., text blocks, images, maps, tables, graphs, etc.) according to the layout. In some embodiments, the acts 642, 644, and 646 may be repeated whenever a change in display size is detected. For instance, in response to detecting that a user has resized a browser window, a different layout may be selected, or one or more items arranged according to a current layout may be resized, according to a new display size. However, it should be appreciated that aspects of the present disclosure are not limited to dynamically configuring a display based on display size.

FIGS. 6E-6G show, respectively, illustrative layouts 650, 652, and 654, in accordance with some embodiments. For instance, the layouts 650, 652, and 654 may be used, respectively, for large, medium, and small display sizes, as discussed in connection with FIG. 6D. In this example, as a display size is reduced from large to medium, items 656, 658, and 660 are rearranged to occupy two rows, instead of one, and the widths of these items are adjusted accordingly (e.g., from one sixth of total width to one quarter, or one half, of total width). The items 662, 664, and 666 may simply be resized. By contrast, as the display size is reduced from medium to small, all of the items 656, 658, 660, 662, and 664 may be rearranged to be in a single column, and the widths may be adjusted to fit a width of the column. The item 666 may be removed (e.g., because a crowded map may be of limited utility when a user is on a small mobile device such as a smartphone). Alternatively, the item 666 may be placed at a bottom of the column, and may be viewed by scrolling down.

Although various user interface techniques and associated advantages are discussed above in connection with FIGS. 6A-6G, it should be appreciated that aspects of the present disclosure are not limited to the use of the illustrative layout 600, or any particular user interface technique. Moreover, any one or more user interface techniques described herein may be used to display any suitable type of data represented in any suitable form.

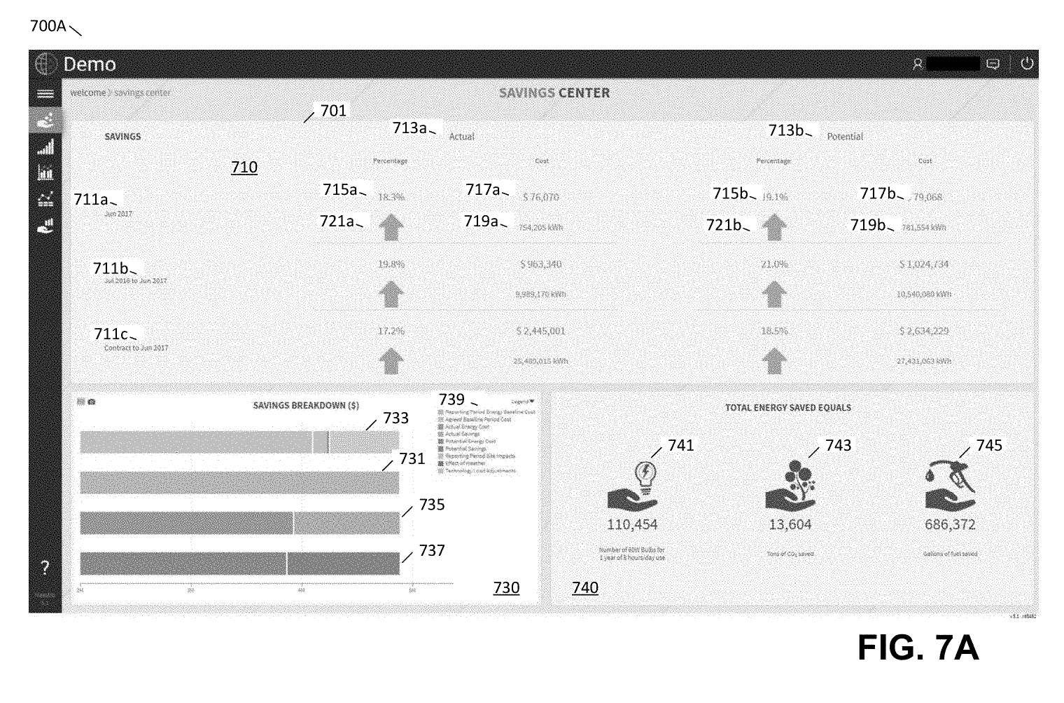

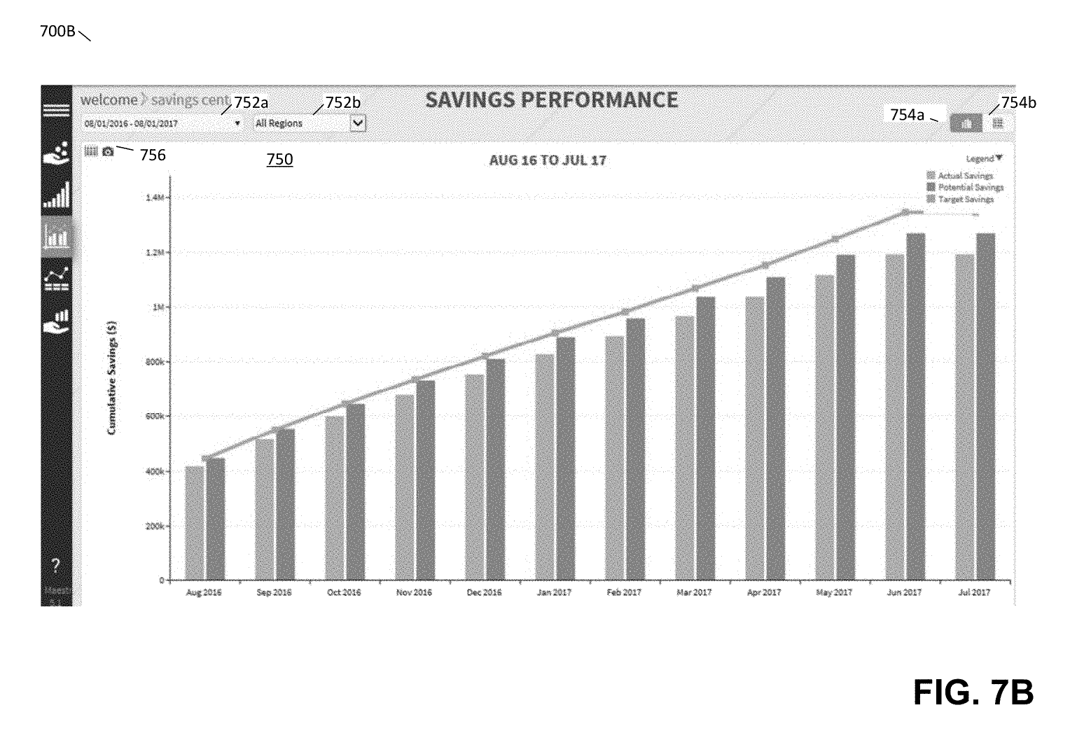

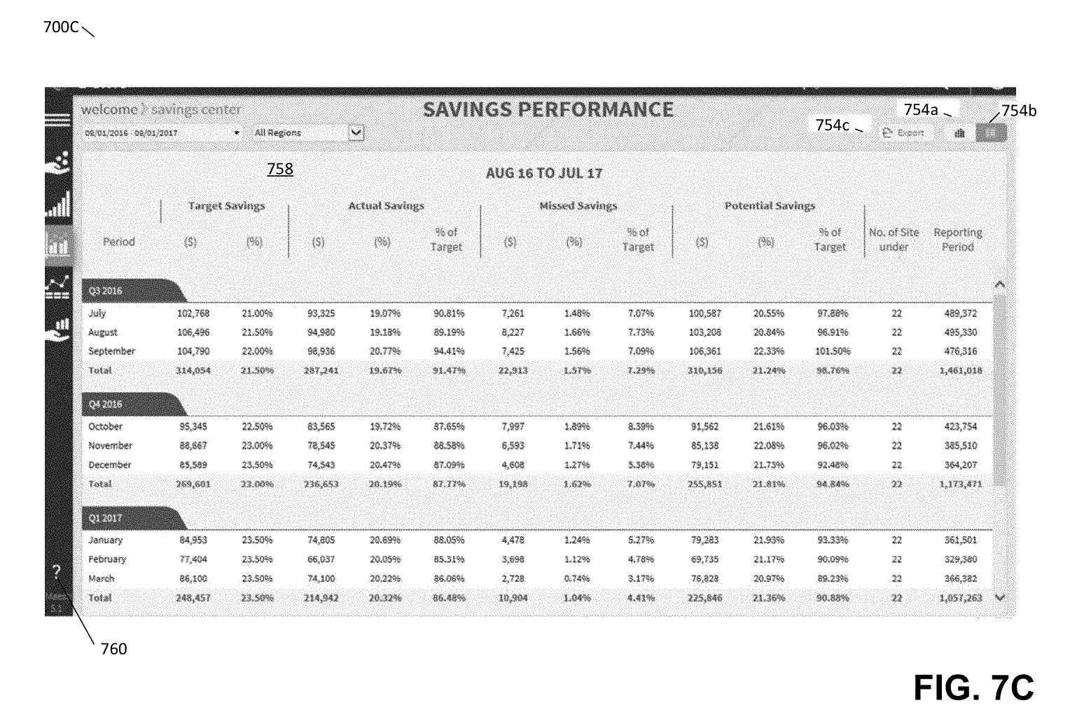

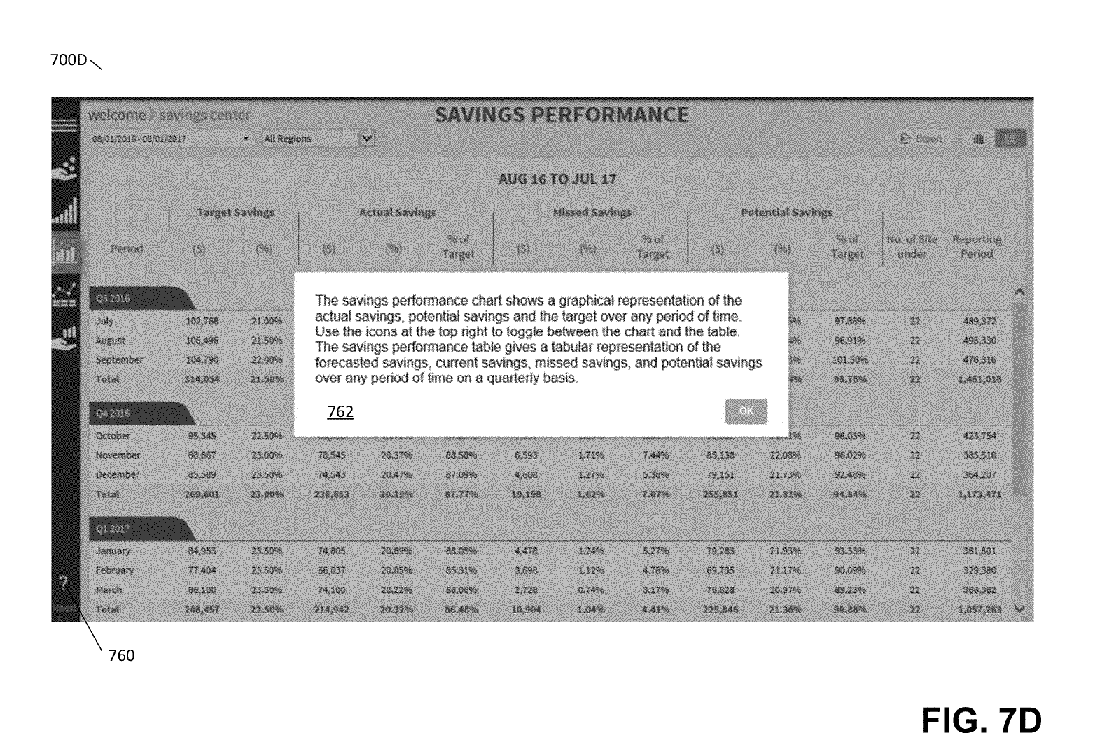

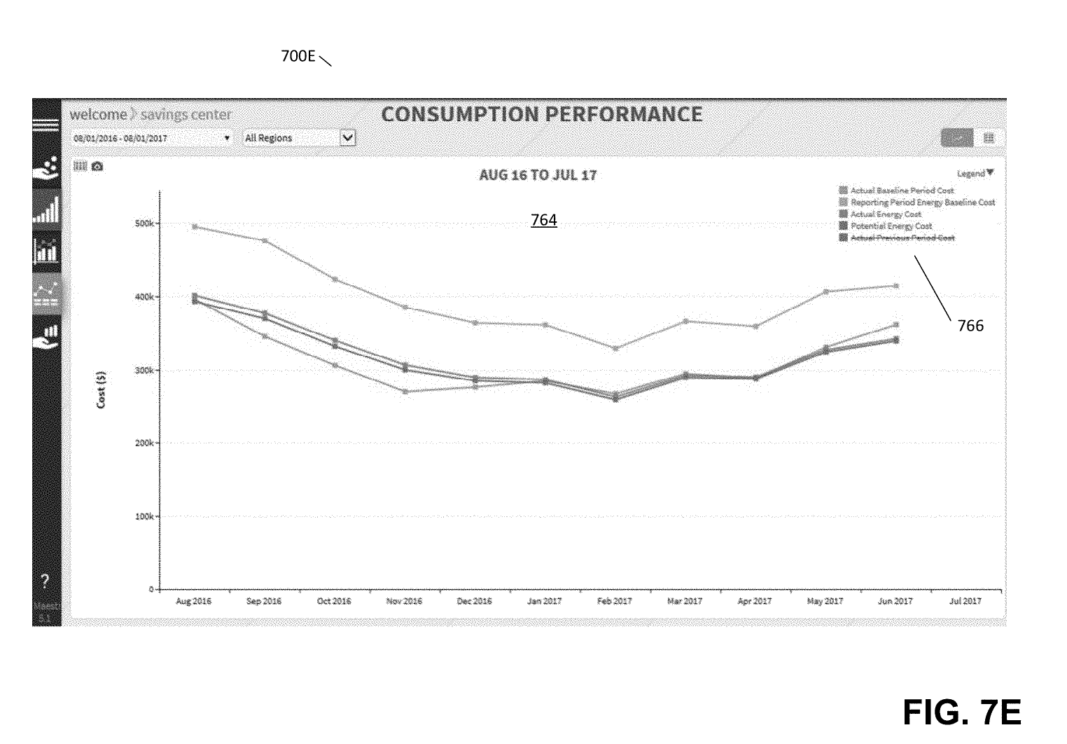

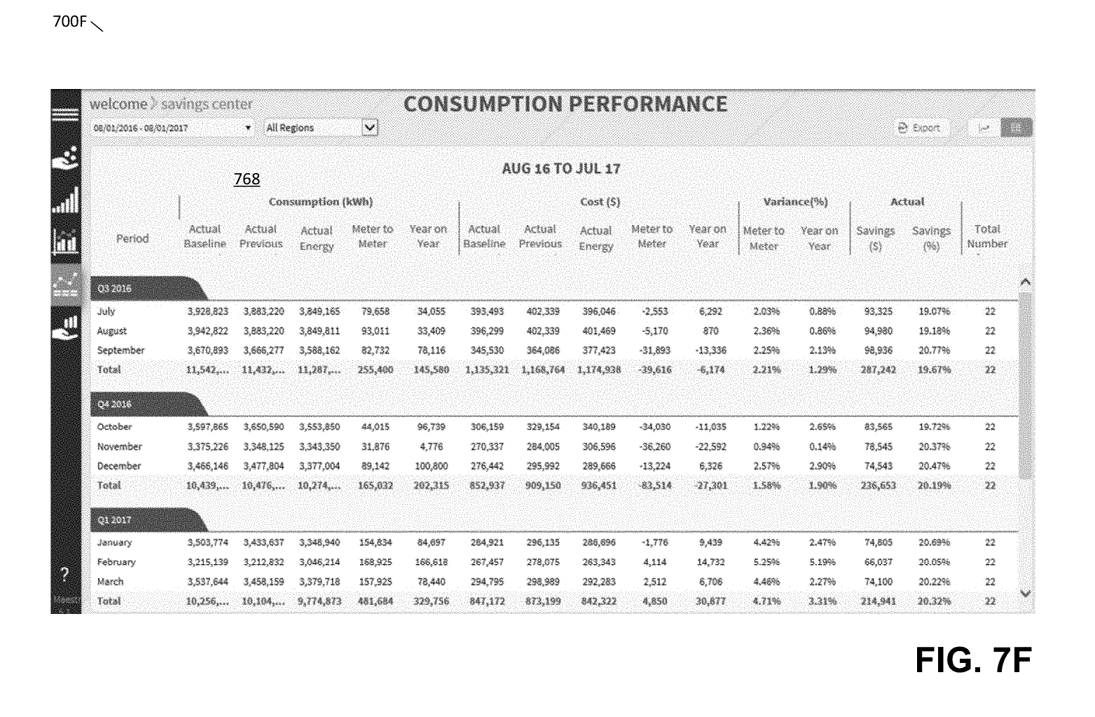

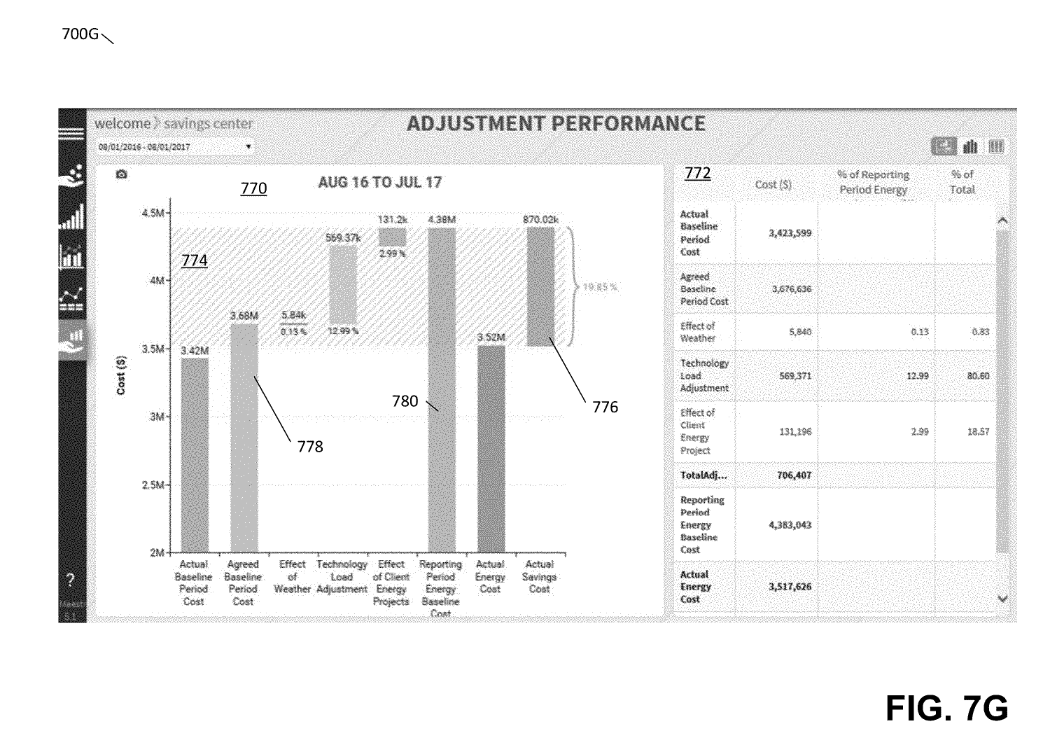

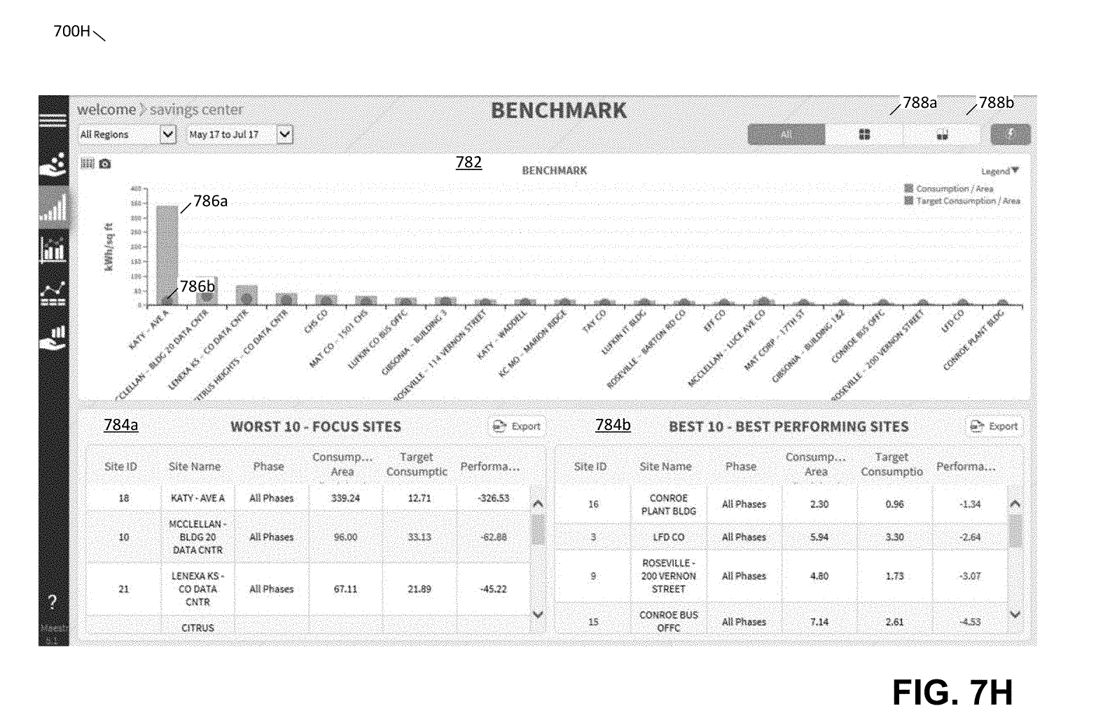

FIGS. 7A-7H show, respectively, illustrative pages 700A-H of a savings center, in accordance with some embodiments. For instance, the page 700A may be a landing page that a user may reach by activating the savings icon 507 from the illustrative home page 500 in the example of FIG. 5, and the pages 700B-H may be versions of dashboards that the user may reach by activating menu items from a side menu of the page 700A and/or other user interface features.

In some embodiments, one or more of the pages 700A-H may present resource savings information (e.g., baseline consumption, actual savings, potential savings, etc.) over one or more periods of time (e.g., within a past week, month, quarter, year, etc., since subscription to a consumption reduction service associated with the consumption management system, year to date, and/or any other suitable time period). Additionally, or alternatively, resource savings information may be broken down into suitable categories (e.g., based on a purpose of consumption such as production, lighting, HVAC, mechanical load, etc.).

In the example of FIG. 7A, a main display area 701 of the landing page 700A is divided into a plurality of areas, 710, 730, and 740. The area 710 may present actual and/or potential savings information for one or more time periods. For instance, there may be one or more rows corresponding, respectively, to one or more time periods, such as past month (711a), past year (711b), since subscription to a consumption reduction service associated with the consumption management system (771c), etc. Additionally, or alternatively, there may be two columns, actual resource savings (713a) and potential resource savings (713b). The actual savings column may present information regarding one or more consumption reduction measures that were actually implemented, whereas the potential savings column may present information regarding one or more consumption reduction measures that were recommended but not actually implemented.

In some embodiments, one or more pieces of numerical information may be displayed for each time period in the actual savings column, such as savings expressed as a percentage of baseline consumption (715a), as a monetary amount (717a), and as an amount of resource such as in kWh for electricity (719a). Additionally, or alternatively, one or more visual indicia may be displayed, such as a green upward arrow (721a) indicating that savings increased in the time period of question relative to a previous time period. Similar numerical information 715b, 717b, 719b and visual indicium 721b may be displayed for the same time period in the potential savings column. Although not shown, a red downward arrow may be used to indicate that savings decreased in the time period of question relative to a previous time period. In this manner, a user may be able to perceive, at one glance, how a consumption reduction service associated with the consumption management system is performing across time periods.

In the example of FIG. 7A, the area 730 may illustrate how baseline consumption is established and how actual savings and potential savings compare against baseline consumption. For instance, the baseline consumption may be represented by a bar 731, and an adjacent bar 733 of a same length as the bar 731 may illustrate how the baseline consumption is established by making one or more adjustments to agreed baseline period consumption (also referred to as baseline period effective consumption).

In some embodiments, the baseline period effective consumption may be obtained by making one or more adjustments to actual consumption during a selected baseline period (e.g., a past time period of a same length as a current reporting period), where each adjustment may account for an incident that happened during the baseline period and had an impact on resource consumption going forward. For example, if energy efficient lighting fixtures were installed during the baseline period but were not part of a consumption reduction service associated with the consumption management system, the actual baseline period consumption may be adjusted down for a portion of the baseline period prior to the installation, as if the energy efficient lighting fixtures were installed at a beginning of the baseline period. This may allow a more accurate comparison between the baseline period and the reporting period, because the energy efficient lighting fixtures were in operation for the entirety of the reporting period but only a portion of the baseline period.

In some embodiments, the baseline period effective consumption may be adjusted to take into account one or more conditions that impact resource consumption. For instance, a relationship may be estimated between resource consumption and weather conditions such as temperature (e.g., by performing regression analysis on a plurality of available data points), and the relationship may be used to adjust the baseline period effective consumption to match weather conditions observed during the reporting period, thereby obtaining an amount of resource that would have been consumed during the baseline period if the weather conditions observed during the baseline period had been identical to those observed during the reporting period.

Additionally, or alternatively, the baseline period effective consumption may be adjusted to take into account one or more incidents that happened during the baseline period and would impact resource consumption going forward. For example, if energy efficient lighting fixtures were installed during the reporting period but were not part of a consumption reduction service associated with the consumption management system, the baseline period effective consumption may be adjusted up for a portion of the reporting period following the installation, as if the energy efficient lighting fixtures were not installed. This may allow a more accurate assessment of resource reduction that is attributable to the consumption reduction service associated with the consumption management system, as opposed to efforts made by an enterprise independently to reduce consumption.

Referring again to the example of FIG. 7A, the area 730 includes another bar 735 of the same length as the bar 731. The bar 735 may illustrate how much resource was actually consumed during the reporting period, at a same scale as the bar 731 representing the baseline consumption. The bar 735 may also illustrate an amount of resource savings that may be attributable to the consumption reduction service associated with the consumption management system, as a difference between the baseline consumption and the reporting period actual consumption.

Similarly, in the example of FIG. 7A, the area 730 includes yet another bar 737 of the same length as the bar 731. The bar 737 may illustrate how much resource could potentially have been consumed during the reporting period, at a same scale as the bar 731 representing the baseline consumption. The bar 735 also illustrates an amount of resource savings that could potentially have been achieved had all recommended consumption reduction measures been implemented, as a difference between the baseline consumption and the reporting period potential consumption.

In some embodiments, the baseline period effective consumption and the one or more adjustments shown in the bar 733 may be color coded, so that a user may be able to quickly gain an intuitive understanding of relative significance of these components of the baseline consumption. Likewise, the actual savings and the reporting period actual consumption shown in the bar 735, as well as the potential savings and the reporting period potential consumption shown in the bar 737, may also be color coded, so that the user may be able to quickly gain an intuitive understanding of how much resource savings may be attributable to the consumption reduction service associated with the consumption management system, and how much more resource savings could have been achieved had all recommended measures been implemented. In the example of FIG. 7A, a legend 739 is provided to explain the color coding to the user.

Referring again to the example of FIG. 7A, the area 740 shows resource savings expressed in alternative units. In some embodiments, the resource savings shown may be cumulative savings from a beginning of a consumption management project. As an example, total resource savings may be converted to equivalent reduction in a same type of resource, such as a number of 60 W bulbs that would have used an equivalent amount of electricity if used for 8 hour per day for a year, as shown at 741. As another example, total resource savings may be converted to equivalent reduction in a different type of resource, such as gallons of fuel (e.g., based on cost of electricity and cost of gasoline), as shown at 745. As another example, total resource savings may be converted to associated savings in environmental costs, such as tons of CO₂(e.g., based on any suitable formula for calculating environmental footprint of electricity consumption), as shown at 743. Such alternative expressions may help a user gain an intuitive understanding of a significance of the resource savings that have been achieved. However, it should be appreciated that aspects of the present disclosure are not limited to the use of any particular alternative expression, or any alternative expression at all.

Although various techniques for summarizing resource savings are illustrated in FIG. 7A and described herein, it should be appreciated that aspects of the present disclosure are not limited to the use of any particular technique to summarize resource savings, or to providing any summary at all.

FIG. 7B shows an illustrative page 700B of a savings center, in accordance with some embodiments. For instance, the page 700B may be a savings performance dashboard that a user may reach by activating a menu item from the side menu of the illustrative page 700A in the example of FIG. 7A.

The inventors have recognized and appreciated that, after viewing a summary of salient information, a user may wish to drill down and view more detailed information. For instance, after reviewing a savings summary displayed at the page 700A in the example of FIG. 7A, a user may wish to compare actual and/or potential savings against certain predetermined targets. Accordingly, in some embodiments, a savings performance dashboard may be provided, for instance, via the page 700B in the example of FIG. 7B.

In some embodiments, the page 700B may include a chart 750 showing actual savings, potential savings, and/or target savings against time. For instance, in the example of FIG. 7B, there may be two bars for each time period (e.g., day, week, month, quarter, year, etc.), representing, respectively, actual savings and potential savings. Target savings may be shown using a line plot. In this manner, a user may be able to understand, at one glance, how the actual savings and the potential savings compare against the target savings. However, it should be appreciated that aspects of the present disclosure are not limited to the use of any particular type of charts.

In some embodiments, one or more filters may be provided to allow a user to specify what data to include in a dataset displayed in the chart 750. For instance, in the example of FIG. 7B, a filter 752a is provided to allow the user to select a time period, and a filter 752b is provided to allow the user to select one or more geographical regions. In response to the user specifying one or more filter criteria, the savings performance dashboard may automatically update the chart 750 to reflect only data matching the one or more filter criteria. Any other suitable filter (e.g., by site, resource type, load category, etc.) may be used in addition to, or instead of these filters, as aspects of the present disclosure are not limited to the use of any particular filter, or any filter at all.

In the example of FIG. 7B, a user may be able to save a snapshot of the page 700B by clicking or otherwise activating a snapshot button 756. In this manner, the user may be able to save a desired view of data without having to use an external application. However, it should be appreciated that aspects of the present disclosure are not limited to the use of a snapshot button.

In some embodiments, a user may able to navigate from the illustrative page 700A in the example of FIG. 7A to the page 700B in the example of FIG. 7B in different ways. For instance, the user may click or otherwise selecting an entry (e.g., 715a-b, 717a-b, 719a-b, 721a-b, etc.) in the area 710 of the page 700A. That may bring up the page 700B, with the filter 752a automatically set to a time period (e.g., 711a-c) corresponding to the selected entry in the area 710. Alternatively, or additionally, the user may click or otherwise activate a menu item from the side menu of the page 700A.

The inventors have recognized and appreciated it may be beneficial to first show a user a graphical representation of data, which may give the user a bird's-eye view of the data, and then allow the user to toggle to a tabular representation to explore more detailed information. Accordingly, in some embodiments, one or more user interface features may be provided to allow the user to toggle between a graphical representation and a tabular representations of the same or related data. For instance, in the example of FIG. 7B, buttons 754a-b are provided. When a user first arrives at the illustrative page 700B, a graphical representation may be shown to the user. The user may activate the button 754b to switch to a tabular representation, and then may activate the button 754a to switch back to the graphical representation. However, it should be appreciated that aspects of the present disclosure are not limited to the use of any particular toggling feature, or any toggling feature at all. For instance, in some embodiments, a toggle may be implemented using a single switch (instead of two buttons). Alternatively, or additionally, a toggle may allow a user to toggle through more than two representations.

FIG. 7C shows an illustrative page 700C with a tabular representation of data, in accordance with some embodiments. For instance, the page 700C may result from a user activating the button 754b of the illustrative page 700B in the example of FIG. 7B. The page 700C may include a table 758 having multiple tabs, each tab corresponding to a respective time period (e.g., day, week, month, quarter, year, etc.). Each tab may include multiple rows corresponding, respectively, to constituent time periods (e.g., days within a week, weeks within a month, months within a quarter, quarters within a year, etc.).

In some embodiments, columns in the table 758 may correspond, respectively, to target savings, actual savings, missed savings, potential savings, number of sites under consideration, reporting period baseline, etc. Target savings may be determined in any suitable manner, such as being specified by an enterprise operating one or more sites under consideration. Actual savings may indicate savings attributable to one or more consumption reduction measures that were actually implemented, whereas missed savings may indicate savings that would have been achieved by implementing one or more consumption reduction measures that were approved but not yet implemented, and potential savings may indicate savings that would have been achieved by implementing one or more consumption reduction measures that were recommended but not approved for implementation.

Target savings, actual savings, missed savings, potential savings, and/or reporting period baseline may be expressed in any suitable manner, for example, as monetary amounts and/or amounts of resource (e.g., kWh for electricity). Additionally, or alternatively, target savings may be expressed as a percentage of reporting period baseline, and/or actual savings, missed savings, and/or potential savings may be expressed as a percentage of target savings.

In some embodiments, a button 754c may be provided to allow a user to export the data shown in the table 758 to a file, for example, a file in a comma-separated values (CSV) format, or any other suitable format.

The inventors have recognized and appreciated that it may be beneficial to provide guidance as a user explores a user interface of a consumption management system. For instance, in the example of FIG. 7C, a user may click or otherwise activate a help button 760 (e.g., “?” near bottom of the side menu) to bring up a message designed to help the user interpret data shown in the table 758. FIG. 7D shows a help message 762 in an illustrative page 700D, in accordance with some embodiments.

The inventors have recognized and appreciated that, after comparing various types of savings (e.g., target, actual, missed, potential, etc.), a user may wish to view a breakdown of how one or more types of savings are determined. Accordingly, in some embodiments, a consumption performance dashboard may be provided, for instance, via the page 700E in the example of FIG. 7E. To reach the page 700E, the user may click or otherwise activate a menu item from the side menu of the illustrative page 700B in the example of FIG. 7B.

In some embodiments, the page 700E may include a chart 764 showing, against time, baseline period actual consumption, reporting period baseline consumption, reporting period actual consumption, reporting period potential consumption, and/or previous period actual consumption. Although line plots are used for easy comparison, it should be appreciated that aspects of the present disclosure are not limited to the use of any particular type of charts. Moreover, although consumption is expressed in monetary terms, that is not required, as consumption in terms of amount of resource (e.g., kWh for electricity) may be also used.

The inventors have recognized and appreciated that a user may find certain types of consumption more relevant than others. Accordingly, in the example of FIG. 7E, the user is able to click or otherwise select one or more consumption types from a legend 766. One or more curves corresponding to the selected one or more consumption types may be hidden, which may reduce clutter in the chart 764 and thereby allow the user to focus on the remaining curves. The user may be able to click or otherwise select a hidden consumption type (which may be shown with a strikethrough in legend 766) to make a corresponding curve visible again.

FIG. 7F shows an illustrative page 700F with a tabular representation of data, in accordance with some embodiments. For instance, the page 700F may result from a user clicking or otherwise activating a toggle button (not labeled) of the illustrative page 700E in the example of FIG. 7E. The page 700F may include a table 768 having multiple tabs, each tab corresponding to a respective time period (e.g., day, week, month, quarter, year, etc.). Each tab may include multiple rows corresponding, respectively, to constituent time periods (e.g., days within a week, weeks within a month, months within a quarter, quarters within a year, etc.).

In some embodiments, some columns in the table 768 may correspond, respectively, to baseline period actual consumption, previous period actual consumption, and/or reporting period actual consumption, expressed in terms of amount of resource (e.g., kWh for electricity) and/or in monetary terms. In some embodiments, meter-to-meter differences may be listed, comparing reporting period actual consumption to baseline period actual consumption, without normalization or adjustment. Additionally, or alternatively, year-on-year differences may be listed, comparing reporting period actual consumption to previous period actual consumption, without normalization or adjustment. Additionally, or alternatively, there may be one or more columns showing, respectively, actual savings expressed as a monetary amount, an amounts of resource, and/or a percentage of target savings, and/or a column showing a number of sites under consideration.

The inventors have recognized and appreciated that, after viewing a breakdown of how one or more types of savings are determined, a user may wish to view further breakdowns that illustrate how various adjustments impact actual savings. Accordingly, in some embodiments, an adjustment performance dashboard may be provided, for instance, via the page 700G in the example of FIG. 7G. To reach the page 700G, the user may click or otherwise activate a menu item from the side menu of the illustrative page 700E in the example of FIG. 7E.

In some embodiments, the page 700G may include a chart 770 and a table 772. The chart 770 may be a waterfall chart displaying similar information as shown in the area 730 of the illustrative page 700A in the example of FIG. 7A. A horizontal band 774 may be provided to allow a user to understand, at one glance, how actual savings 776 compares against various adjustments (e.g., effect of weather, technology load adjustment, etc.) that are made to an agreed baseline period consumption (also referred to as a baseline period effective consumption) 778 to arrive at reporting period baseline consumption 780.

In some embodiments, the table 772 may show the same data illustrated in the chart 770. Additionally, or alternatively, the table 772 may show each adjustment as a percentage of reporting period baseline consumption, and/or as a percentage of total adjustment.

FIG. 7H shows an illustrative page 700H of a savings center, in accordance with some embodiments. For instance, the page 700H may be a benchmark dashboard that a user may reach by activating a menu item from the side menu of the illustrative page 700A in the example of FIG. 7A.

In some embodiments, the page 700H may include a chart 782 and tables 784a-b. The chart 782 may show actual normalized consumption versus target normalized consumption for a plurality of sites. In the example shown in FIG. 7H, normalized consumption is determined as consumption per unit area (e.g., kWh/sq ft). However, that is not required, as consumption may be normalized in other ways (e.g., per occupant, per unit output, etc.).

In some embodiments, each bar in the chart 782 may represent actual normalized consumption for a corresponding site, and an associated indicium may be displayed along an axis of the bar to represent target normalized consumption for the same site. For instance, in the example shown in FIG. 7H, a dot 786b may be displayed along an axis of a bar 786a, to allow a user to quickly discern how a corresponding site is performing.

In some embodiments, the plurality of sites may be shown in the chart 782 in a ranked order according to some suitable metric, for example, from worst performing (e.g. highest actual normalized consumption) to best performing (e.g. lowest actual normalized consumption). In this manner, a user may be able to see, at a glance, which sites are performing well and which sites are not.

Additionally, or alternatively, one or more worst performing sites may be summarized in the table 784a, and/or one or more best performing sites may be summarized in the table 784b. Any suitable information may be shown in the tables 784a and/or 784b, including, but not limited to, site identifier, site name, phase of a consumption management project, actual consumption per unit area, target consumption per unit area, performance (e.g., difference between actual consumption per unit area and target consumption per unit area), etc. In some embodiments, toggle buttons 788a-b may be provided to allow a user to toggle through subsets of sites based on quantity.

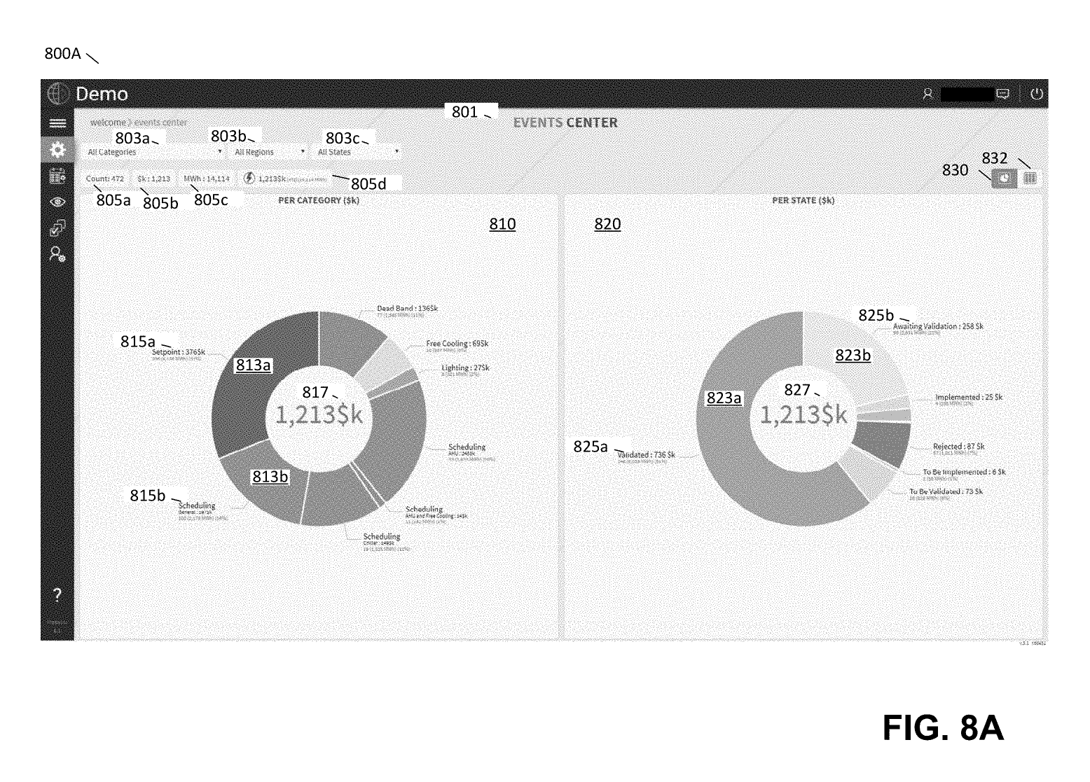

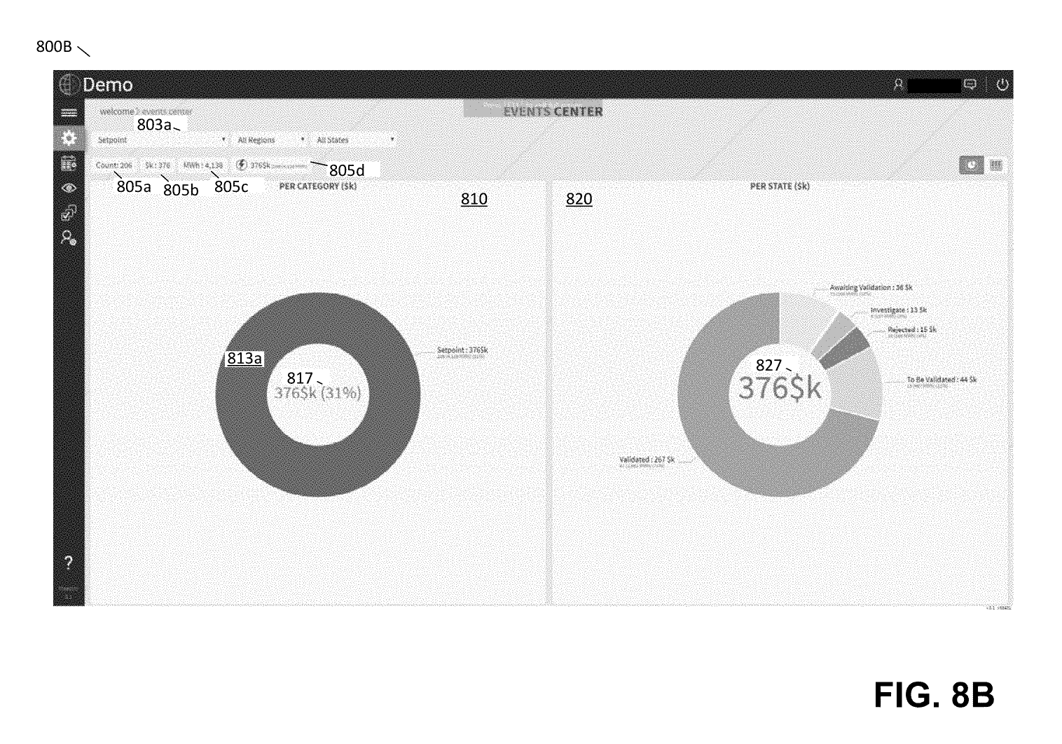

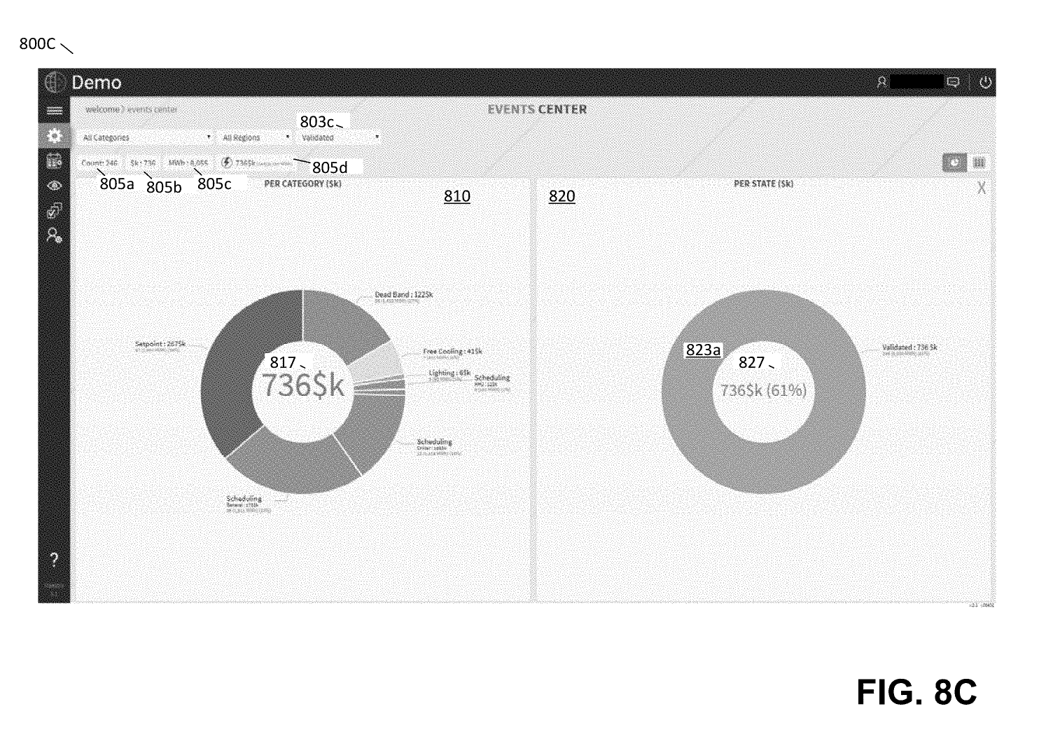

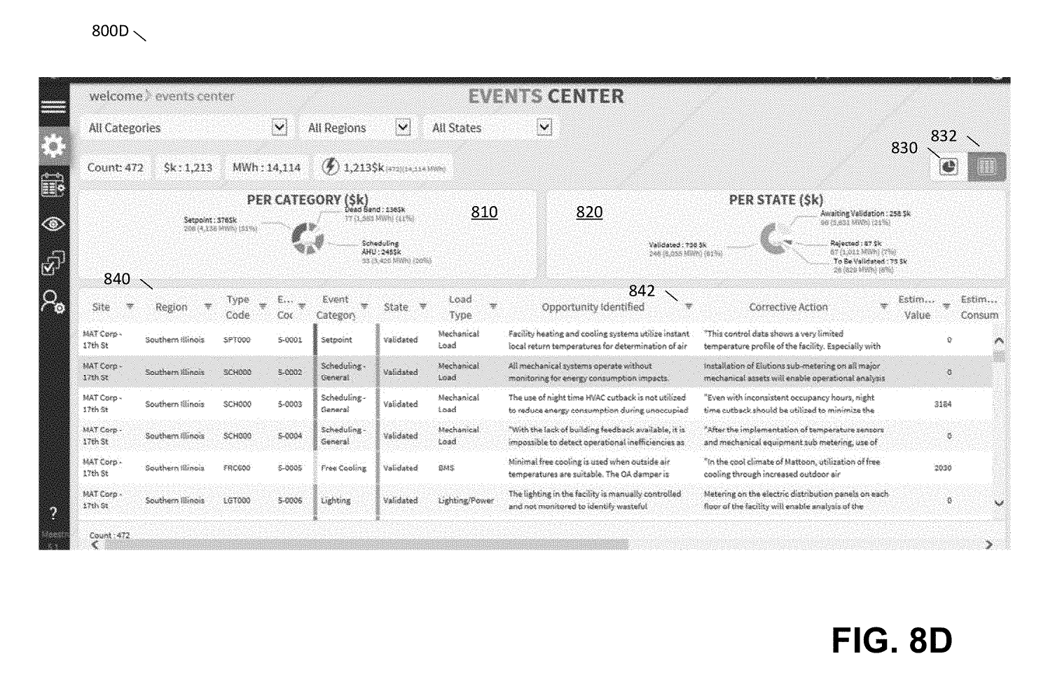

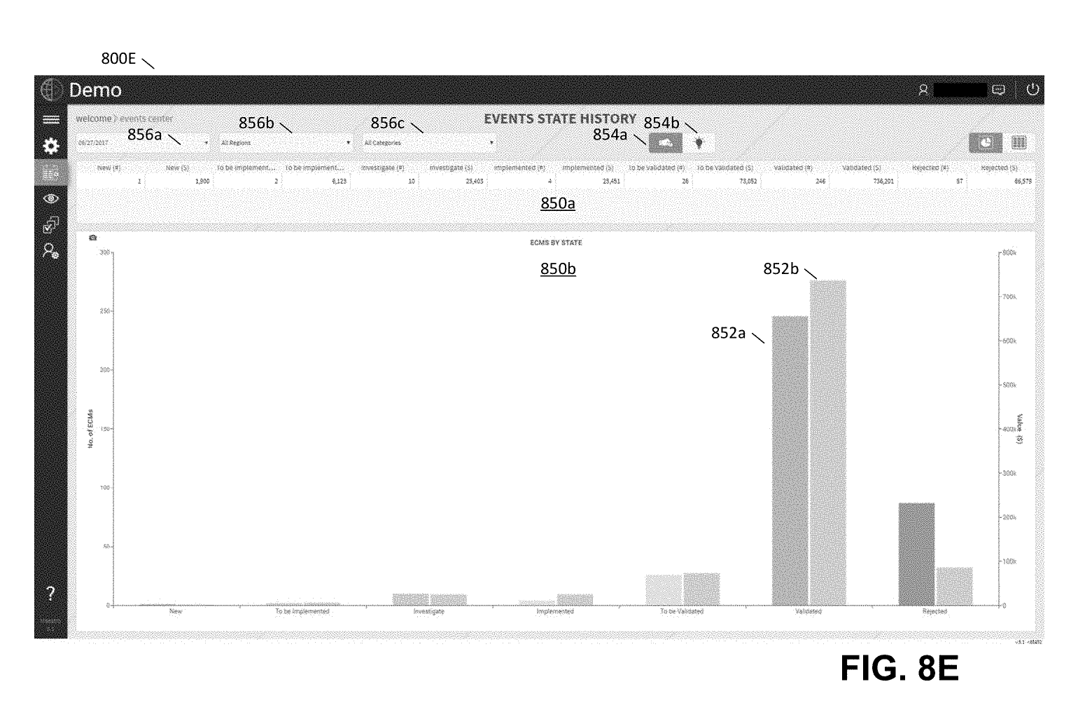

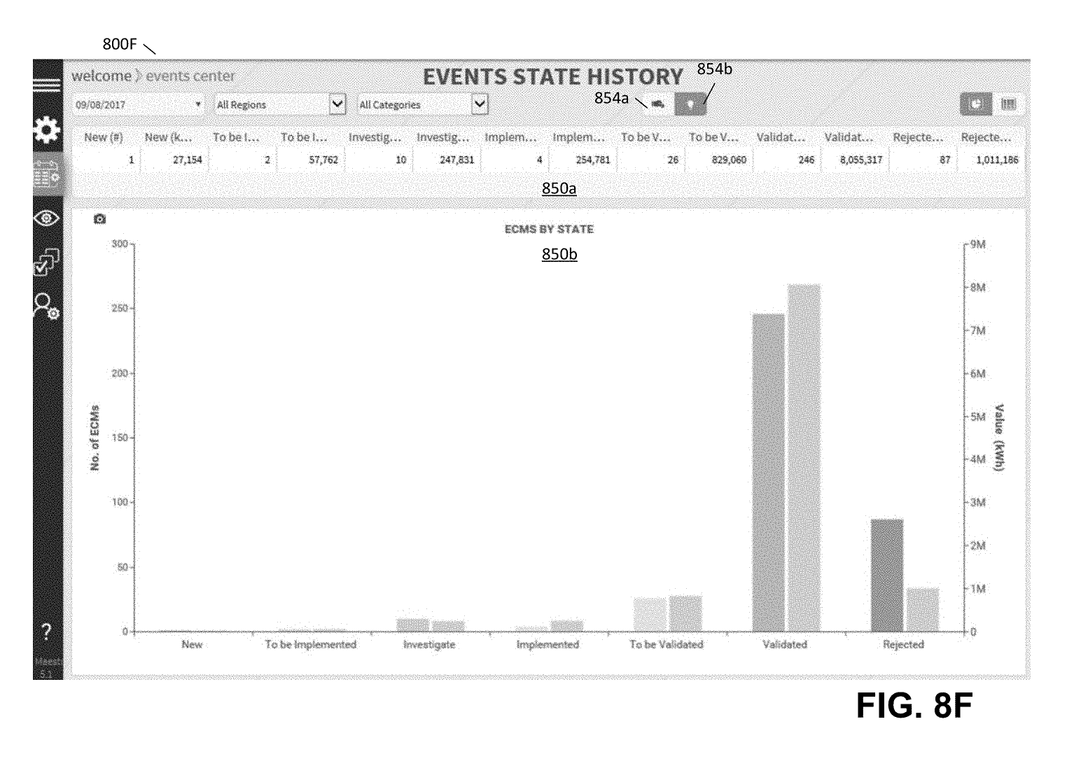

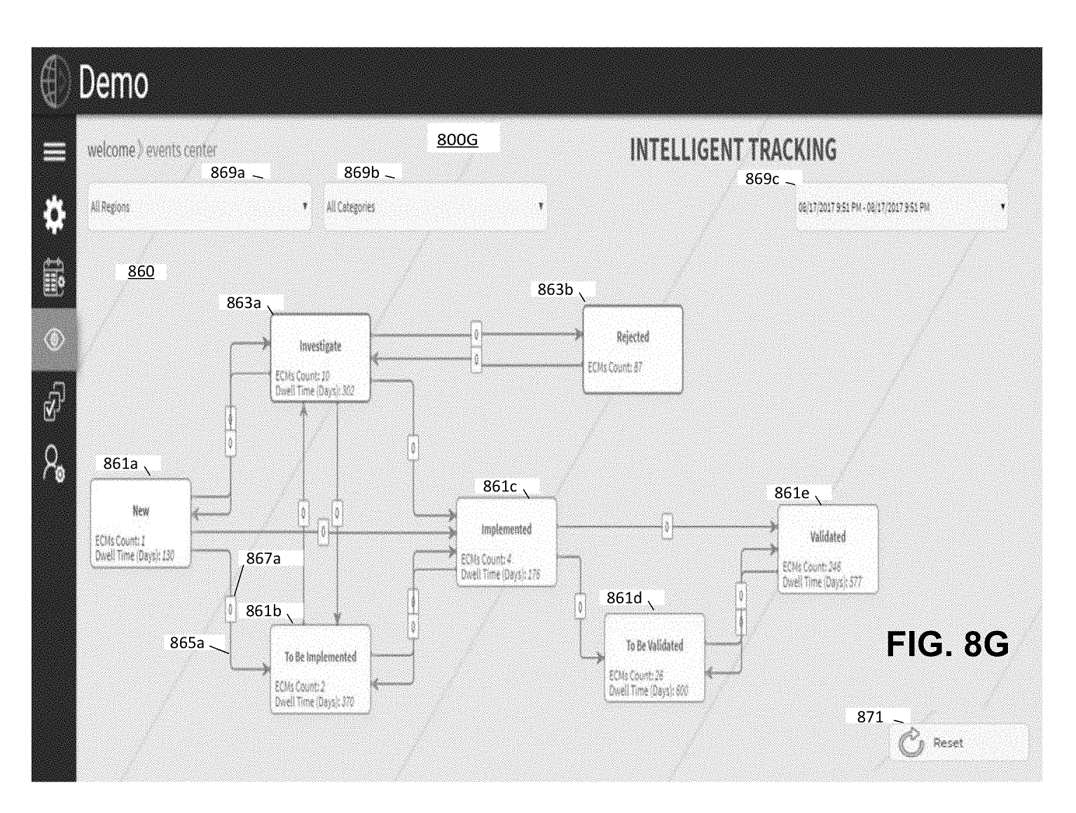

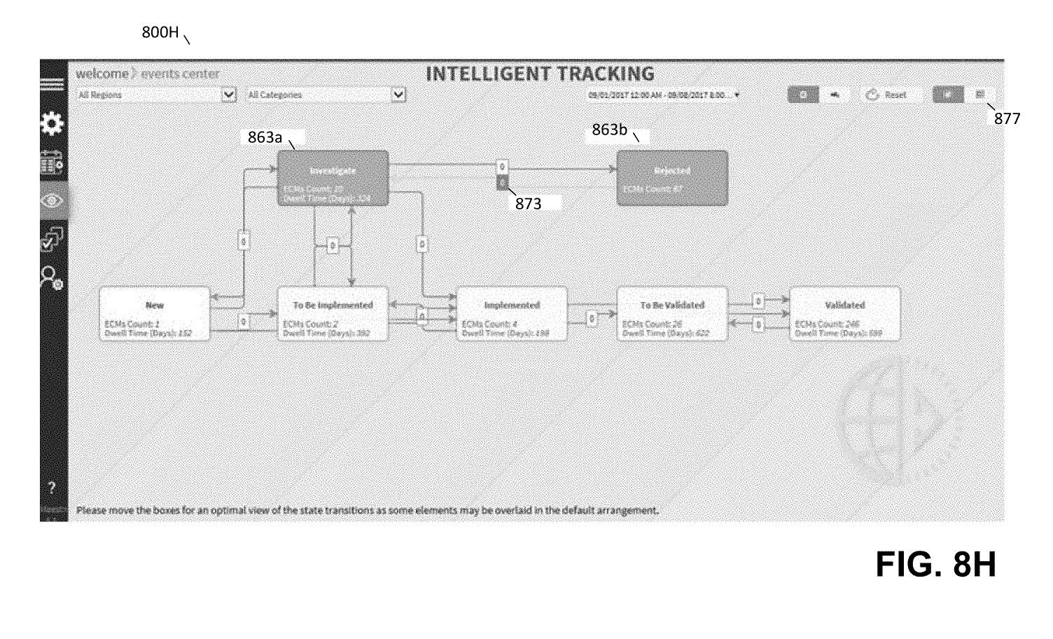

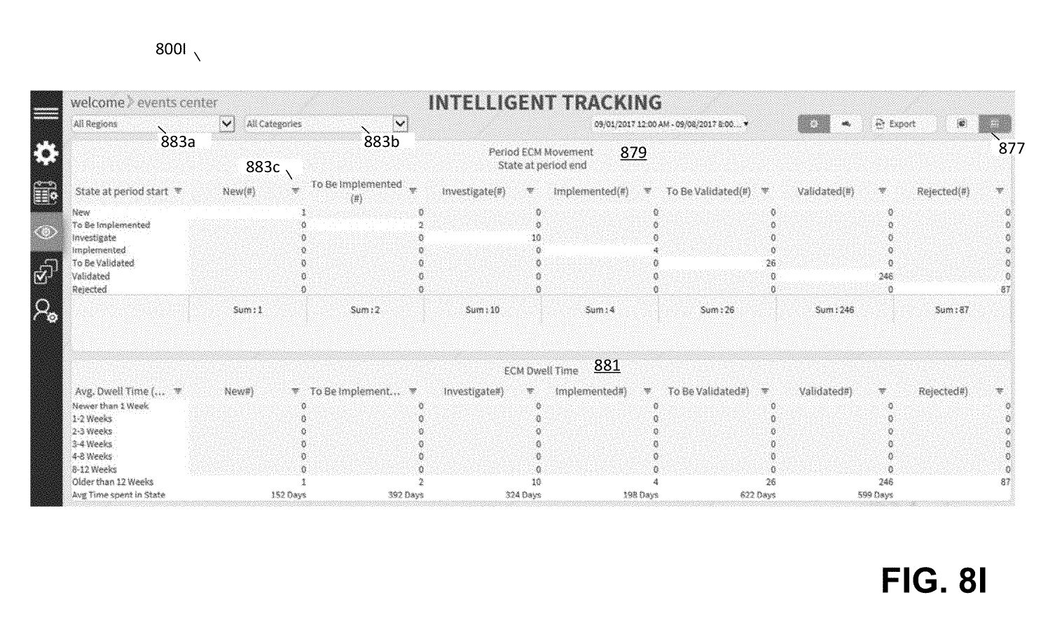

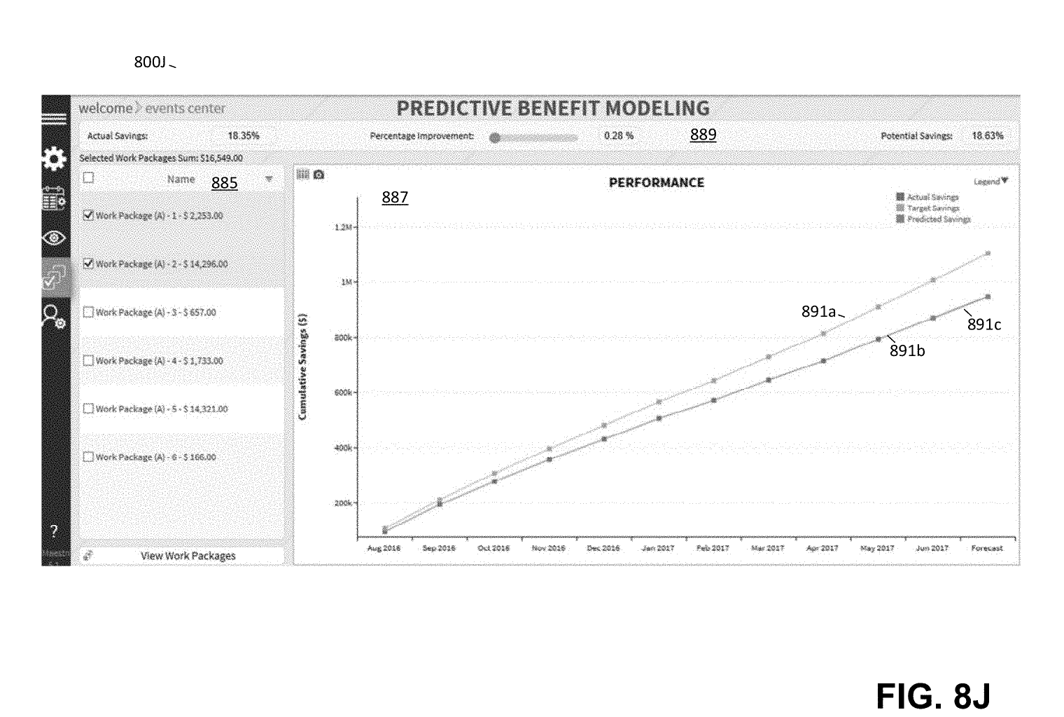

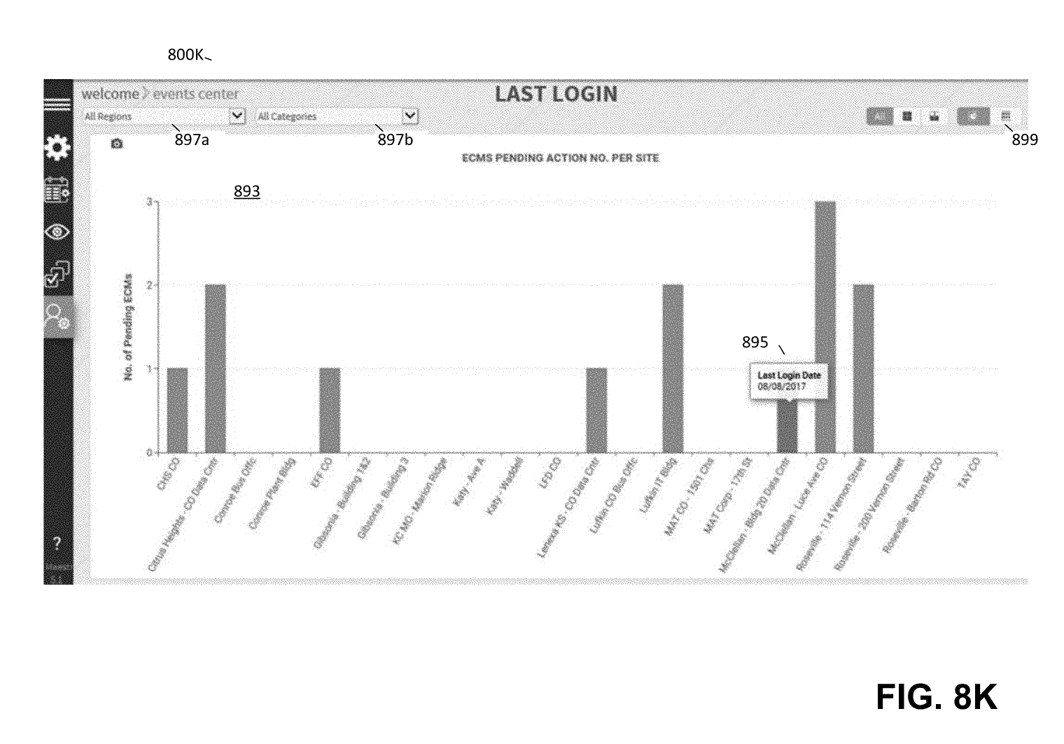

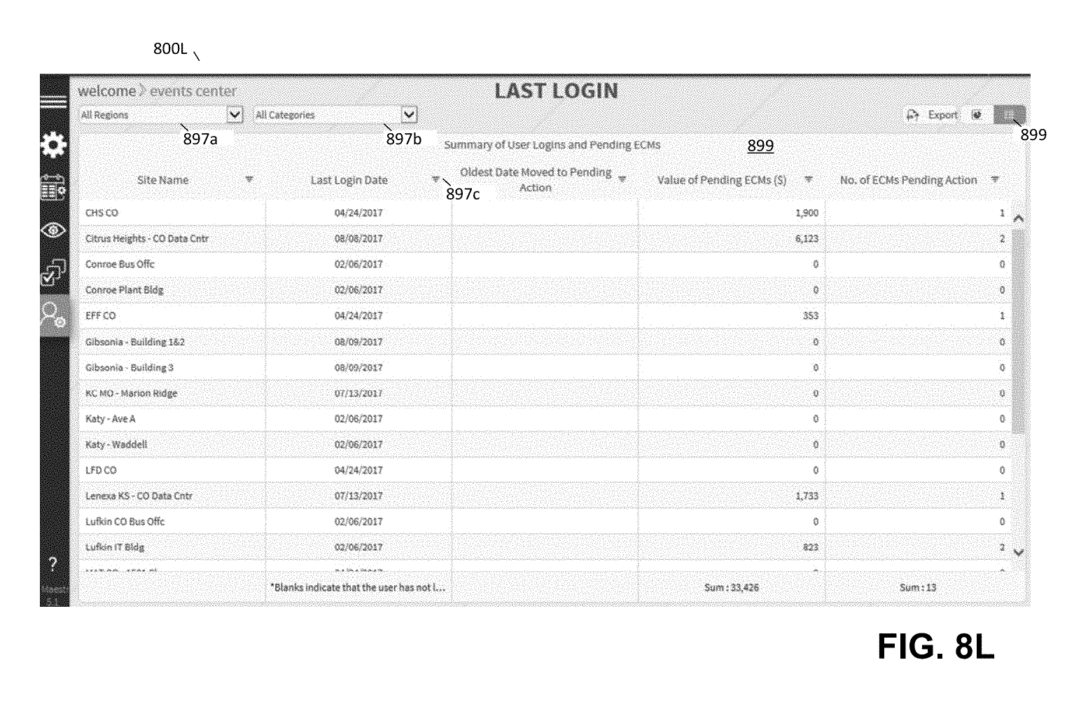

FIGS. 8A-8L show, respectively, illustrative pages 800A-L of an events center, in accordance with some embodiments. For instance, the pages 800A-D may be versions of a landing page that a user may reach by activating the events icon 509 from the illustrative home page 500 in the example of FIG. 5, and the pages 800E-L may be versions of dashboards that the user may reach by activating menu items from a side menu of the pages 800A-D and/or other user interface features.

As discussed in connection with FIG. 1, a consumption management system may analyze data received from one or more data sources to identify opportunities to reduce resource consumption. For an identified opportunity, the consumption management system may create an event record that includes one or more proposed measures for reducing resource consumption, and/or expected savings that may result from implementing the one or more consumption reduction measures. Once generated, an event may transition through multiple states (e.g., “New,” “To Be Implemented,” “Implemented,” “To Be Validated,” “Validated,” as discussed in connection with FIG. 4).

The inventors have recognized and appreciated that it may be beneficial to give a user an overview of events generated by a consumption management system, and/or allow the user to break down, filter, or otherwise manipulate data relating to the events without having to export the data into an external software application. Accordingly, in some embodiments, the events center may provide one or more curated functionalities to allow a user to gain useful insight in a glance, or with just one click.

In the example of FIG. 8A, the landing page 800A has a main display area 801 with a plurality of user interface features arranged therein, including filters 803a-c, summary statistics 805a-c, label 805d, donut charts 810 and 820, and buttons 830 and 832. In some embodiments, the donut chart 810 may display event information by event category. Examples of event categories include, but are not limited to, e.g., lighting, scheduling, set point, dead band, etc. Segments 813a, 813b, . . . in the donut chart 810 may represent events belonging to respective categories, and a size of each segment may indicate a ratio between total value of events in the corresponding event category and total value of all events. A value of an event may represent expected savings that may result from implementing one or more consumption reduction measures associated with the event, and may be expressed as an amount of resource and/or a monetary amount.

In some embodiments, the segments 813a, 813b, . . . may be labeled, respectively, by labels 815a, 815b, . . . A label may provide any suitable combination of information, including, but not limited to, a name of an event category in question, total expected savings in monetary terms for the event category, a total number of events in the event category, total expected savings as an amount of resource (e.g., in MWh for electricity) for the event category, and/or a percentage indicative of a ratio between total value of events in the event category and total value of all events. The inventors have recognized and appreciated that a user may find the illustrative labels shown FIG. 8A highly informative. However, it should be appreciated that aspects of the present disclosure are not limited to the display of any particular piece of information in a label, or to the use of any label at all.

In some embodiments, the donut chart 820 may display event information by event state. Segments 823a, 823b, . . . may represent events residing in respective event states, and a size of each segment may indicate a ratio between total value of events in the corresponding event state and total value of all events. Examples of event states include, but are not limited to, “New,” “To Be Implemented,” “Implemented,” “To Be Validated,” “Validated,” “Investigate,” “Rejected,” etc. Labels 825a, 825b, . . . may be provided, similar to the labels 815a, 815b, . . . for the donut chart 810.

The inventors have recognized and appreciated it may be beneficial to make summary information readily visible, for example, to help a user interpret the donut charts 810 and 820. Accordingly, in some embodiments, a summary statistic 817 may be provided in a center of the donut chart 810. In the example shown on FIG. 8A, the summary statistic 817 may indicate the total value of all events, which may remind the user of an overall context in which to view the donut chart 810. A similar summary statistic 827 may be provided for the donut chart 820.

Additionally, or alternatively, one or more summary statistics may be provided, for example, above the donut charts 810 and 820. In the example of FIG. 8, summary statistic 805a indicates a number of events generated by the consumption management system, and summary statistics 805b and 805c show, respectively, expected savings as a monetary amount and as an amount of resource (e.g., in MWh for electricity). A label 805d may be provided that includes the summary statics 805a-c, along with the summary statistic 817 (or 827).

The inventors have recognized and appreciated that a user may find the illustrative summary statistics shown FIG. 8A highly informative. However, it should be appreciated that aspects of the present disclosure are not limited to the display of any particular summary statistic, or any summary statistic at all.

In some embodiments, one or more filters may be provided to allow a user to specify which events to include in a dataset displayed in the donut charts 810 and 820. For instance, in the example of FIG. 8A, a filter 803a is provided to allow the user to select one or more event categories, a filter 803b is provided to allow the user to select one or more geographical regions, and a filter 803c is provided to allow the user to select one or more event states. Any other suitable filter (e.g., by site, resource type, load category, time period, etc.) may be used in addition to, or instead of these filters, as aspects of the present disclosure are not limited to the use of any particular filter, or any filter at all.

While the filters 805a-c are implemented as drop down menus in the example of FIG. 8A, that is not required. In some embodiments, a filter may be implemented using text input, or in any other suitable manner. For instance, a user may apply a filter by clicking or otherwise selecting a segment in the donut chart 810 or 820.

In some embodiments, one or more of the summary statistics 805a-c, 817, 827, the label 805d, and the donut charts 810 and 820 may be automatically updated in response to application of a filter, so that only those events matching one or more filter criteria selected by the user are reflected. FIG. 8B shows an illustrative page 800B that may result from applying an event category filter, in accordance with some embodiments. For instance, the page 800B may result from a user selecting a set point category via the illustrative filter 803a in the example of FIG. 8A. Alternatively, the page 800B may result from the user clicking or otherwise selecting the segment 813a of the illustrative donut chart 810 in the example of FIG. 8A. The segment 813a, corresponding to the set point category, may expand to fill up the entire donut chart 810, and the summary statistics 805a-c, 817, 827, the label 805d, and the donut chart 820 may be automatically updated to reflect only those events in the set point category.

FIG. 8C shows an illustrative page 800C that may result from applying an event state filter, in accordance with some embodiments. For instance, the page 800C may result from a user selecting a “Validated” state via the illustrative filter 803c in the example of FIG. 8A. Alternatively, the page 800C may result from the user clicking or otherwise selecting the segment 823a of the illustrative donut chart 820 in the example of FIG. 8A. The segment 823a, corresponding to the “Validated” state, may expand to fill up the entire donut chart 820, and the summary statistics 805a-c, 817, 827, the label 805d, and the donut chart 810 may be automatically updated to reflect only those events in the “Validated” state.

The inventors have recognized and appreciated various benefits of the illustrative user interface features shown in FIGS. 8A-8C and described herein. For instance, when a user is viewing the donut chart 810, the user may simply click or otherwise select a segment, which corresponds to an event category, to cause the donut chart 820 to show a breakdown, by event state, of events in the selected category. Likewise, when the user is viewing the donut chart 820, the user may simply click or otherwise select a segment, which corresponds to an event state, to cause the donut chart 810 to show a breakdown, by event category, of events in the selected state. However, it should be appreciated that aspects of the present disclosure are not limited to the use of any particular user interface feature. For instance, aspects of the present disclosure are not limited to generating charts based on monetary value of events, as in some embodiments one or more other metrics (e.g., count, value as an amount of resource, etc.) may be charted in addition to, or instead of, monetary value. Also, aspects of the present disclosure are not limited to the use of any particular number of donut charts, or any donut chart at all. One or more other types of graphical or non-graphical representations may be used in addition to, or instead of, donut charts.

In some embodiments, one or more user interface features may be provided to allow a user to toggle between a graphical representation and a tabular representations of the same or related data. For instance, in the example of FIG. 8A, buttons 830 and 832 are provided. When a user first arrives at the illustrative page 800A, a graphical representation may be shown to the user. The user may activate the button 832 to switch to a tabular representation, and then may activate the button 830 to switch back to the graphical representation. However, it should be appreciated that aspects of the present disclosure are not limited to the use of any particular toggling feature, or any toggling feature at all. For instance, in some embodiments, a toggle may be implemented using a single switch (instead of two buttons). Alternatively, or additionally, a toggle may allow a user to toggle through more than two representations.

FIG. 8D shows an illustrative page 800D with a tabular representation of data, in accordance with some embodiments. For instance, the page 800D may result from a user activating the button 832 of the illustrative page 800A in the example of FIG. 8A. The page 800D may include a table 840 where each row may correspond to an event record, and each column may correspond to an event record entry (e.g., site, region, type code, event code, event category, state, load type, opportunity identified, corrective action, estimated value, estimated consumption, identification date, last modification date, last modification state, dwell time, implementation cost, time taken to implement, verified value as a monetary amount, verified value as an amount of resource, implementation date, etc.).

In some embodiments, a user may adjust a width of any column in the table 840, for example, to allocate more space to more important information. In some embodiments, one or more user interface features (e.g., filter button 842) may be provided for one or more columns to allow data manipulation, including, but not limited to, sorting, filtering, etc. As one example, a user may click on any column header to sort the rows, where one click may indicate sorting in ascending order, two clicks may indicate sorting in descending order, and three clicks may indicate returning to a default or initial order. As another example, the user may use the filter button 842 to bring up a filter menu, which may allow the user to specify a filter criterion using one or more conditions such as <, <=, >, >=, =, < >, etc. for a numerical field, one or more logical operators such as AND, OR, XOR, NOT, etc., and/or conditions such as “starts with,” “Contains,” “Does Not Contain,” etc., for a text field. In this manner, the user may have a continuous productive session, without having to export data into an external application.

In the example of FIG. 8D, the illustrative donut charts 810 and 820 may be shown in a miniaturized form. However, that is not required, as in some embodiments, the page 800D may include only tabular representation of data.

FIG. 8E shows an illustrative page 800E of an events center, in accordance with some embodiments. For instance, the page 800E may be an events state history dashboard that a user may reach by activating a menu item from the side menu of the illustrative page 800A in the example of FIG. 8A.

In the example of FIG. 8E, the page 800E includes an events state history summary 850a and an events state history chart 850b. The events state history summary 850a may show one or more summary statistics, such as a number of events in each state (e.g., “New,” “To Be Implemented,” “Implemented,” “To Be Validated,” “Validated,” “Investigate,” “Rejected,” etc.) and/or a total value of events in each state. The events state history chart 850b may show the same data in graphical form. For instance, the events state history chart 850b may be a bar chart that includes two bars for each state (e.g., bars 852a and 852b for the state “Validated), representing, respectively, the number of events in the state and the total value of events in the state.

In some embodiments, one or more filters may be provided to allow a user to specify which events to include in a dataset displayed in the events state history summary 850a and the events state history chart 850b. For instance, in the example of FIG. 8E, a filter 856a is provided to allow the user to select one or more time periods, a filter 856b is provided to allow the user to select one or more geographical regions, and a filter 856c is provided to allow the user to select one or more event categories. Any other suitable filter (e.g., by site, resource type, load category, etc.) may be used in addition to, or instead of these filters, as aspects of the present disclosure are not limited to the use of any particular filter, or any filter at all.

The inventors have recognized and appreciated it may be beneficial to allow a user to toggle between monetary values of events and resource values of events. For instance, in the example of FIG. 8E, buttons 854a and 854b are provided. When a user first arrives at the illustrative page 800E, values shown in the events state history summary 850a and the events state history chart 850b may be monetary values. The user may activate the button 854b to convert the monetary values to equivalent resource values (e.g., kWh for electricity), and then may activate the button 854a to switch back to the monetary values. FIG. 8F shows an illustrative page 800F with resource values for events, in accordance with some embodiments. For instance, the page 800F may result from a user activating the button 854b of the illustrative page 800E in the example of FIG. 8E.

It should be appreciated that aspects of the present disclosure are not limited to the use of any particular toggling feature, or any toggling feature at all. For instance, in some embodiments, a toggle may be implemented using a single switch (instead of two buttons). Alternatively, or additionally, a toggle may allow a user to toggle through more than two forms of value (e.g., different currencies, environment costs such as CO₂, equivalent amounts of a same resource or a different resource, etc.).

FIG. 8G shows an illustrative page 800G of an events center, in accordance with some embodiments. For instance, the page 800G may be an intelligent tracking dashboard that a user may reach by activating a menu item from the side menu of the illustrative page 800A in the example of FIG. 8A.

As discussed in connection with FIG. 4, the inventors have recognized and appreciated it may be desirable to track progress of implementation of consumption reduction measures. For instance, statistics may be collected regarding for how long events reside in various event states. Such statistics may be used to identify and correct potential workflow issues (e.g., insufficient staffing). Accordingly, in some embodiments, a tracking dashboard may be provided, for instance, via the page 800G in the example of FIG. 8G.

In some embodiments, the page 800G may include a canvas 860 on which a state transition diagram is shown. For instance, in the example of FIG. 8G, the state transition diagram includes states 861a-e and 863a-b, corresponding, respectively, to event states “New,” “To Be Implemented,” “Implemented,” “To Be Validated,” “Validated,” “Investigate,” and “Rejected.” The states 861a-e and 863a-b may be represented in any suitable manner, for example, using boxes, circles, ovals, etc.

Additionally, the state transition diagram may include one or more transitions, where each transition has an origin state and a destination state. For instance, in the example of FIG. 8G, there is a transition 865 from the state 861a (“New”) to the state 861b (“To Be Implemented”). The transition 865 may be represented in any suitable manner, for example, as a straight line, a curved line, a line with alternating horizontal and vertical segments, etc.

The inventors have recognized and appreciated that it may be desirable to display one or more statistics regarding events in a certain state. For instance, a user may wish to know where in a workflow events tend to accumulate, so that one or more actions may be taken to improve the workflow. Accordingly, in the example of FIG. 8G, each state is labeled with an event count and a dwell time. For instance, there may be 26 event currently in the state 861d (“To Be Validated”), and the dwell time for that state is 600 days. In this manner, a user may be able to tell, at one glance, that a bottleneck may exist in getting events validated.

In some embodiments, dwell time for a certain state may be computed by taking an average (e.g., mean, median, or mode), over all events that are currently in that state, of an amount of time an event has spent in that state. Alternatively, an average may be taken over all events that have moved through the state in question during a selected time period, such as past day, week, month, quarter, six months, year, etc., or a time period indicated by a user (e.g., via a menu 869c in the example of FIG. 8G). However, that is not required, as other ways to measure delays associated with a state may also be suitable.

In some embodiments, a user may use event counts and dwell times to identify bottlenecks in implementing recommended consumption actions, for instance, by determining a throughput of consumption management events at each state. The user may focus on reducing a dwell time of a state with a large backlog of events by allocating more resources.

In some embodiments, a transition may be labeled to indicate direct movement of events from one state to another during a selected period of time. For instance, in the example of FIG. 8G, the menu 869c may default to a time period starting at an end of a previous week and ending at a present time. A user may activate the menu 869c to specify a time period, for example, by typing into one or more text boxes, and/or by selecting a beginning time (e.g., time of day and/or date) and/or an end time (e.g., time of day and/or date) from a calendar. In response to the user's selection, the tracking dashboard may automatically update a label 867a of the transition 865a to indicate a number of events that have moved from the state 861a (“New”) to the state 861b (“To Be Implemented”) during the specified time period. Additionally, or alternatively, dwell time in each of the states 861a-b may be updated to take into account only those events that moved through the state in question during the selected time period.

Although not shown, the tracking dashboard may, in some embodiments, keep track of direct and indirect movement of events. For instance, there may be a transition from the state 861a (“New”) to the state 861c (“Implemented”), and the transition may have a label indicating how many events moved from the state 861a (“New”) to the state 861c (“Implemented”) either directly or indirectly via one or more other states. In some embodiments, such a transition may be visually distinguished from a direct transition from the state 861a (“New”) to the state 861c (“Implemented”). For example, a direct transition from the state 861a (“New”) to the state 861c (“Implemented”) may be shown using a solid line, whereas a combined transition (direct and indirect) may be shown using a dotted line.

In some embodiments, one or more filters may be provided in addition, or instead of, the time filter 869c. These filters may allow a user to specify which events should be included when calculating an event count and/or a dwell time for a state, and/or an event count for a transition. For instance, in the example of FIG. 8G, a filter 869b is provided to allow the user to select one or more event categories and a filter 803b is provided to allow the user to select one or more geographical regions. Any other suitable filter (e.g., by site, resource type, load category, etc.) may be used in addition to, or instead of these filters, as aspects of the present disclosure are not limited to the use of any particular filter, or any filter at all.

In some embodiments, an event count and/or a dwell time for a state, and/or an event count for a transition, may be automatically updated in response to application of a filter, so that only those events matching one or more filter criteria selected by the user are reflected. This may advantageously allow the user to drill down into finer segments of data to explore whether and/or how certain factors may impact a pipeline of consumption management events. For instance, the user may be able to explore whether sites in different regions approve recommended measures for implementation at comparable rates, whether events in different categories (e.g., HVAC vs. production equipment) take more or less time to implement, whether a corrective action has adequately addressed a workflow issue (e.g., by comparing event movement before the corrective action and event movement after the corrective action). In this manner, the user may be able to, with just a few clicks, gain insight into differences and/or inefficiencies from highly complex and/or voluminous data.

In some embodiments, an event may proceed through a normal flow, such as from “New” to “To Be Implemented,” to “Implemented,” to “To Be Validated,” and to “Validated.” States along a normal flow may be visually distinguished from other states, for example, by showing the states along the normal flow with a colored border. This may allow a user to quickly identify states that are outside the normal flow, for example, to see how many events have fallen off the normal flow and whether there is a problem to be addressed. However, it should be appreciated that aspects of the present disclosure are not limited to visually distinguishing a normal flow, or to designating any path as a normal flow.

The inventors have recognized and appreciated that a state transition diagram may become crowded when there are many states and/or many transitions. Accordingly, in some embodiments, the tracking dashboard may allow a user to move one or more of the states 861a-e and 863a-b, for example, by clicking or otherwise selecting any of states 861a-e and 863a-b, and dragging the selected state to a desired position or otherwise indicating the desired position. This may be done using any suitable input device such as mouse, touchpad, touchscreen, gesture detection device, etc. In some embodiments, the tracking dashboard may allow a user to return one or more moved states to respective default positions, for example, by activing a reset button 871.

In some embodiments, the tracking dashboard may be programmed to, in response to the user moving a state, automatically redraw a transition having the moved state as an origin or a destination. For instance, the transition may appear to remain attached to the state as the state is being moved by the user. In some embodiments, a label of the transition indicating a number of events that moved along the transition may remain centered on the transition as the transition is redrawn. Alternatively, the label may be repositioned along the transition so as to avoid visually obscuring a label of another transition.

FIG. 8H shows an illustrative page 800H that may result from a user selecting a transition, in accordance with some embodiments. In this example, the user selects a transition 873, for instance, by clicking or hovering over the transition 873. In response, the tracking dashboard may highlight an origin state and/or a destination state of the transition 873 (e.g., the states 863a-b). This may allow the user to focus on the transition 873 and easily see statistics relating to the transition 873 and/or the states 863a-b.

FIG. 8I shows an illustrative page 8001 with a tabular representation of data, in accordance with some embodiments. For instance, the page 8001 may result from a user activating the button 877 of the illustrative page 800H in the example of FIG. 8H. In some embodiments, the page 8001 may include a table 879 showing movement of consumption management events between states during a selected time period. For instance, each row in the table 879 may correspond to an event state, and likewise for each column. Each cell in the table 879 may include a number indicating how many events moved, during the selected time period, from a state corresponding to a row of the cell, to a state corresponding to a column of the cell. For example, if five consumption management events moved from “New” to “To Be Implemented” during the selected time period, then the number “5” may be shown in the cell in the “New” row and the “To Be Implemented” column. Moreover, each cell along a diagonal of the table 879 may show a number of events that stayed in a state corresponding to the cell throughout the selected time period.

In some embodiments, the page 8001 may include a table 881 showing dwell time of events in various states. For instance, each row in the table 881 may correspond to a length of time (e.g., less than one week, 1-2 weeks, 2-3 weeks, 3-4 weeks, 4-8 weeks, 8-12 weeks, over 12 weeks, etc.), while each column may correspond to an event state. Each cell in the table 881 may show a number of events that spent a length of time corresponding to the cell, in a state corresponding to the cell. For example, if 20 events that are currently in the state “To Be Implemented” have spent between two and three weeks in that state, then the number “20” may be shown in the cell in the “2-3 Weeks” row and the “To Be Implemented” column. In some embodiments, the table 881 may include a row showing, in each column, an average (e.g., mean, media, or mode) amount of time consumption management events spend in a state corresponding to the column, or any other suitable measure of productivity associated with that state, where the average is taken over events currently in that state.

In some embodiments, the page 8001 may include one or more user interface features (e.g., filters 883a-c) for data manipulation, including, but not limited to, sorting, filtering, etc. In some embodiments, a user may click or otherwise select any cell in the tables 879 and 881 to view details regarding events referenced in that cell. In this manner, the user may investigate events that have been delayed, and/or compare such events with events that have progressed smoothly. Thus, the user may be able to, with just a few clicks, gain useful insight into a flow of events through an event life cycle.

Although various user interface techniques are shown in FIGS. 8G-8I to facilitate analysis of event movement, it should be appreciated that aspects of the present disclosure are not limited to any of these user interface techniques, or to tracking of events.

FIG. 8J shows an illustrative page 800J of an events center, in accordance with some embodiments. For instance, the page 800J may be a predictive benefit modeling dashboard that a user may reach by activating a menu item from the side menu of the illustrative page 800A in the example of FIG. 8A.

The inventors have recognized and appreciated that it may be beneficial to allow a user to view and analyze a plurality of events collectively (e.g., events that relate to a same piece of equipment, a same type of equipment, a same site, etc.). Accordingly, in some embodiments, one or more work packages may be created, each comprising a plurality of events. A predictive benefit modeling dashboard may be provided, for instance, via the page 800J in the example of FIG. 8J, to allow a user to view potential savings that may result from implementing consumption reduction measures in one or more work packages. In some embodiments, a work package may be automatically generated, for example, based on ease of implementation and/or cost. Any suitable technique may be used to generate work packages, such as machine learning.

In the example shown in FIG. 8J, the page 800J includes a work package list 885, a performance chart 887, and a header 889. The work package list 885 may show one or more work packages that have yet to be completely implemented. For instance, a work package may be included in the work package list 885 if the work package includes at least one event in a “New,” “To Be Implemented,” or “Investigate” state. Each work package may be shown with a value indicating expected savings that may result from implementing one or more consumption reduction measures in the work package that have yet to be implemented. In some embodiments, a user may view a list of events in a work package by clicking or otherwise selecting the work package from the work package list 885.

In some embodiments, one or more user interface features (e.g., check boxes) may be provided to allow a user to select one or more of the work packages shown in the work package list 885. In response to a user's selection, the predictive benefit modeling dashboard may calculate total expected savings that may result from completing the selected work packages. Additionally, or alternatively, the predictive benefit modeling dashboard may update the performance chart 887. For instance, the performance chart 887 may show curves 891 a-b representing, respectively, cumulative target savings and cumulative actual savings as functions of time. Upon the user's section, the predictive benefit modeling dashboard may extend the curve 891b with a segment 891c based on the calculated total expected savings that may result from completing the selected work packages.

In some embodiments, the header 889 may show actual savings and/or potential savings as percentages of actual consumption. In some embodiments, the header 889 may include a slider, a text box, and/or any other user interface feature for allowing a user to specify a percentage improvement in savings. In response to the user moving the slider or otherwise specifying a percentage improvement, the predictive benefit modeling dashboard may automatically identify one or more work packages in the work package list 885 such that completing the identified one or more work packages may achieve the percentage improvement specified by the user. For instance, the work packages may be ranked based on ease of implementation, and the predictive benefit modeling dashboard may select one or more highest ranked work packages. Additionally, or alternatively, the predictive benefit modeling dashboard may update the percentage improvement shown via the slider and/or the text box adjacent to the slider, and/or the potential savings percentage, based on one or more work packages selected by the user (e.g., by checking one or more of the check boxes shown in the work package list 885).

FIG. 8K shows an illustrative page 800K of an events center, in accordance with some embodiments. For instance, the page 800K may be a last login dashboard that a user may reach by activating a menu item from the side menu of the illustrative page 800A in the example of FIG. 8A.

The inventors have recognized and appreciated it may be desirable to collect and display statistics regarding persons responsible for implementing consumption reduction measures associated with events generated by a consumption management system. Accordingly, a last login dashboard may be provided, for instance, via the page 800K in the example of to show action owner activities by site. In this example, each column in a chart 893 displays a number of events pending action at a respective site. By hovering over a column, such as a column 895, a user may be able to see a time at which an action owner for the corresponding site last logged into the consumption management system.

In some embodiments, for ease of viewing, sites may be grouped based on gross area, or some other suitable metric. For instance, sites may be ranked by the metric, and may be grouped into top N percentile, next N percentile, . . . , bottom N percentile, for some suitable N (e.g., 10). However, it should be appreciated that aspects of the present disclosure are not limited to grouping sites in any particular manner, or any grouping at all.

In some embodiments, one or more filters may be provided to allow a user to specify which events to include in a dataset displayed in the chart 893. For instance, in the example of FIG. 8K, a filter 897a is provided to allow the user to select one or more geographical regions, and a filter 897b is provided to allow the user to select one or more event categories. Any other suitable filter (e.g., by event state, resource type, load category, time period, etc.) may be used in addition to, or instead of these filters, as aspects of the present disclosure are not limited to the use of any particular filter, or any filter at all.

FIG. 8L shows an illustrative page 800L with a tabular representation of data, in accordance with some embodiments. For instance, the page 800L may result from a user activating the button 899 of the illustrative page 800K in the example of FIG. 8K. The page 800L may include a table 899 where each row may correspond to a site (or group of sites), and each column may correspond to some relevant information regarding one or more persons responsible for implementing consumption reduction measures at that site (or group of sites), such as last login date, date of oldest event pending action at that site (or group of sites), total value of pending events at that site (or group of sites), number of pending events at that site (or group of sites), etc. In some embodiments, a blank last login date may indicate a corresponding action owner has never logged in. One or more user interface features (e.g., filter button 897c) may be provided for one or more columns to allow data manipulation, including, but not limited to, sorting, filtering, etc.

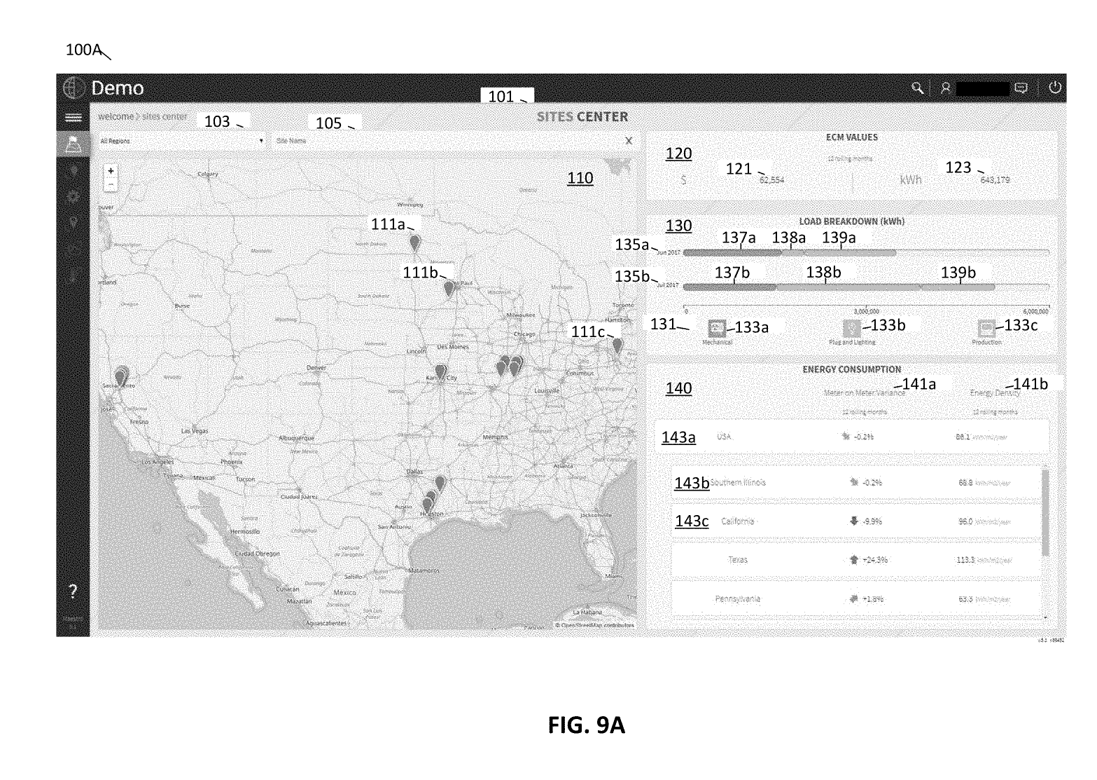

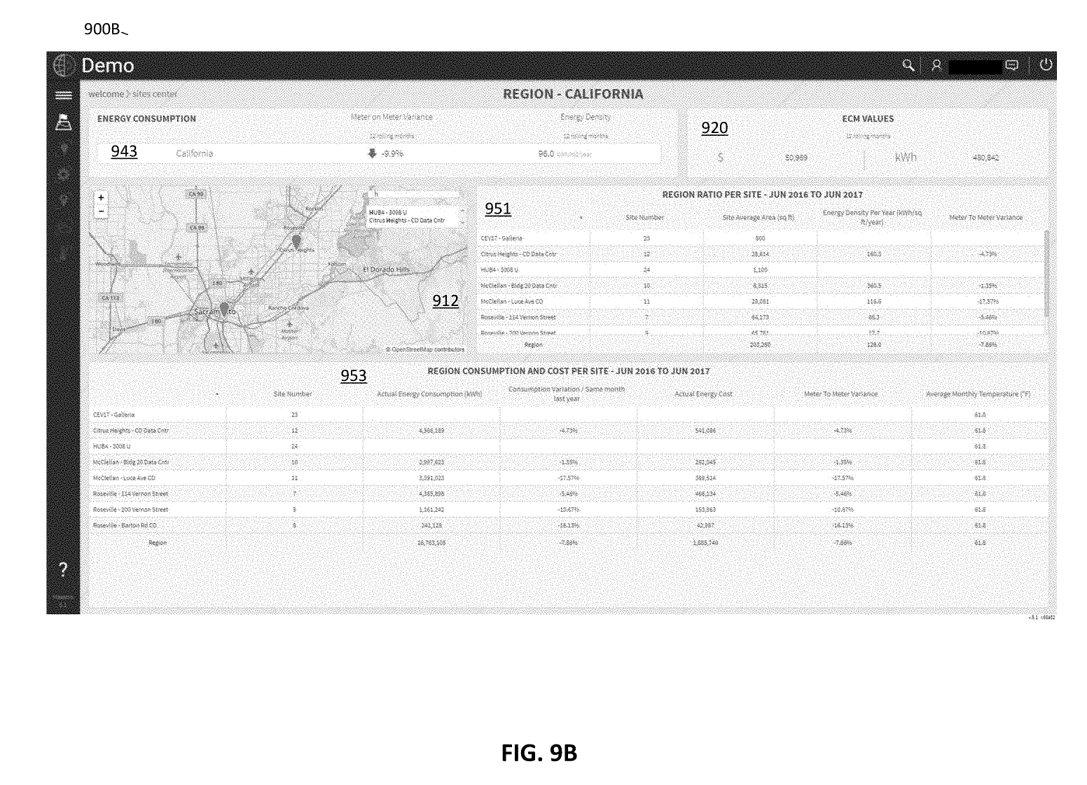

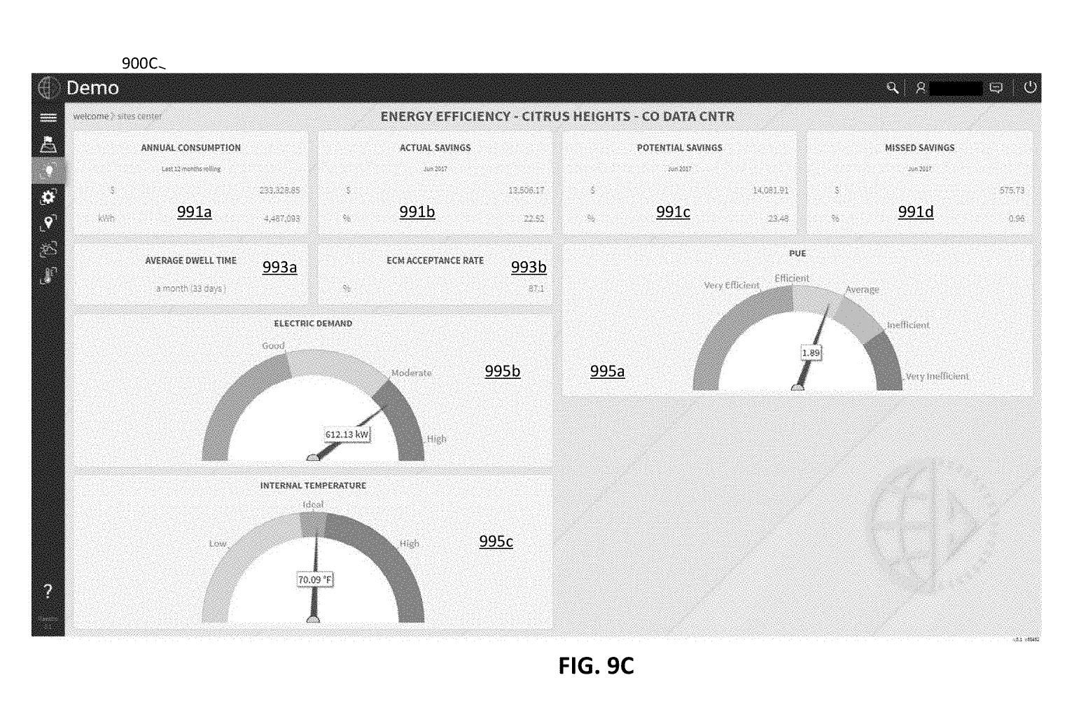

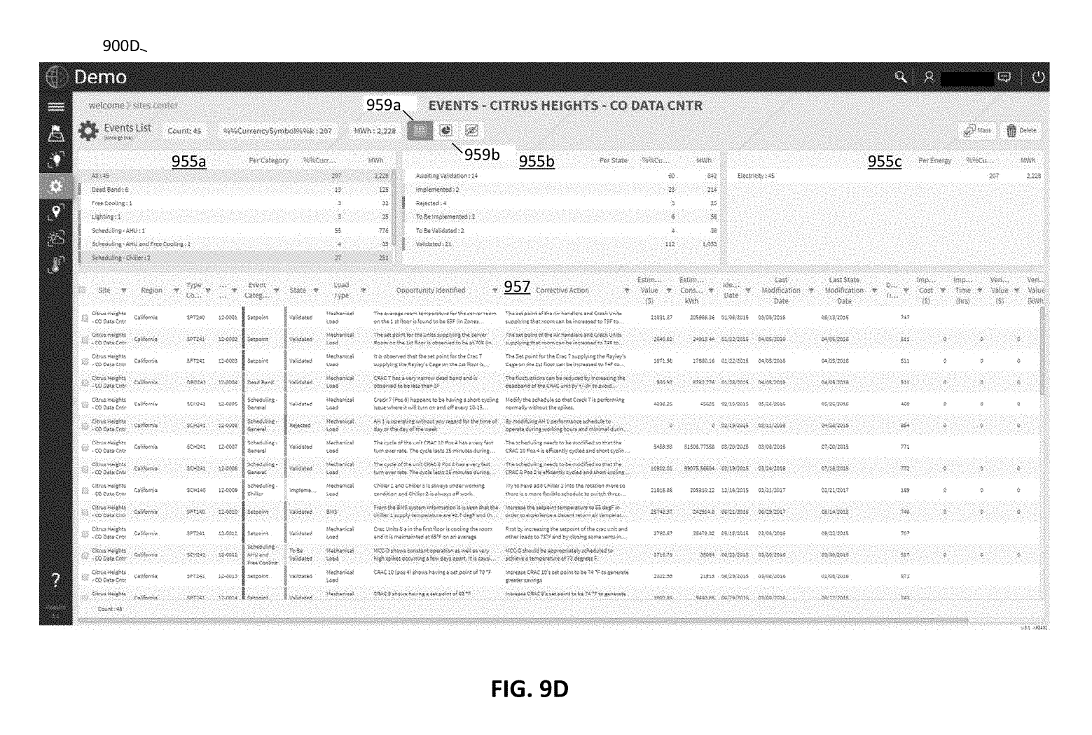

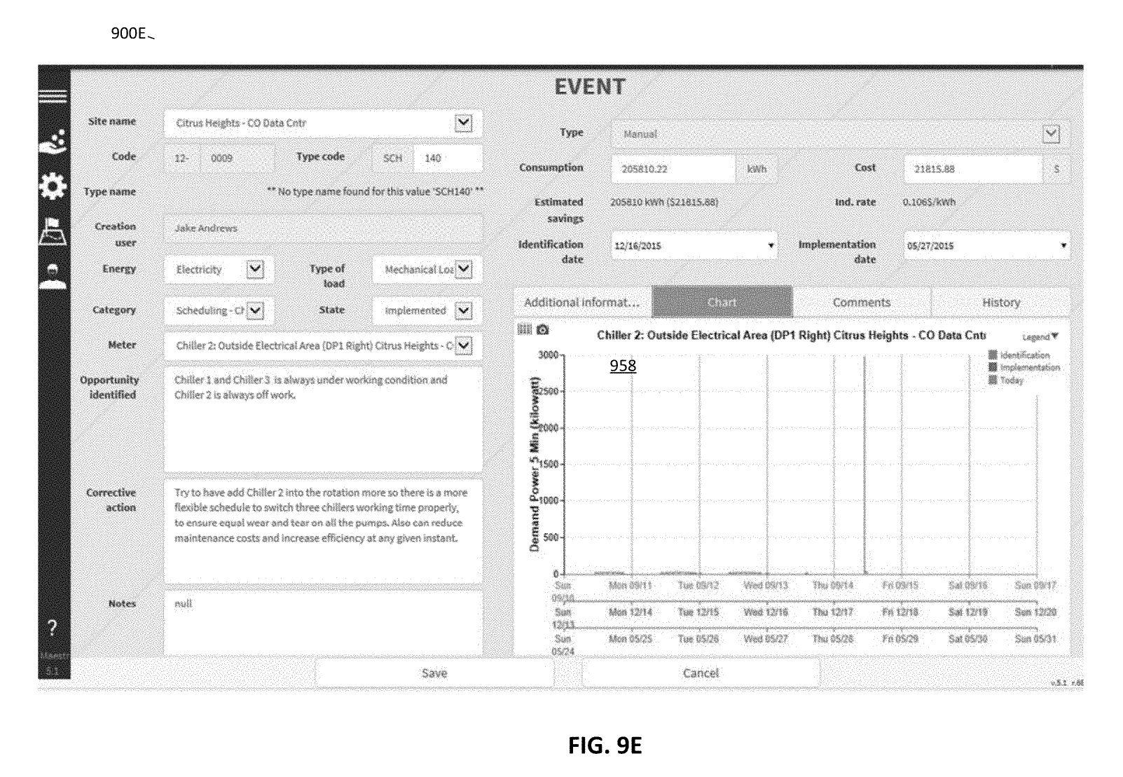

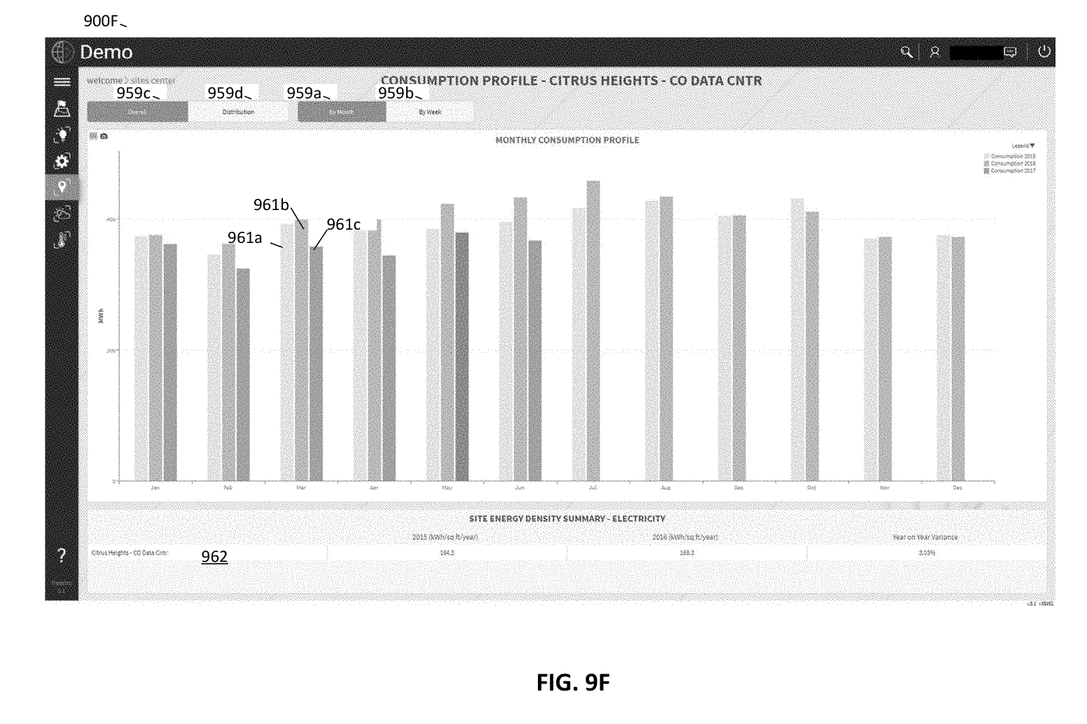

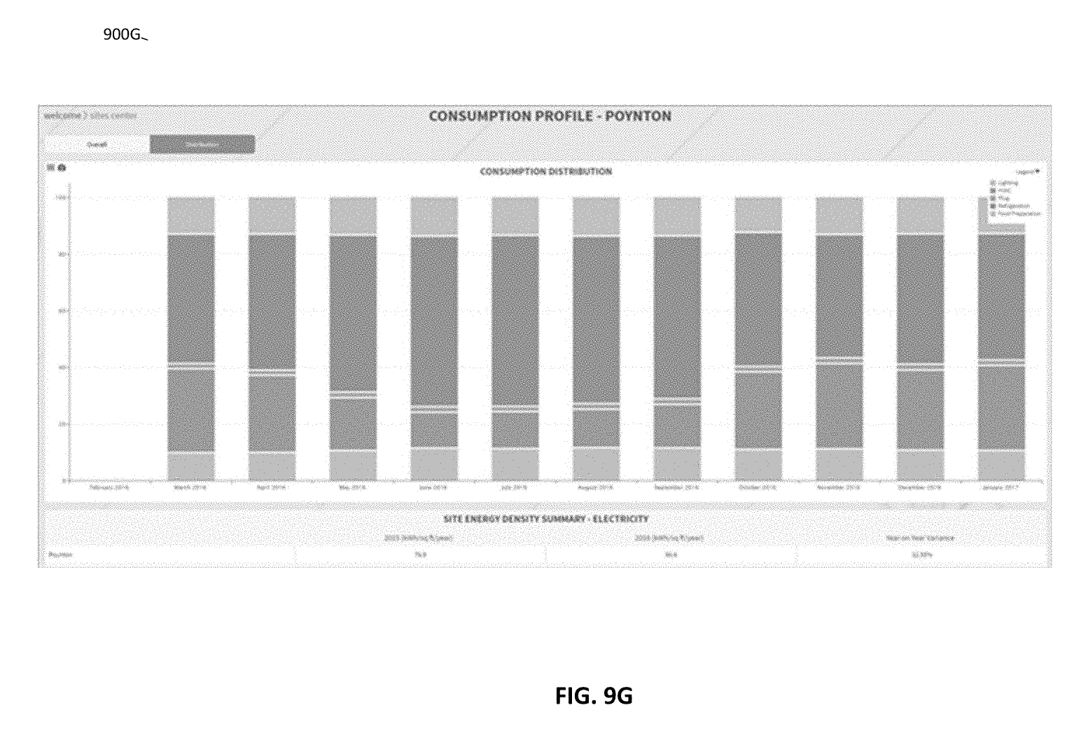

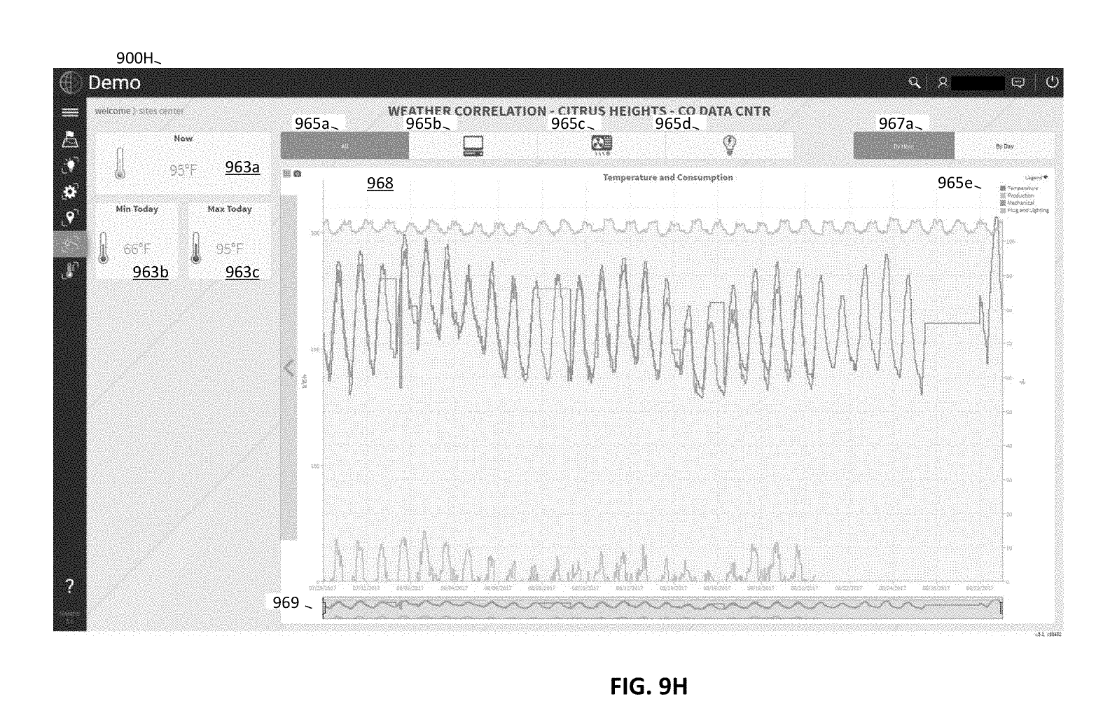

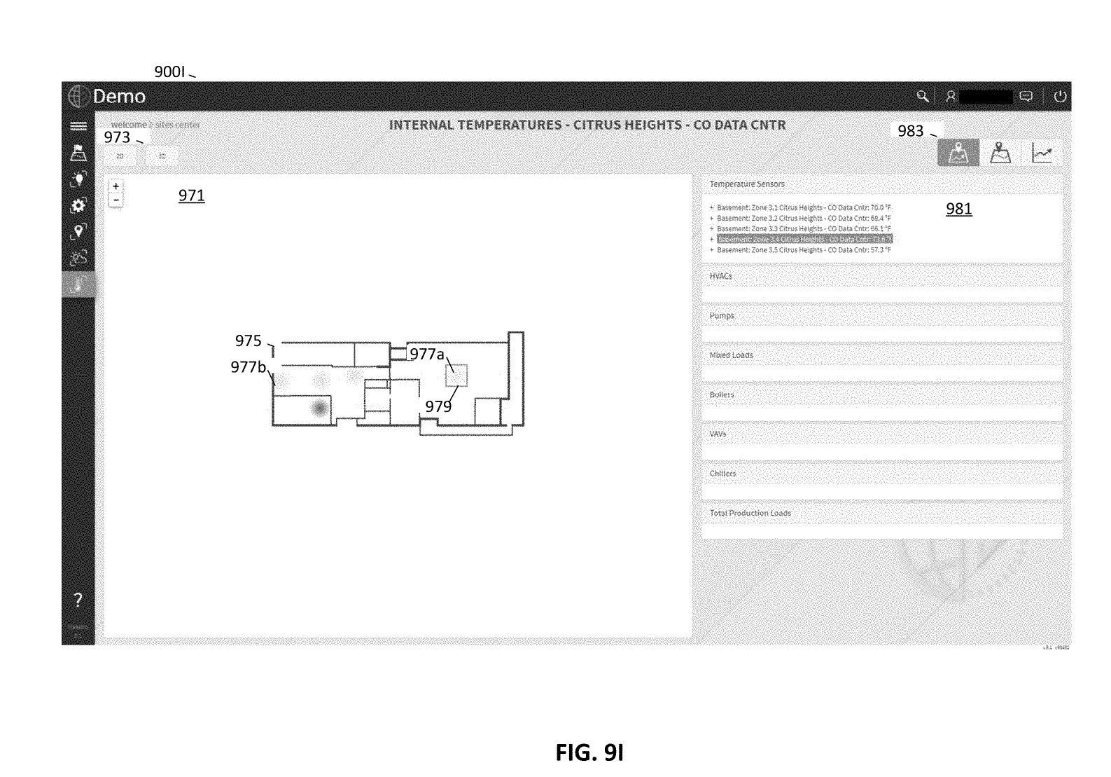

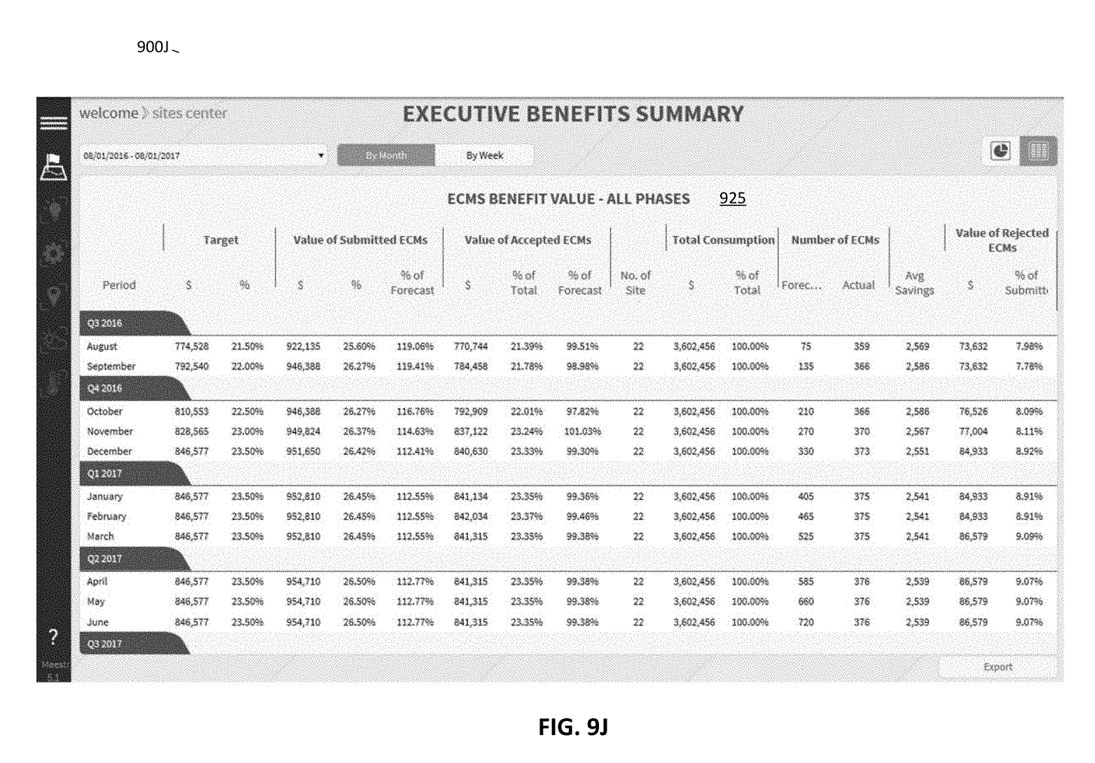

FIGS. 9A-9I show, respectively, illustrative pages 900A-I of a sites center, in accordance with some embodiments. For instance, the page 900A may be a version of a landing page that a user may reach by activating the sites icon 511 from the illustrative homepage 500 in the example of FIG. 5, and the pages 900B-I may be versions of dashboards that the user may reach by activating menu items from a side menu of the page 900A and/or other user interface features.

As discussed in connection with FIG. 1, a consumption management system may analyze data received from one or more sites. The inventors have recognized and appreciated that it may be beneficial to give a user an overview of resource consumption information related to one or more sites monitored by the consumption management system, and/or to allow the user to break down, filter, sort or otherwise manipulate data from one or more sites, for example, based on load category (e.g., production, lighting, mechanical load, HVAC, etc.), geographical region (e.g., continent, country, state, county, city, etc.), and/or any other suitable characteristic. This may allow the user to gain useful insight into an entire collection of sites operated by an enterprise, multiple sites in a geographical region, and/or a single site.

FIG. 9A shows an illustrative landing page 900A of a sites center of a consumption management system, according to some embodiments. The sites center may allow a user to view resource consumption data based on geographic location of one or more sites being monitored.

In some embodiments, a display area 901 of the page 900 may include a geographic filter 903, a search area 905, an interactive map 910, event values 920, a load breakdown 930, and a resource consumption table 940. The geographic filter 903 may provide a selectable list of geographic regions. In the example of FIG. 9A, all regions are selected, and, consequently, data displayed in the display area 901 may reflect all sites. In some embodiments, when one or more regions are selected in the geographic filter 903, the display area 901 may be updated to include only those sites in the selected one or more regions, e.g. sites in California, Illinois, and/or Texas.

In some embodiments, the search area 905 may be used to search for one or more sites matching a text input. For example, the search area 905 may be used to search for a specific site based on a name of the site. In some embodiments, the consumption management system may be programmed to process text entered into the search area 905 (e.g., part of a site's name) and return a list of selectable options (e.g., via a dropdown menu). Additionally, or alternatively, the consumption management system may be programmed to process text entered into the search area 905 (e.g., a name of a geographic region), and update the interactive map 910 to show all sites matching the input text.

In some embodiments, the interactive map 910 may be located in a left column of the display area 901, and may display icons representing site locations 911a-c. The interactive map 910 may show site locations 911a-c using any suitable icon, and may use a roadmap, a satellite image, or any suitable type of map as an underlying layer. In some embodiments, the sites center may be programmed to adjust a geographic area displayed in the interactive map 901 in response to user input (e.g. by changing a level of zoom to include a geographic region selected by a user). In some embodiments, a geographic area displayed the interactive map 901 may be smaller than a geographic region selected by a user (e.g., only large enough to include all sites in the selected geographic region).

In some embodiments, the consumption management event values 920, the load breakdown 930, and/or the consumption statistics 940 may be located in a right column of the display area 901. The consumption management system may be programmed to update the consumption management event values 920, the load breakdown 930, and/or the consumption statistics 940 in response to user input such as a user selecting a geographic region via the filter 903, typing in a geographic region name or a site name in the search area 905, clicking one of the icons 911a-c, etc. In this manner, the consumption management event values 920, the load breakdown 930, and/or the consumption statistics 940 may be updated based on data associated with one or more sites displayed in the interactive map 910.

In some embodiments, the consumption management event values 920 may reflect savings that are achieved by one or more consumption reduction measures associated with consumption management events during a reporting period or some other suitable time period. The savings may be reported as a monetary amount 921 and/or an amount of resource 923 (e.g., kWh for electricity).

FIG. 9J shows an illustrative page 900J with a tabular representation of data, in accordance with some embodiments. For instance, the page 900J may result from a user clicking or otherwise selecting either of the consumption management event values 921 and 923 from the illustrative page 900A in the example of FIG. 9A. The page 900J may include a table 925 having multiple tabs, each tab corresponding to a respective time period (e.g., day, week, month, quarter, year, etc.). Each tab may include multiple rows corresponding, respectively, to constituent time periods (e.g., days within a week, weeks within a month, months within a quarter, quarters within a year, etc.).

In some embodiments, columns in the table 925 may correspond, respectively, to target savings, total value of events generated by the consumption management system and submitted to one or more users for consideration, total value of events accepted for implementation, a number of sites considered, total resource consumption, a number of events generated by the consumption management system, average savings per event, total value of rejected events, etc. One or more of these columns may have sub columns. For instance, the column for total value of events accepted for implementation may have three sub columns: monetary value, amount of resource saved as a percentage of total consumption, and amount of resource actually saved as a percentage of forecasted savings.

Returning to the example of FIG. 9A, the load breakdown 930 may break down resource consumption at one or more selected sites based on a purpose for which resource is consumed. A legend 931 may explain which color, pattern, or other suitable visual indicium corresponds to which one of a plurality of load categories. In the example of FIG. 9A, the legend 931 includes an icon 933a representing resource used by machinery, an icon 933b representing resource used by electrical outlets and lighting, and an icon 933c representing resource used by production equipment (e.g., uninterrupted power supplies, rectifiers, inverters, batteries, servers, IT equipment, etc.). Segmented bars 935a and 935b may display resource usage broken down into segments 937a-b, 938a-b, and 939a-b, corresponding respectively to mechanical load, outlets and lighting, and production, as explained by the legend 931. The segmented bars 935a-b may correspond, respectively, to different time periods (e.g., current month, prior month, same month in a previous year, . . . , current quarter, prior quarter, same quarter in a previous year, . . . , current year, prior year, . . . , etc.).

In some embodiments, the resource consumption table 940 may display resource consumption statistics for one or more regions. For instance, a row 943a may correspond to the entire United States, and one or more other rows (e.g., 943b and 943c) may correspond respectively to regions within the United States (e.g., “Southern Illinois” and “California”). A column 941a may show variances in resource consumption over a time period (e.g., past 12 months). A column 941b may show resources consumption density, for example, in terms of amount of resource consumed per unit area at a site per time period (e.g., month, quarter, year, etc.).

The inventors have recognized and appreciated that a significant amount of database queries and/or calculations may be performed to obtain the consumption management event values 920, the load breakdown 930, and/or the consumption statistics 940. If the consumption management system performs such database queries and/or calculations afresh whenever a user changes a scope of the information (e.g., by selecting a geographic region via the filter 903, typing in a geographic region name or a site name in the search area 905, clicking on one of the site icons 911a-c, etc.), there may be a significant time lag (e.g., several seconds) before the consumption management event values 920, the load breakdown 930, and/or the consumption statistics 940 are updated to reflect the new scope.

Accordingly, in some embodiments, one or more pieces of information in the consumption management event values 920, the load breakdown 930, and/or the consumption statistics 940, or any other suitable information, may be maintained at different granularities (e.g., country, region, state, site, etc.), so that such information is readily available. Such information may be stored in an object tree (e.g., the illustrative object tree 300 in the example of FIGS. 3A-3F) at multiple nodes corresponding, respectively, to different countries, regions, states, sites, etc. For instance, multiple event values may be aggregated for, respectively, a country, a region, a state, a site, etc., and may be stored in nodes corresponding, respectively, to that country, that region, that state, that site, etc.

In some embodiments, scalability may be provided with respect to time, in addition to, or instead of, geography. For instance, one or more pieces of information in the consumption management event values 920, the load breakdown 930, and/or the consumption statistics 940, or any other suitable information, may be maintained for different time periods (e.g., past month, quarter, year, . . . , reporting period, baseline period, etc.), so that such information is readily available. Additionally, or alternatively, scalability may be provided with respect to equipment collection, for example, all mechanical equipment at a site, all elevators at the site, all elevators in a building within the site, all elevators at an elevator bank within the building, and a particular elevator.

In some embodiments, clicking or otherwise selecting a row representing a region in the consumption statistics 940 (e.g., any of rows 943a-c) may take a user to a region dashboard. FIG. 9B shows an illustrative page 900B of a region dashboard, according to some embodiments. The region dashboard may display resource consumption information of all sites within a selected region (e.g., as shown in a map 912).

In some embodiments, the page 900B may include one or more graphical and/or tabular presentations of data. For instance, a top ribbon may give an overview of the region of interest (e.g., via 943 and 920). A right panel may include a table 951 showing resource consumption information by site for some suitable period of time (e.g., past 12 months), such as energy density and/or variance. Aggregated values (e.g., sum, average, etc.) for the region may be shown in a bottom row.

In some embodiments, a bottom panel may include a table 953 that drills down further from the table 951, for example, showing actual consumption as an amount of resource (e.g., kWh for electricity) and/or a monetary amount, month-to-month variation from prior year, meter-to-meter variance, etc. In some embodiments, information may be provided to help a user to put the displayed data into context, such as average monthly temperature.

FIG. 9C shows an illustrative page 900C of a resource efficiency dashboard, according to some embodiments. For instance, the page 900C may be shown in response to a user clicking or otherwise selecting a site from the map 912 or the table 951 or 953 from the illustrative page 900B in the example of FIG. 9B.

In some embodiments, the resource efficiency dashboard may give a comprehensive overview of how resources are utilized at a selected site. For instance, the page 900C may show annual consumption 991a, actual savings 991b, potential savings 991c, and missed savings 991d for the selected site. Any one or more of these may be expressed as a monetary amount and/or an amount of resource.

In some embodiments, the page 900C may show average dwell time 993a of consumption management events accepted for implementation at the selected site. A dwell time may be a time period between an event being accepted for implementation and the event actually being implemented. Additionally, or alternatively, the page 900C may show a rate 993b at which submitted events are approved for implementation.

In some embodiments, the page 900C may show one or more speedometer graphs to allow a user to understand, at one glance, how well the selected site is doing in terms of resource utilization. For instance, there may be a speedometer 995a showing power usage effectiveness (PUE), a speedometer 995b showing electric demand, and a speedometer 995c showing internal temperature at the site.

FIG. 9D shows an illustrative page 900D of an events dashboard, according to some embodiments. The events dashboard may show a list of consumption management events identified for a selected site. A user may reach the page 900D by activating a menu item from a side menu of the illustrative page 900C in the example of FIG. 9C.

In some embodiments, the page 900D includes a table 957 listing event records for events generated by the consumption management system for the selected site. The table 957 may be similar to the table 840 in the illustrative page 800D in the example of FIG. 8D, and may include one or more user interface features to allow data manipulation, including, but not limited to, sorting, filtering, etc.

In some embodiments, the page 900D may include one or more panels summarizing savings achieved by consumption reduction measures of the events shown in the table 957. For instance, there may be a table 955a showing a breakdown by load category, a table 955b showing a breakdown by event state, a table 955c showing a breakdown by resource type, etc. A user may use toggle buttons 959a-b to switch between graphical and tabular views of one or more of these breakdowns. For instance, one or more donut charts similar to those in the example of FIG. 8A may be used in a graphical view to illustrate a breakdown. In some embodiments, one or more of the tables 955a-c may be automatically updated in response to a user filtering the data shown in the table 957 to reflect only those events matching one or more filter criteria indicated by the user.

It should be appreciated that aspects of the present disclosure are not limited to displaying events for a single site. In some embodiments, a page similar to the illustrative page 900D in the example of FIG. 9D may be used to display events for all sites operated by an enterprise, multiple sites in a geographical region, one or more sites matching one or more filter criteria indicated by a user, etc.

FIG. 9E shows an illustrative page 900E of an event dashboard, in accordance with some embodiments. The event dashboard may show details of a selected consumption management event. A user may reach the page 900E by clicking or otherwise selecting a row in the table 957 of the illustrative page 900D in the example of FIG. 9D.

In the example shown in FIG. 9E, the page 900 shows a chart 958 comparing performance of an asset before and after implementation of one or more consumption reduction measures associated with an event. Additionally, or alternatively, the page 900 may show performance of the asset on a current day. This may allow a user to assess whether one or more consumption reduction measures provide sustainable benefits.

In some embodiments, an event dashboard may be used to update event state, and/or to add comments about implementation of an event, one or more reasons for rejecting an event for implementation, and/or other types of notes. This may allow a complete audit trail of all activities performed against an event to be logged. In some embodiments, such an audit trail may be available for viewing from a history tab.

FIG. 9F shows an illustrative page 900F of a consumption profile dashboard, in accordance with some embodiments. The consumption profile dashboard may allow a user to compare historical resource consumption against current resource consumption for a selected site. The user may reach the page 900F by clicking or otherwise selecting a menu item in a side menu of the illustrative page 900D in the example of FIG. 9D.

In some embodiments, the page 900F may allow a user to compare consumption in different years on a month-to-month basis for a selected site. For instance, a bar graph may be shown, with bars 961a-c corresponding, respectively, to consumption in March 2015, March 2016, and March 2017. In this manner, the user may make multiple comparisons, for example, across different months (e.g., from January 2017, to February 2017, to March 2017, etc.) and/or across different years (e.g., from June 2015, to June 2016, to June 2017). Additionally, or alternatively, a table 962 may be provided to allow the user to compare consumption density (e.g., amount of resource consumed per unit area at a site per time period) across different time periods (e.g., consecutive years).

In some embodiments, buttons 959a-b may be provided to allow the user to toggle between monthly data and weekly data. However, it should be appreciated that aspects of the present disclosure are not limited to displaying monthly or weekly data. Data may be displayed at any suitable granularity, such as daily, weekly, biweekly, monthly, bi-monthly, quarterly, annually, etc. In some embodiments, buttons 959c-d may be provided to allow the user to toggle between overall data and data broken down by load category, for instance, as shown in an illustrative page 900G in the example of FIG. 9G.

FIG. 9H shows an illustrative page 900H of a weather correlation dashboard, in accordance with some embodiments. The weather correlation dashboard may show resource consumption at a selected site against one or more weather conditions. This may allow a user to identify any anomalous variation in resource consumption (e.g., a sharp increase or decrease that does not appear to be weather related). The user may reach the page 900H by clicking or otherwise selecting a menu item in a side menu of the illustrative page 900F in the example of FIG. 9F.

In the example of FIG. 9H, a left panel shows one or more weather conditions such as current temperature 963a, daily minimum temperature 963b, and daily maximum temperature 963c at the site. The air temperatures may be received from one or more sensors at the site, a weather information service, and/or any other suitable source.

In the example of FIG. 9H, a right panel includes a chart 968 showing resource consumption and temperature over time. Resource consumption may be broken down based on load category (e.g., production, mechanical load, lighting, etc.). A user may be able to choose which one or more categories to display using toggle buttons 965a-d and/or a legend 965e (e.g., by clicking or otherwise selecting one or more items in the legend to be shown/hidden). In some embodiments, the same information may be shown in another chart 969, which may have a different vertical scale compared to the chart 968. This additional chart 969 may help the user spot trends that may otherwise be missed by viewing the chart 968 alone. In some embodiments, the chart 969 may include a slider to allow the user to zoom in/out to a certain time period in the chart 968.

In some embodiments, buttons 967a-b may be provided to allow a user to toggle between hourly data and daily data. In some embodiments, operating hours of the site may be displayed alongside hourly data, which may help the user understand a periodic nature of resource consumption information.

FIG. 9I shows an illustrative page 9001 of an internal temperatures dashboard, in accordance with some embodiments. The internal temperatures dashboard may give a user a visual representation, in two or three dimensions, of a temperature distribution across a selected site, which may allow the user to identify any anomaly (e.g., an excessively hot or excessively cold area). The user may reach the page 9001 by clicking or otherwise selecting a menu item in a side menu of the illustrative page 900H in the example of FIG. 9H.

In some embodiments, the page 9001 may include a site display 971 showing a floorplan 975 of a selected site. A user may zoom in or out, and/or move the floorplan within the site display 971 to suit viewing preferences. In some embodiments, a button 973 may be provided to allow the user to switch to a three-dimensional view, where the user may rotate a three-dimensional representation of the floorplan 975.

In some embodiments, the site display 971 may include one or more temperature indicators (e.g., 977a-b) that show temperatures reported by one or more temperature sensors at the site. A location of a temperature indicator in the floorplan 975 may reflect a location of a corresponding sensor at the site. The temperature sensor may be a stand-alone sensor, or a sensor incorporated into a piece of equipment such as an air conditioner.

In some embodiments, a temperature indicator may be color coded based on a temperature range in which a corresponding reported temperature falls. In this manner, a user may be able to see, at one glance, where anomalous temperatures may be reported at the site.

In some embodiments, the site display 971 may include a table 981 displaying information associated with the temperature indicators shown in the site display 971. For example, the table 981 may include a description of a temperature sensor (e.g., location, currently reported temperature, etc.) corresponding to a temperature indicator shown in the site display 971. In some embodiments, a user may click or otherwise select an entry in table 981, and a corresponding temperature indicator (e.g. 977a) may be highlighted in the site display 971 (e.g., using a box 979). Additionally, or alternatively, the user may bring up a description of a corresponding temperature sensor by hovering over a temperature indicator in the site display 971.

In some embodiments, a sites center may include one or more dashboards related, respectively, to one or more load categories, one or more resource types, etc. For example, there may be a dashboard relating to resource consumption for refrigeration, a dashboard relating to water consumption, etc.

In some embodiments, a refrigeration dashboard may show a relationship between resource consumption of refrigeration equipment and daily average temperature at a selected site. Additionally, or alternatively, the refrigeration dashboard may show a comparison between refrigeration consumption in a current period and refrigeration consumption in a reference period (e.g., using line plots). In some embodiments, the current period and/or reference refrigeration consumptions may be charted along with current period and/or reference period daily temperatures. This may help a user understand how variations in temperature may impact refrigeration consumption.

In some embodiments, the refrigeration dashboard may include a bubble chart, or any other suitable type of chart, that shows a comparison between expected consumption and current consumption over a temperature range. In some embodiments, the refrigeration dashboard may include a table showing refrigeration consumption as a percentage of total resource consumption at the selected site, and/or evolution of that percentage from a reference period to a current period.

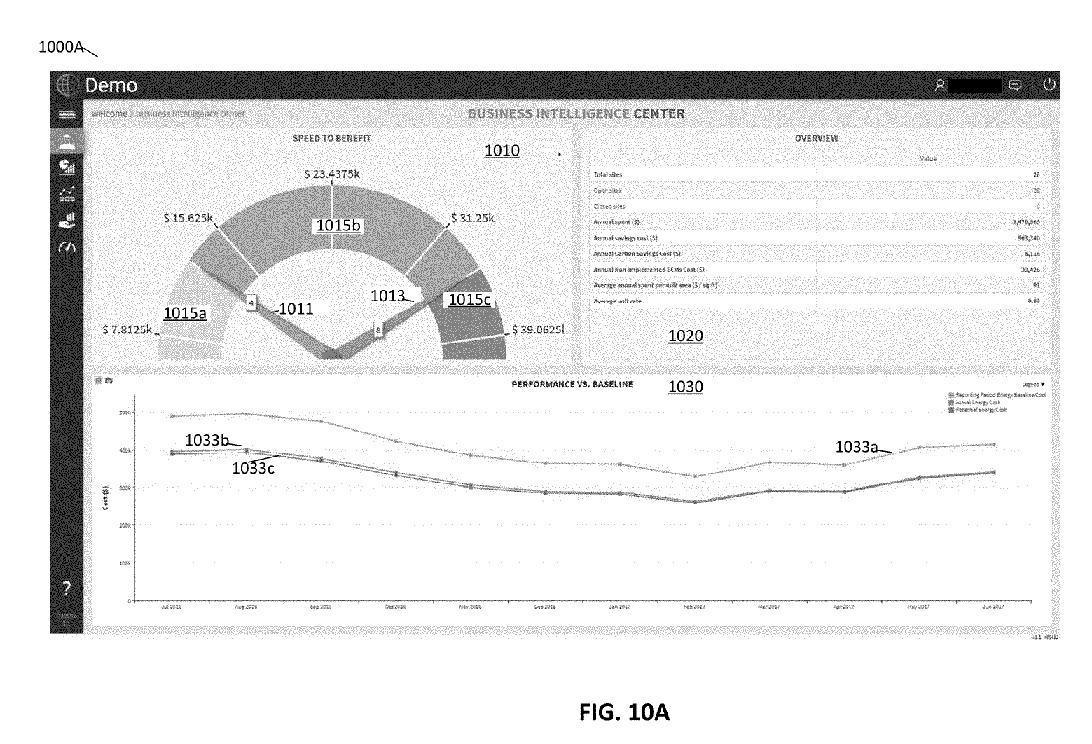

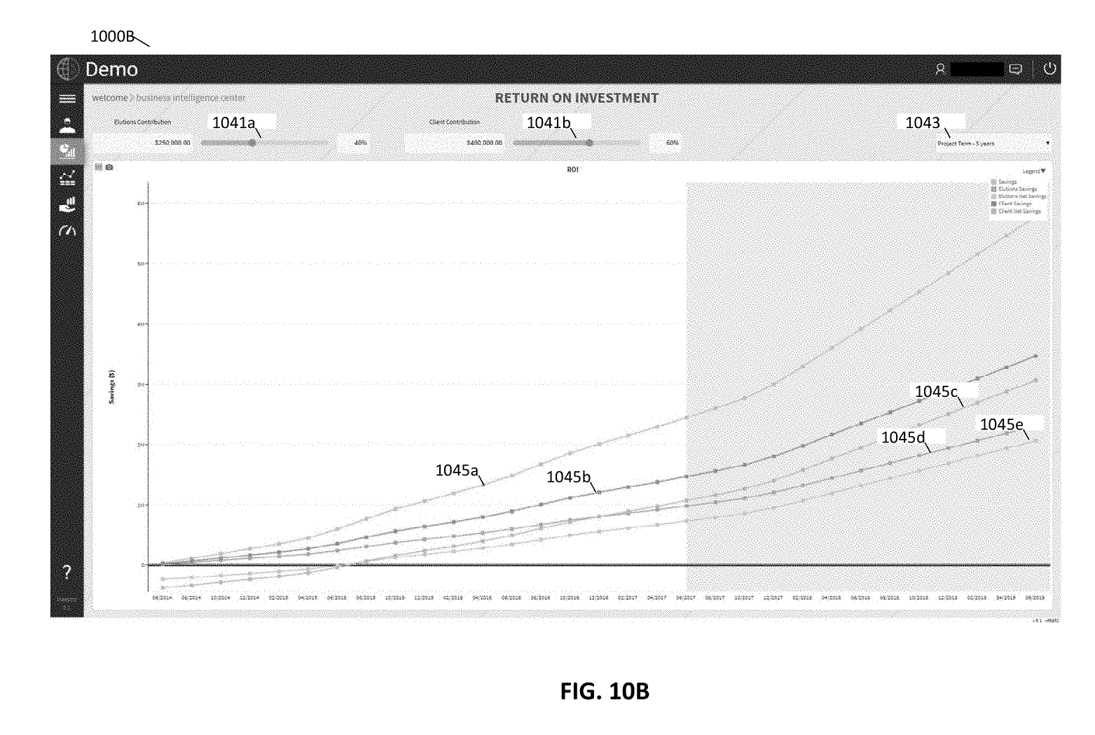

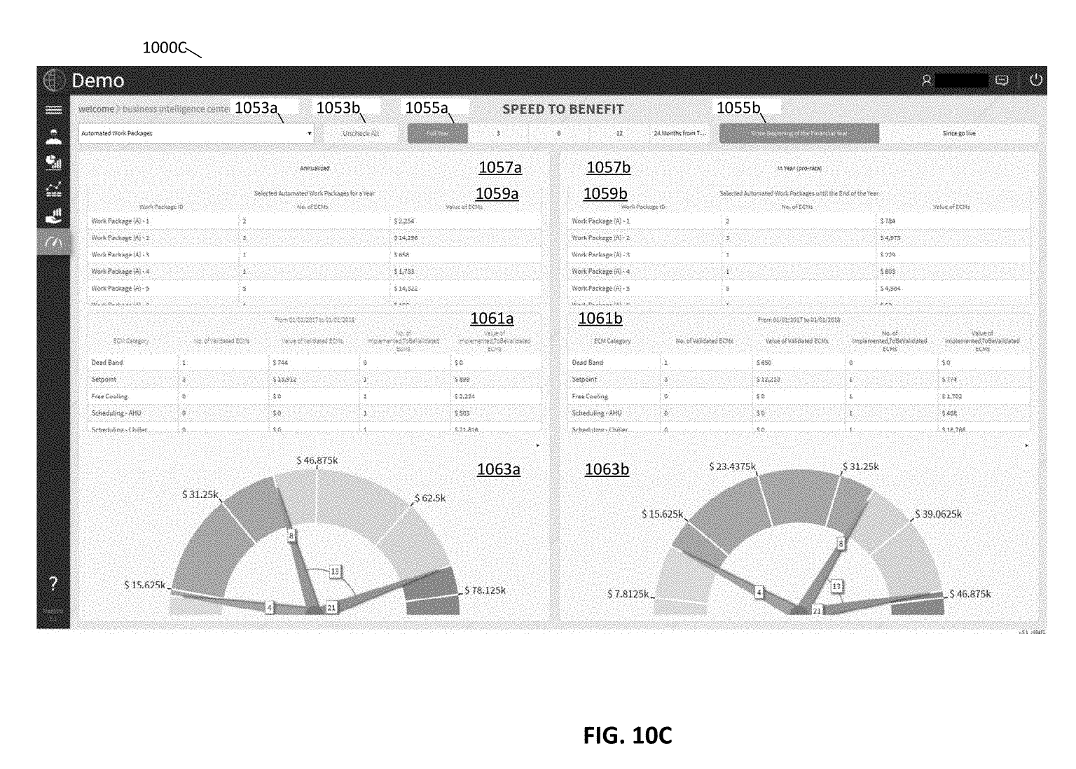

FIGS. 10A-10C show, respectively, illustrative pages 1000A-C of an intelligence center, in accordance with some embodiments. For instance, the page 1000A may be a version of a landing page that a user may reach by activating the intelligence icon 513 from the illustrative homepage 500 in the example of FIG. 5, and the pages 1000B-C may be versions of dashboards that the user may reach by activating menu items from a side menu of the page 1000A and/or other user interface features.

As discussed in connection with FIG. 1, a consumption management system may analyze data received from one or more data sources to identify opportunities to reduce resource consumption. The inventors have recognized and appreciated that it may be beneficial to give the user an overview of resource consumption, costs associated with implementing one or more consumption reduction measures, and progress towards implementation of one or more consumption reduction measures. This may allow a user to gain useful insight, at a glance, into performance of a consumption management project (e.g. a project that requires initial spending to achieve future resource savings and/or reduction of environment impact).

FIG. 10A shows an illustrative landing page 1000A of an intelligence center, according to some embodiments. In this example, the page 1000A includes a speed to benefit display 1010, an overview table 1020, and a performance vs. baseline graph 1030.

In some embodiments, the speed to benefit display 1010 may be a speedometer graph designed to illustrate progress in moving consumption management events through an event life cycle (e.g., as discussed in connection with FIG. 4). For instance, each arc segment in the speedometer graph may correspond to one or more event states, and a clockwise ordering of the arc segments may correspond to a reverse ordering of event states in the event life cycle (i.e., from later states to earlier states).

In the example of FIG. 10A, there are three arc segments in the speed to benefit display 1010. An arc segment 1015a may represent a collection of events that have been validated, an arc segment 1015b may represent a collection of events that have been implemented but not yet validated, and an arc segment 1015c may represent a collection of events that have been approved for implementation but not yet implemented. In some embodiments, the arc segments 1015a-c may be visually distinguished from each other in some suitable manner, for example, using different colors, fill patterns, borders, labels, etc.

In some embodiments, each of the arc segments 1015a-c may be sized proportionally based on a total value of the corresponding collection of events. One or more value markers (e.g., $7.8125 k, $15.625 k, $23.4375 k, $31.25 k, and $39.0625 k) may be provided to help a user gain an intuitive understanding of the total values of the collections of events.

In some embodiments, an indicator 1011 may be provided to highlight where the arc segment 1015a ends and the arc segment 1015b begins, and an indicator 1013 may be provided to highlight where the arc segment 1015b ends and the arc segment 1015c begins. The indicator 1011 may be labeled with a number (e.g., “4”) indicating how many events have been validated, and the indicator 1013 may be labeled with a number (e.g., “8”) indicating how many events have been implemented (including those that have been validated). In some embodiments, the indicators 1011 and 1013 may be visually distinguished from each other in some suitable manner, for example, using different colors, fill patterns, borders, labels, etc.

Although the inventors have recognized and appreciated various advantages of using a speedometer graph to show progress in moving consumption management events through an event life cycle, it should be appreciated that aspects of the present disclosure are not limited to the use of a speedometer graph. In some embodiments, a bar graph, a donut chart, etc., may be used in addition to, or instead of, a speedometer graph to illustrate values of events at various points in an event life cycle.

In the example shown in FIG. 10A, the overview table 1020 presents information regarding sites (e.g., total number of sites, number of open sites, number of closed sites, etc.), and/or information regarding costs (e.g., annual spending on resource consumption, average annual spending per unit area, annual savings resulting from implementing consumption reduction measures, annual carbon savings resulting from implementing consumption reduction measures, annual potential savings (e.g., savings that could have been achieved by implementing non-implemented events, average unit rate such as cost per kWh for electricity, etc.). Any suitable one or more pieces of information may be shown, as aspects of the present disclosure are not so limited.

In the example shown in FIG. 10A, the performance graph 1030 displays baseline resource cost 1033a, actual resource cost 1033b, and potential resource cost 1033c. The costs are plotted against time at any suitable resolution (e.g., daily, weekly, biweekly, monthly, bi-monthly, quarterly, annually, etc.).

In some embodiments, the intelligence center may include one or more dashboards, such as a cost effectiveness dashboard, a performance vs. baseline dashboard, an adjustments distribution dashboard, and a speed to benefit dashboard. The performance vs. baseline dashboard may be similar to the consumption performance dashboard in the example of FIG. 7E, whereas the adjustment distribution dashboard may be similar to the adjustment performance dashboard in the example of FIG. 7G.

FIG. 10B shows an illustrative page 1000B of a cost effectiveness dashboard, according to some embodiments. The cost effectiveness dashboard may allow a user to see how quickly an initial cost associated with a consumption management project may be recouped via future savings. For instance, the user may use a slider 1041a (or 1041b) to adjust a percentage of initial cost bore by a consumption management service vendor (or an enterprise operating one or more sites monitored by the consumption management service vendor). Additionally, or alternatively, the user may enter monetary amounts contributed, respectively, by the vendor and the enterprise. In some embodiments, the user may select a project horizon (e.g., 5 years, 7 years, 10 years, etc.).

In some embodiments, one or more plots may be generated based on information provided by the user. For instance, a plot 1045c may represent projected savings, and plots 1045b and 1045d may represent savings attributable, respectively, to the vendor and the enterprise (e.g., based on a percentage specified using the slide 1041a or 1041b). Plots 1045c and 1045e may represent net savings attributable, respectively, to the vendor and the enterprise, where the net savings attributable to the vendor may be obtained by subtracting an initial cost bore by the vendor from the savings attributable to the vendor, and likewise for the net savings attributable to the enterprise.

FIG. 10C shows an illustrative page 1000C of a speed to benefit dashboard, according to some embodiments. The speed to benefit dashboard may give a graphical representation and/or a tabular representation of savings achieved by implementing work packages on an annualized basis and/or an in-year, pro-rata basis. In some embodiments, in-year savings may be determined as a proportion of annualized savings based on a number of months selected using an interface feature (e.g., 1055a). For instance, if a user selects 3 months (or 6 months), in-year savings may be one quarter (or one half) of annualized savings. In the example of FIG. 10C, the speed to benefit dashboard may include areas 1057a and 1057b, corresponding, respectively, to annualized savings and in-year savings.

In some embodiments, interface features 1053a-b may allow a user to select one or more work packages that may be implemented to reduce consumption, for example, as discussed with reference to FIG. 8J. In some embodiments, interface feature 1055a may allow the user to select a time frame for the in-years savings displayed in the area 1507b (e.g., full year, 3 months, 6 months, 12 months, or twenty 24 months from a present date).

In the example of FIG. 10C, the area 1057a shows information related to the selected work packages on an annualized basis. There may be a table 1059a of the selected work packages, summarizing, for example, respective number of consumption management events in each package and total value of such events. Additionally, or alternatively, there may be a table 1061a showing information related to the consumption management events broken down by category and state. In some embodiments, monetary values and state information of the consumption management events may be summarized in a speed-to-benefit display 1063a, for example, as discussed with reference to the illustrative display 1010 shown in FIG. 10A.

In some embodiments, the area 1057b may show information similar to that shown in the area 1057a, except values shown in the area 1057b may be adjusted to reflect the time period (e.g. full year, 3 months, 6 months, 12 months, or twenty 24 months from a present date, etc. as selected by a user with the interface features 1055a-b). For example, there may be a table 1059b, a table 1061b, and a display 1063b that are similar to, respectively, the table 1059a, the table 1061a, and the display 1063a.

In some embodiments, the areas 1057a-b may be display information using identical starting points (e.g., beginning of a current fiscal year or a consumption management project, as selected via input feature 1055b).

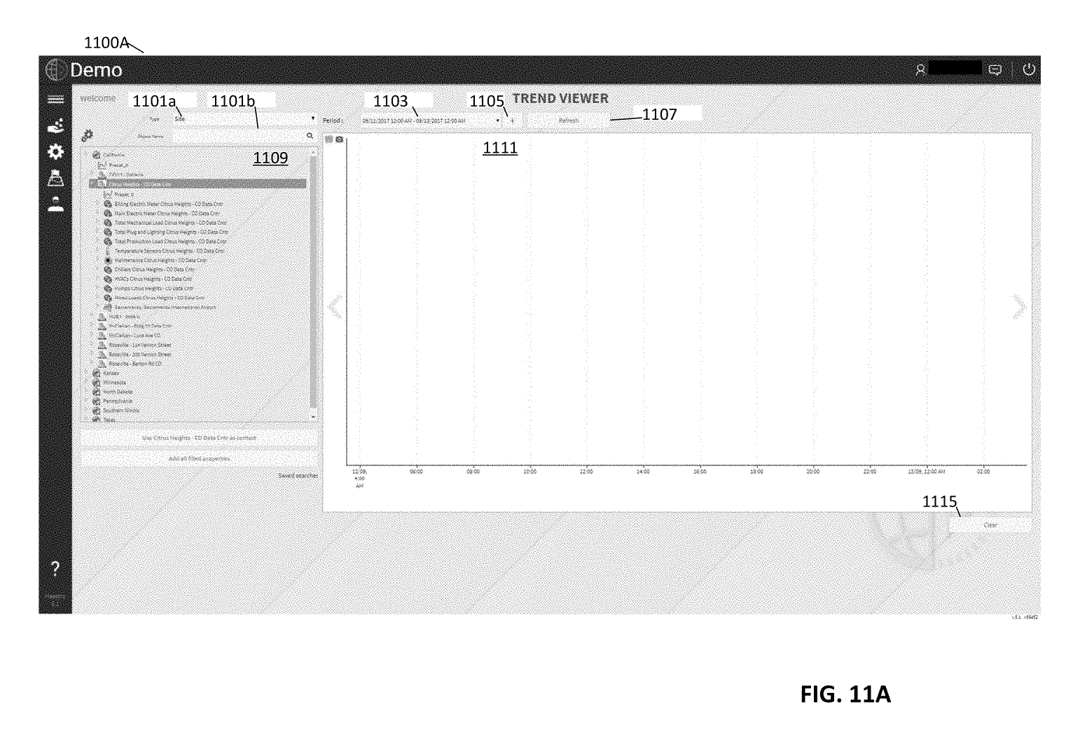

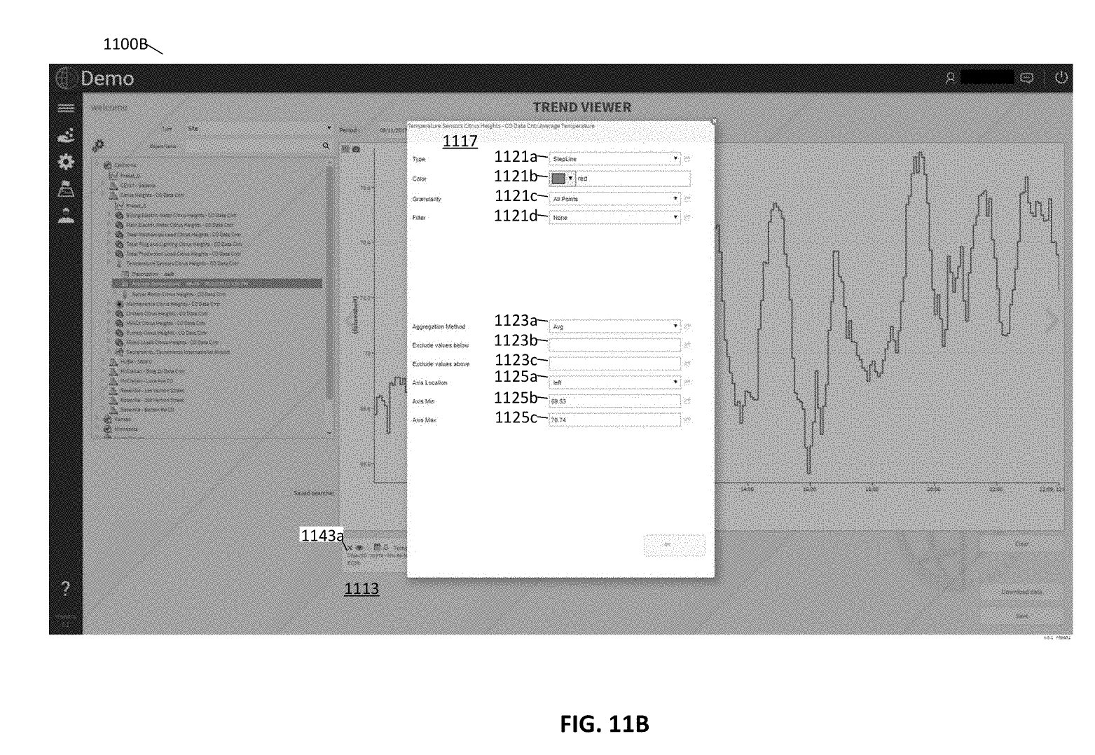

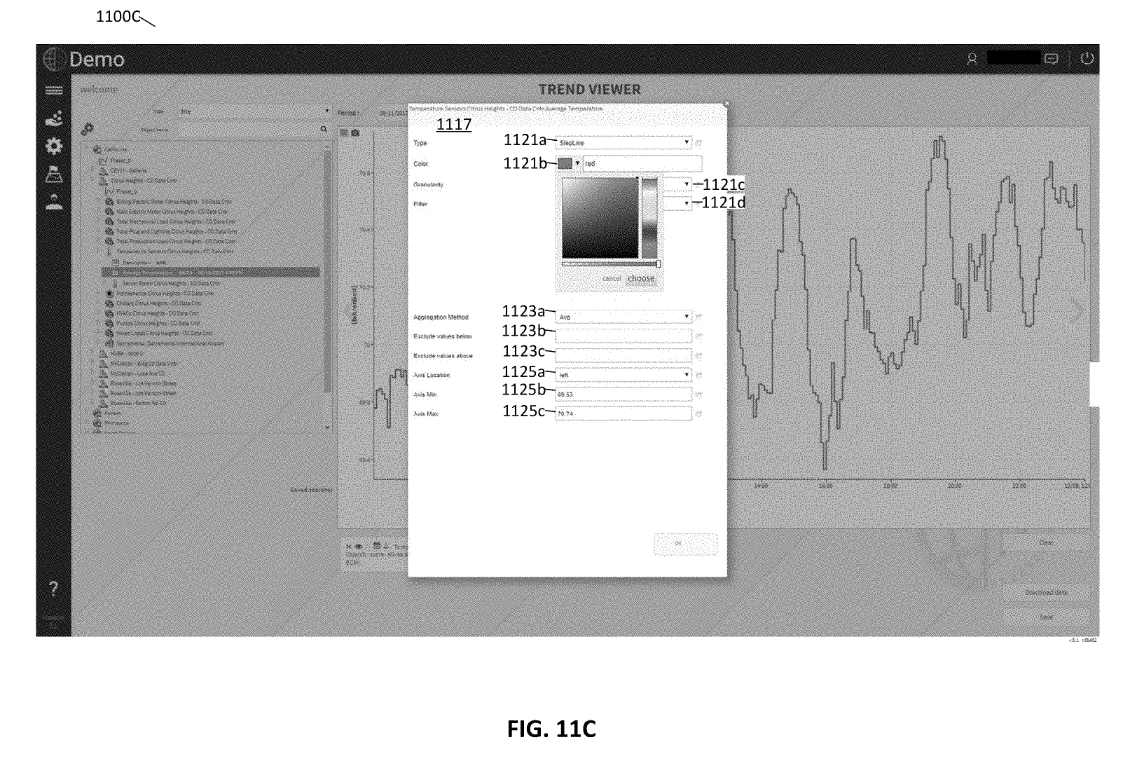

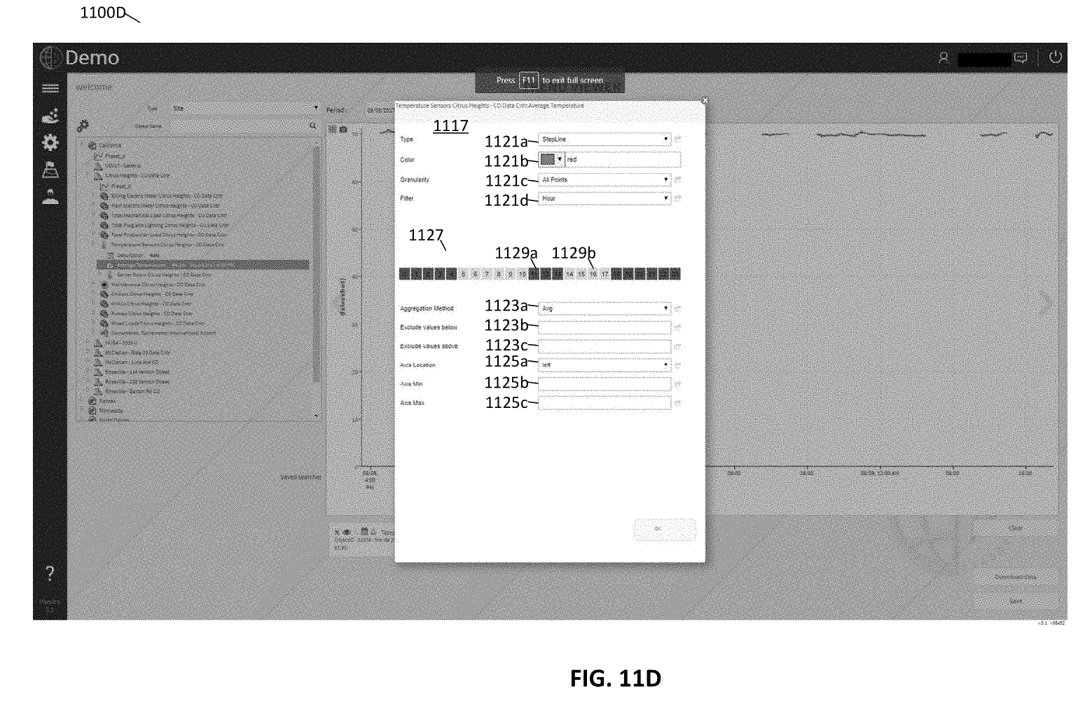

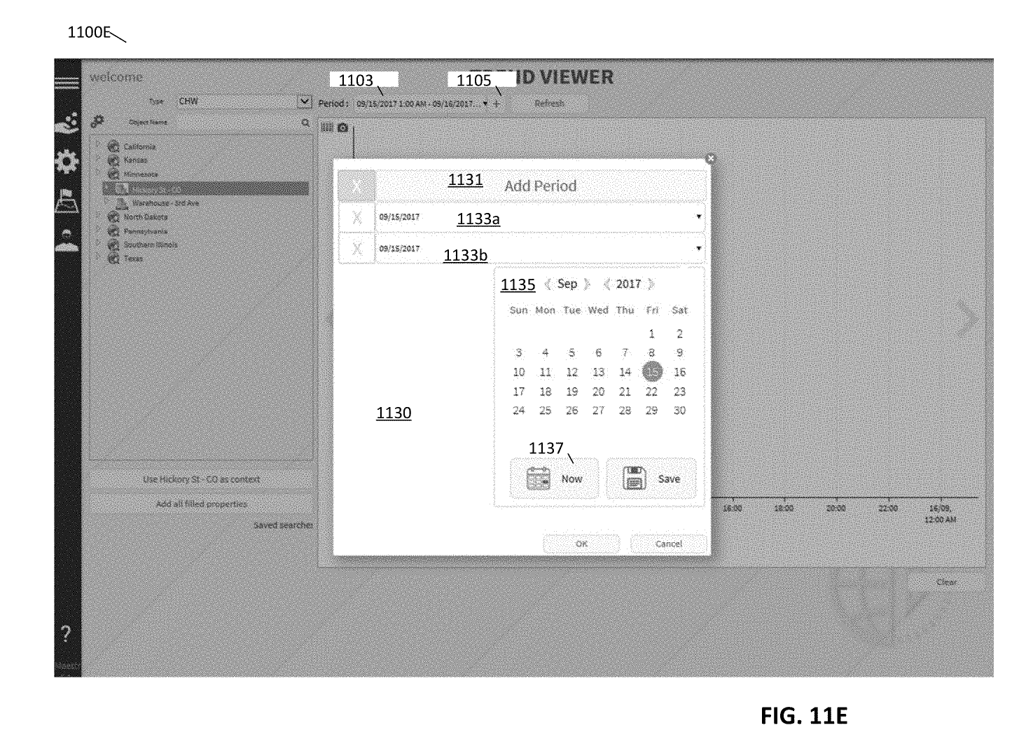

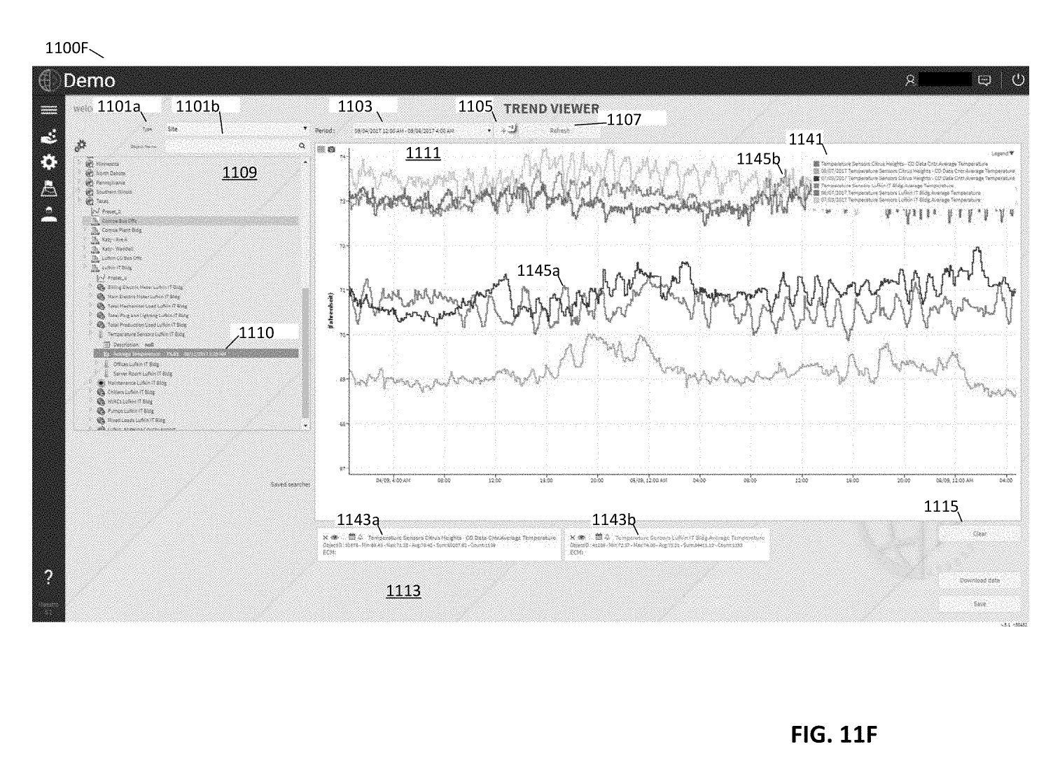

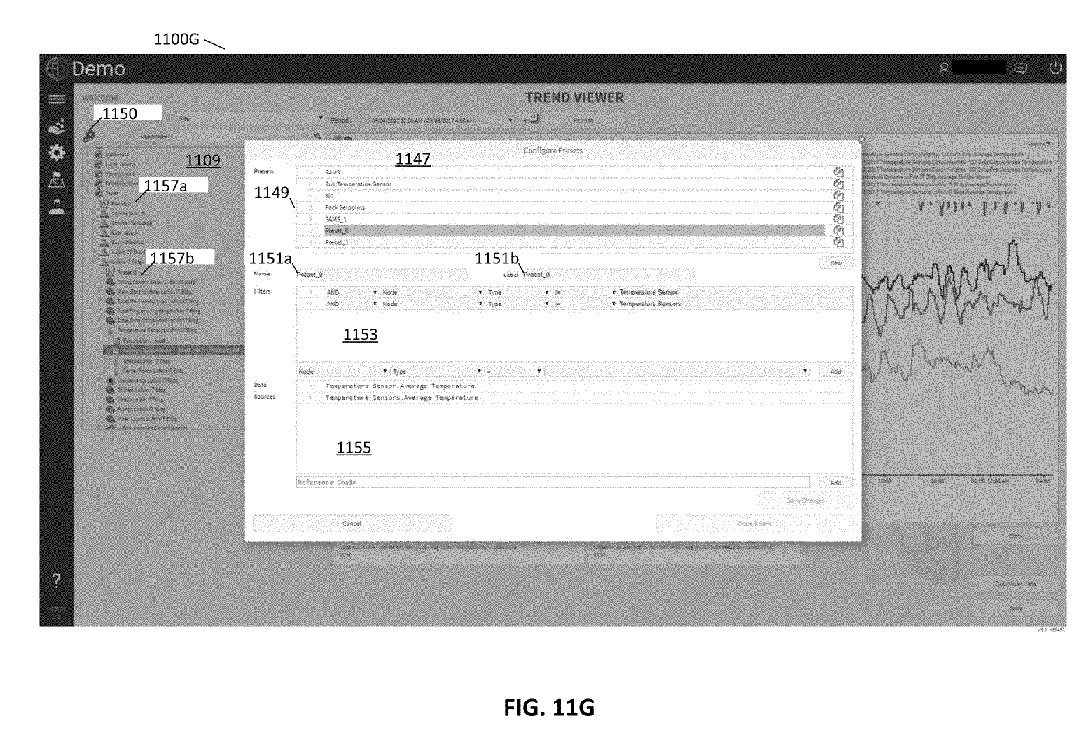

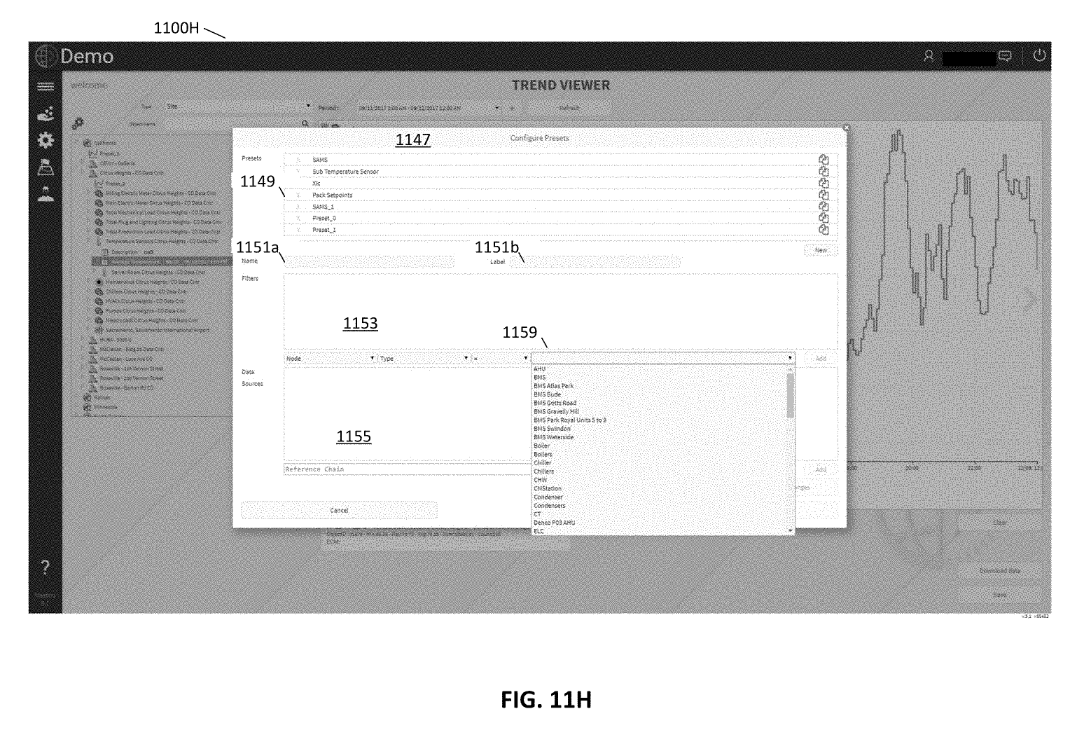

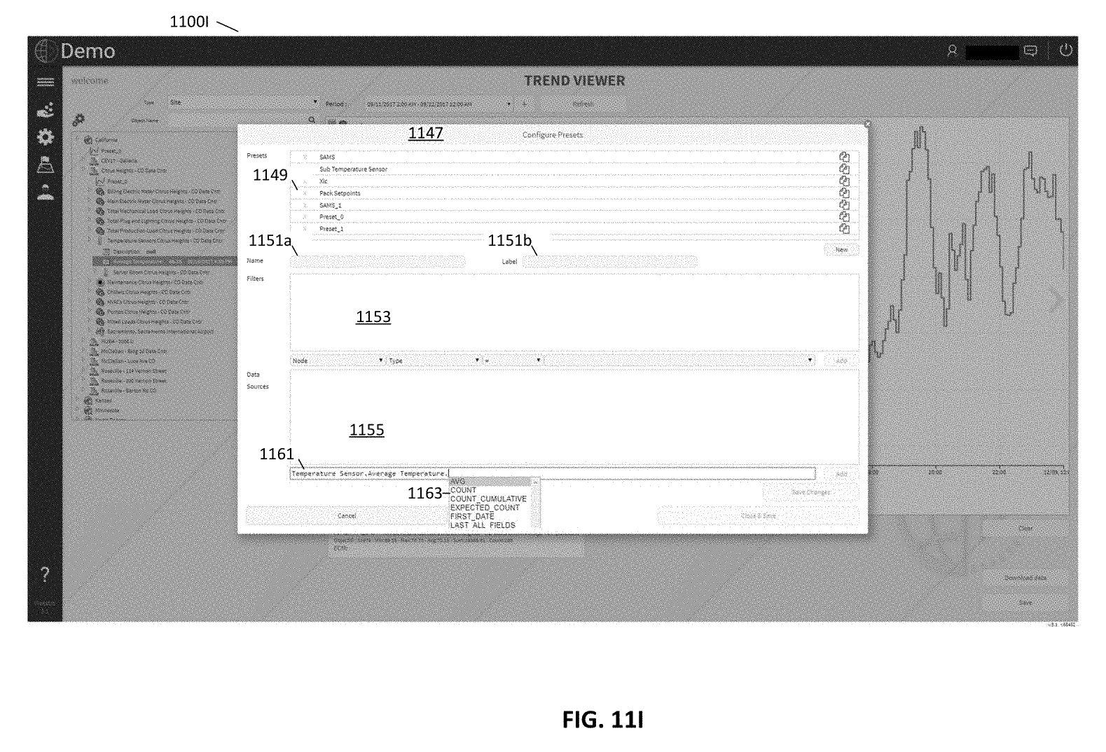

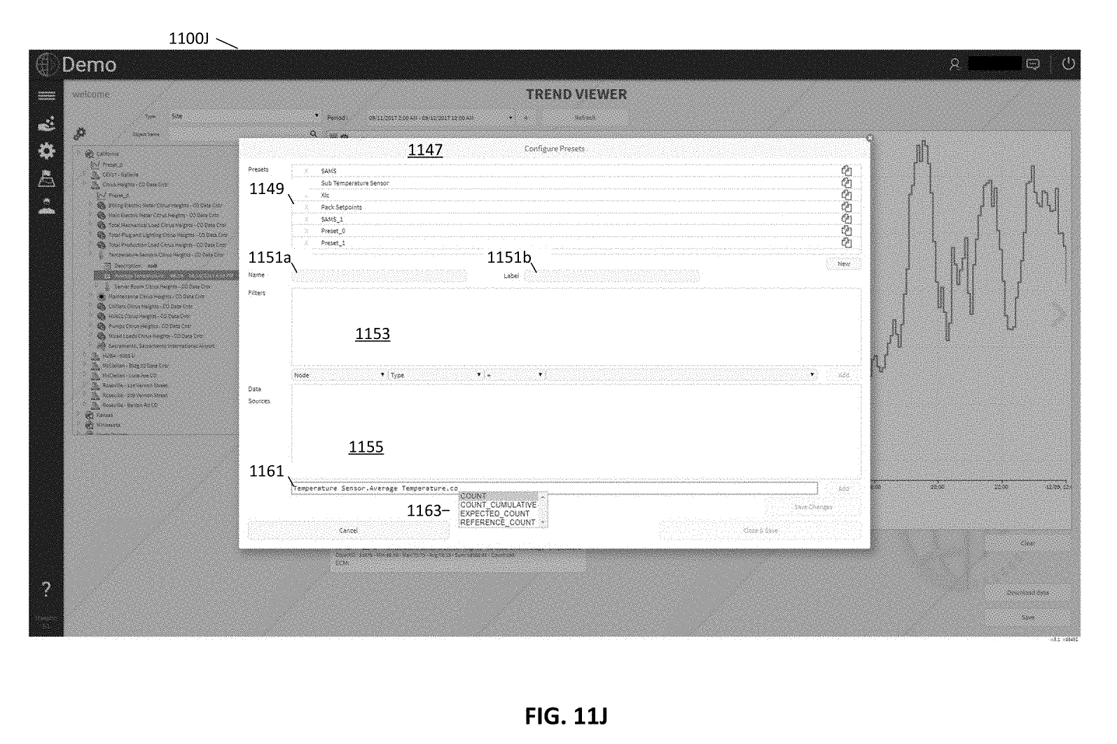

FIGS. 11A-11J show, respectively, illustrative pages 1100A-J of a trend viewer dashboard, in accordance with some embodiments. For instance, the page 1100A may be a version of a landing page that a user may reach by activating a trend viewer option from a side menu, such as the side menu of the illustrative page 700A in the example of FIG. 7A. The pages 1100B-J may be reached from the page 1100A by activating one or more user interface features.

As discussed in connection with FIG. 1, a consumption management system may analyze data received from one or more data sources to identify opportunities to reduce resource consumption. The inventors have recognized and appreciated that it may be beneficial to allow the user to view one or more series of data measured by the consumption management system, and/or to compare data across time periods, sites, data sources, etc. Accordingly, in some embodiments, the trend viewer dashboard may allow the user to view trends of any data stored in an object tree (e.g., the illustrative object tree 300 in the example of FIG. 3A) over any suitable period of time.

In the example shown in FIG. 1100A, the page 1100A includes search filters 1101a-b to allow a user to search for a data source. The search filter 1101a may allow the user to filter search results to only include data objects of a particular type (e.g. sites, temperature sensors, regions, chillers, or any other suitable type of data object that may be present in an object tree). The search filter 1101a may be a drop-down menu, a radio button, a text box, or any other suitable user interface feature for allowing the user to specify a desired type of data object. The search filter 1101b may be a text box that allows the user to enter a search string (e.g., site name, object type, property name, etc.) to find one or more data sources matching the search string.

In some embodiments, the page 1100A may include a menu 1103 that allows a user to select a time period for a trend to be displayed. A time period may be selected in any suitable manner, for example, by typing into one or more text boxes, and/or by selecting a beginning time (e.g., time of day and/or date) and/or an end time (e.g., time of day and/or date) from a calendar. In some embodiments, the page 1100A may include an icon 1105 that, when selected by a user, allows the user to select multiple time periods, which may cause multiple series of data to be displayed simultaneously on the page 1100A, each series of data corresponding to a respective selected time period. Illustrative methods for selecting multiple time periods are discussed in additional detail with reference to FIG. 11E.

In the example of FIG. 11A, the page 1100A shows an object tree 1109, which may be similar to the illustrative object tree 300 discussed with reference to FIGS. 3A-F. For instance, the object tree 1109 may be used to hierarchically organize data sources within the consumption management system, and to allow a user to select one or more data sources for inclusion in a trend display. In some embodiments, the object tree 1109 may include one or more geographical regions. A geographical region may be expanded to show one or more sites in the geographical region. In some embodiments, a site in the object tree 1109 may expand to show one or more data sources associated with the site.

In some embodiments, the object tree 1109 may be expanded automatically to show one or more search results generated based on user input to search filters 11011-b. In some embodiments, one or more presets, which may be data sets specified by a user, may be added to the object tree 1109. Examples of presets are discussed with reference to FIGS. 11G-J.

In the example of FIG. 11A, the page 1100A includes a trend display 1111. A user may initially be presented with a blank version of the trend display 1111 because no data source has been selected in the object tree 1109. Alternatively, a suitable default view may be shown, such as one or more most recently visualized trends, one or more data sources collected on a current date, etc.

In some embodiments, in response to a user selection of an object in the object tree 1109, the trend display 1111 may be populated with data from the selected object for one or more selected time periods. An example of the trend display 1111 populated with multiple selected data series is shown FIG. 11F and discussed below. In some embodiments, a refresh button 1107 may be provided to allow a user to refresh the trend display 1111 after making one or more changes, for example, as discussed in connection with FIGS. 11B-E.

FIG. 11B shows an illustrative page 1100B with an options menu 1117 for the trend display 1111 in the example of FIG. 11A, according to some embodiments. In some embodiments, one or more visual indicia corresponding, respectively, to one or more selected data sources may be displayed in an area 1113 in the page 1100B. A user may click or otherwise select a visual indicium to bring up the options menu 1117, which may allow the user to configure how the corresponding data source is to be displayed. For instance, the user may use the options menu 1117 to configure a visual appearance of a displayed data series, manipulate (e.g., filter, aggregate, etc.) underlying data, specify a display axis, etc.

In some embodiments, the options menu 1117 may include inputs 1121a-d to allow a user to select characteristics of a visual representation of data. For instance, the input 1121a may allow the user to specify a type of visual representation used to represent values in a data series. Examples of visual representations include, but are not limited to, a stepped line graph, a line graph, a scatter plot, a bar graph, etc.

In some embodiments, the input 1121b may allow a user to select a color for a visual representation of data. FIG. 11C shows an illustrative page 1100C in which the input 1121b is expanded responsive to a user selection to allow the user to select a color, in accordance with some embodiments. For instance, the user may click or otherwise select a color region from a color wheel, which may cause the selected color region to be shown in a square. The user may click anywhere on the square to select a desired hue, and/or use a slider to adjust intensity.

Returning to FIG. 11B, the input 1121c may allow a user to select a granularity of data to be displayed in the trend display 1111. In some embodiments, the user may select to display all available data points, or to aggregate the data points in some suitable manner and display aggregated data only. For instance, a data source may produce a value every minute. The user may choose to display all values in such a data series, or to divide the data series into groups of five consecutive values, aggregate the five values in each group into a single aggregated value, and display only the aggregated values. This may correspond to a time resolution of 5 minutes. Any other suitable time resolution of data may also be provided to the user as an option, such as 10 minutes, 30 minutes, 1 hour, 12 hours, 1 day, 1 week, 1 month, etc.

In some embodiments, the input 1121d may allow a user to filter data to be displayed in the trend display 1111. For example, the user may choose to only include data recorded on Mondays through Fridays, on weekends, between 9 am and 5 pm, outside of operating hours, or any other suitable time period. In some embodiments, the user may be able to select multiple criteria for filtering data, e.g. using both hours of the day and days of the week. In this manner, the user may be able to remove irrelevant and/or noisy data points from a data series.

FIG. 11D shows an illustrative page 1100D in which the input 1121d is expanded responsive to a user selection to allow the user to select a filter criterion, in accordance with some embodiments. In some embodiments, a timeline 1127 may be provided with one or more selectable time periods (e.g. 1129a and 1129b), such as hours of the day or days of the week. The user may select any one or more desired time periods from the timeline 1127. However, it should be appreciated that aspects of the present disclosure are not limited to the use of a timeline. In some embodiments, a text box may be provided to allow the user to type in one or more time periods to be included or excluded.

In some embodiments, one or more time periods that are selected may be visually distinguished from one or more time periods that are not selected. For example, the time period 1129a may be shaded darker than the time period 1129b to indicate that the time period 1129a is to be excluded from data shown in the trend display 1111. However, it should be appreciated that aspects of the present disclosure are not limited to visually differentiating selected time periods in any particular manner, or any visual differentiation at all. In some embodiments, radio buttons may be used to indicate which time periods are selected for inclusion or exclusion.

Returning to FIG. 11B, the inputs 1123a-c may allow a user to specify how data is to be aggregated prior to being shown in the trend display 1111. For instance, the input 1123a may allow the user to specify how the data is aggregated according to a level of granularity selected by the user (e.g. using the input 1121c). In some embodiments, the user may be presented with options to use sum, average (e.g., mean, median, or mode), minimum, maximum, count (e.g., an actual number of data points output based on selected granularity), or any other suitable method for aggregating a plurality of data points.

In some embodiments, the inputs 1123b-c may allow a user to exclude values above a selected threshold and/or values below a selected threshold. This may remove noise (e.g., one or more outliers) from the data shown in the trend display 1111, so that a long term trend may be more readily recognized. In some embodiments, the user may enter a value to be used as a threshold. Alternatively, or additionally, the user may specify a threshold based on one or more statistics, such as one or more standard deviations from a mean value.

In some embodiments, the inputs 1125a-c may allow a user to configure an axis of the trend display 1111 (e.g., a y-axis in the example of FIG. 11A). For instance, the user may specify an axis location (e.g., left or right), a minimum value, and/or a maximum value. This may allow the user to zoom in on a certain data range for convenient viewing.

In some embodiments, a minimum value provided at the input 1125b may be the same as, or different from, a value provided at the input 1123b to be used as a threshold. Likewise, a maximum value provided at the input 1125c may be the same as, or different from, a value provided at the input 1123c to be used as a threshold.

FIG. 11E shows an illustrative add period menu 1130, according to some embodiments. In some embodiments, the add period menu 1130 may be displayed to a user in response to the user clicking or otherwise selecting the icon 1105 from the illustrative page 1100A in the example of FIG. 11A. The add period menu 1130 may allow the user to specify one or more time periods in addition to a time period already specified via the menu 1103, so that data corresponding to multiple time periods may be shown simultaneously in the trend display 1111.

In some embodiments, an add period button 1131 may be provided to allow a user to add a time period. Each added time period may be represented by a corresponding row (e.g. 1133a or 1133b). In some embodiments, each row may include an icon for deleting the row from the add period menu 1130. Once a time period is deleted, a corresponding data series may disappear from the trend display 1111.

In some embodiments, an additional time period may have a same length as a time period already specified via the menu 1103, so that a user may simply select a start time (or an end time) for the additional time period. However, that is not required, as in some embodiments the user may specify both a start time and an end time for an additional time period, and the additional time period and the time period specified via the menu 1103 may be of unequal lengths.

In the example of FIG. 11E, a calendar 1135 may be provided to allow a user to select a start time for an additional time period. The user may navigate through different months and/or years to select a desired start date. In some embodiments, an option 1137 may be provided to allow the user to easily select a current date. Additionally, or alternatively, one or more other input features (e.g., text boxes, radio buttons, etc.) may be used to specify time, day, month, and/or year.

In some embodiments, in response to a user specifying one or more additional time periods using the add period menu 1130, the trend display 1111 may be refreshed to show one or more series of data corresponding, respectively, to the one or more additional time periods. The icon 1105 may be updated to indicate a number of additional time periods for which data is shown in the trend display 1111 (e.g., as shown in FIG. 11F).

FIG. 11F shows an illustrative page 1100F that is similar to the page 1100A in the example of FIG. 11A, except the trend display 1111 has been populated with a plurality of series of data from data sources in the object tree 1109. For instance, an object 1110 is selected, and data from the object 1110 is represented by a plot 1145b in the trend display 1111. A corresponding visual indicium 1143b may be shown in the area 1113. In some embodiments, the plot 1145b and the visual indicium 1143b may have a same or similar color, so that a user may easily recognize that the plot 1145b and the visual indicium 1143b correspond to the same data source.

In some embodiments, plots (e.g., 1145a-b) in the trend display 1111 may be visually distinguished from each other, for example, using different colors, line styles, labels, etc. A legend 1141 may be provided to indicate which data source and/or time period correspond to which plot. In some embodiments, a user may click or otherwise select a data series in the legend 1141 to hide/show a corresponding plot.

In some embodiments, plots in the trend display 1111 may be visually distinguished from each other using different colors. For instance, a base color (e.g., blue, green, red, etc.) may be automatically selected for each data source (e.g., the object 1110 in the object tree 1109), and plots corresponding to different time periods of a same data source may be shown using different shades of a same base color. Alternatively, a base color (e.g., blue, green, red, etc.) may be automatically selected for each time period, and plots corresponding to different data sources in a same time period may be shown using different shades of a same base color.

In some embodiments, plots corresponding to a time period (e.g. a most recent time period) may be visually distinguished from those corresponding to other time periods. For example, the trend display 1111 may show most recent series for all data sources using various shades of red, all except the most recent series for a first data source using shades of blue, all except the most recent series for a second data source using shades of green, etc.

Any one or more of the above-described techniques may be used to visually distinguish data from various data sources and/or time periods. This may reduce a level of cognitive effort required on the part of a user to interpret multi-dimensional data sets. However, it should be appreciated that aspects of the present disclosure are not limited to the use of any particular technique to display multi-dimensional data sets.

In some embodiments, a user may be given an option to add all filled properties to view trends in all available data in a selected portion of the object tree 1109, for example a portion representing a meter category. In some embodiments, this option may add data from available data sources in the selected portion of the object tree 1109 to the trend display 1111. In some embodiments, corrected data may be represented by a line that is dashed or otherwise visually distinct from the other trend line(s), which may be solid lines by default.

In some embodiments, the user may be given an option to use data from one object in the object tree 1109 as context for data from a second object. For example, the user may be able to select a first chiller in a data center to see a trend in an amount of resource used by the first chiller. The user may then select a second chiller to use as context and view a difference between resource consumption for the two chillers. In some embodiments, an asset used for context may be in a different site, for example, to provide easy comparison across sites. In some embodiments, the user may select a site in the object tree 1109, and the consumption management system may use all or a portion of data collected from the selected site as context for trends being viewed by the user. The inventors have recognized and appreciated that context selection may be provided to allow easy selection of multiple similar points of data from multiple similar sources. However, it should be appreciated that aspects of the present disclosure are not so limited.

In the example of FIG. 11F, a clear button 1115 is provided to allow a user to clear all data source selections, which may also clear the trend display 1111 and the area 1113.

FIG. 11G shows an illustrative page 1100G of a trend viewer dashboard, in accordance with some embodiments. In this example, the page 1100G includes a presets menu 1147 for configuring trend viewer presets. For instance, a user may bring up the presets menu 1147 by clicking or otherwise activating a configuration button 1150 in the page 1100G.

In some embodiments, the preset menu 1147 may allow a user to create custom presets, which may be added to the object tree 1109 as data objects. The user may create a custom preset from scratch, or by duplicating an existing preset from a list 1149 of existing presets and making one or more desired changes. Additionally, or alternatively, the user may use the preset menu 1147 to view, edit, and/or delete an existing preset from the list 1149.

In some embodiments, the preset menu 1147 may include text boxes 1151a and/or 1151b to allow a user to enter, view, and/or change a name and/or a label for a preset. In some embodiments, the name of the preset may be displayed in the list 1149 of existing presets (which may be used primarily by a user who configures presets), whereas the label of the preset may be displayed in the object tree 1109 (which may be used primarily by a user who views presets). However, it should be appreciated that aspects of the present disclosure are not limited to having both a name and a label. In some embodiments, a same text string may be used in the list 1149 of existing presets and in the object tree 1109 to denote a preset.

In some embodiments, a preset, once created, may be available in the object tree 1109 at multiple levels. For instance, in the example of 1147, “Preset_0” may be available both at the node “Texas” (shown at 1157a), and at the node “Lufkin IT Bldg” (shown at 1157b). Selecting “Preset_0” at the node “Texas” may cause display of data aggregated from all nodes descending from “Texas,” whereas selecting “Preset_0” at the node “Lufkin IT Bldg” may cause display of data aggregated from all nodes descending from “Lufkin IT Bldg.” In some embodiments, such aggregated data may be kept up-to-date (e.g., refreshed periodically), for example, to reduce response time when a user wishes to view the preset in the trend viewer dashboard.

In some embodiments, the preset menu 1147 may include a filter section 1153 for allowing a user to indicate which one or more nodes in the object tree 1109 to include when aggregating data for a preset. As one example, a filter criterion may indicate that a node should be included if a name of the node (or a name of a parent of the node) is equal to, not equal to, or contains a certain text string. As another example, a filter criterion may indicate that a node should be included if a type of the node (or a type of a parent of the node) is equal to or not equal to a certain node type, as shown at a dropdown menu 1159 in an illustrative page 1100H in the example of FIG. 11H. As another examples, multiple filter criteria may be combined using one or more logical operators such as AND, OR, XOR, etc.

In some embodiments, the preset menu 1147 may include a data source section 1155 for allowing a user to indicate which one or more data sources in the object tree 1109 to include when aggregating data for a preset. As discussed in connection with FIG. 1, a data source may include measured data, or data derived from measured data (e.g., maximum, minimum, rolling average, etc. over some past period).

In some embodiments, the data source section 1155 may include a text box 1161 for entering an identifier of a data source. FIGS. 11I-11J show, respectively, illustrative pages 1100I-J with an autocomplete menu 1163, in accordance with some embodiments. The autocomplete menu 1163 may assist a user with entering a data source identifier in a selected format. For instance, as the user types, the autocomplete menu 1163 may present the user with one or more options that begin with a string typed in by the user so far. Thus, as the user types in a longer string (e.g., as shown in FIG. 11J), fewer options may remain in the autocomplete menu 1163.

In some embodiments, options presented by the autocomplete menu 1163 may depend on one or more filter criteria indicated in the filter section 1153. For instance, the autocomplete menu 1163 may present identifiers of only those data sources available in one or more nodes matching the one or more filter criteria. Additionally, or alternatively, a browse button may be provided to allow a user to browse all data sources available in one or more nodes matching the one or more filter criteria. In this manner, fewer options may be presented to the user, which may reduce a level of cognitive effort required on the part of the user to identify a desired data source.

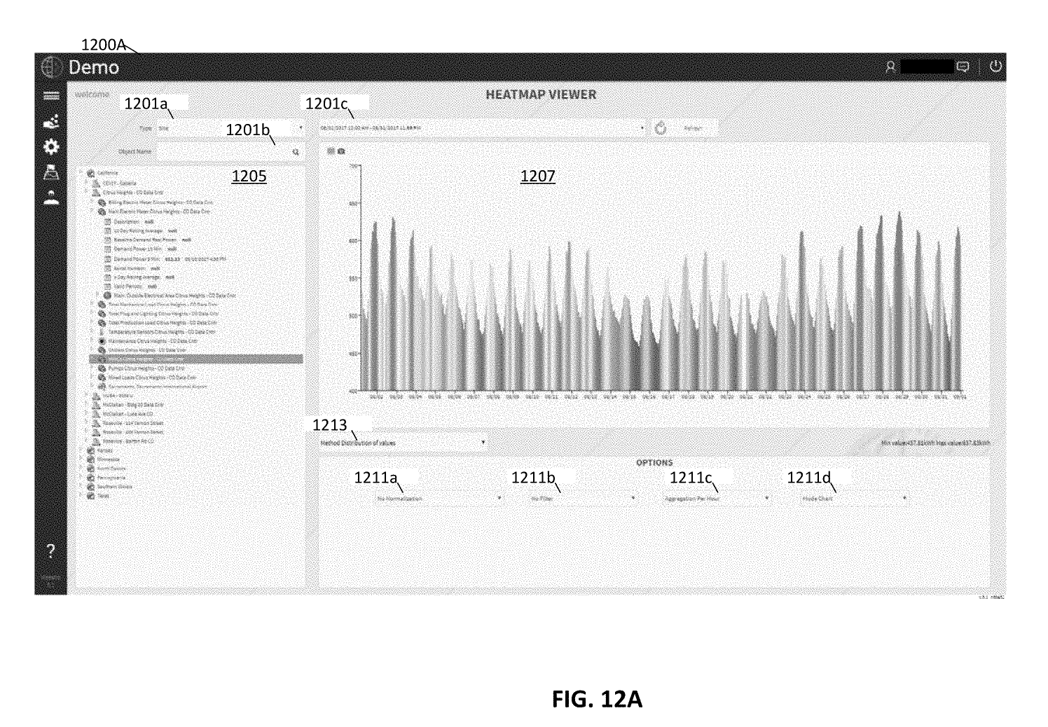

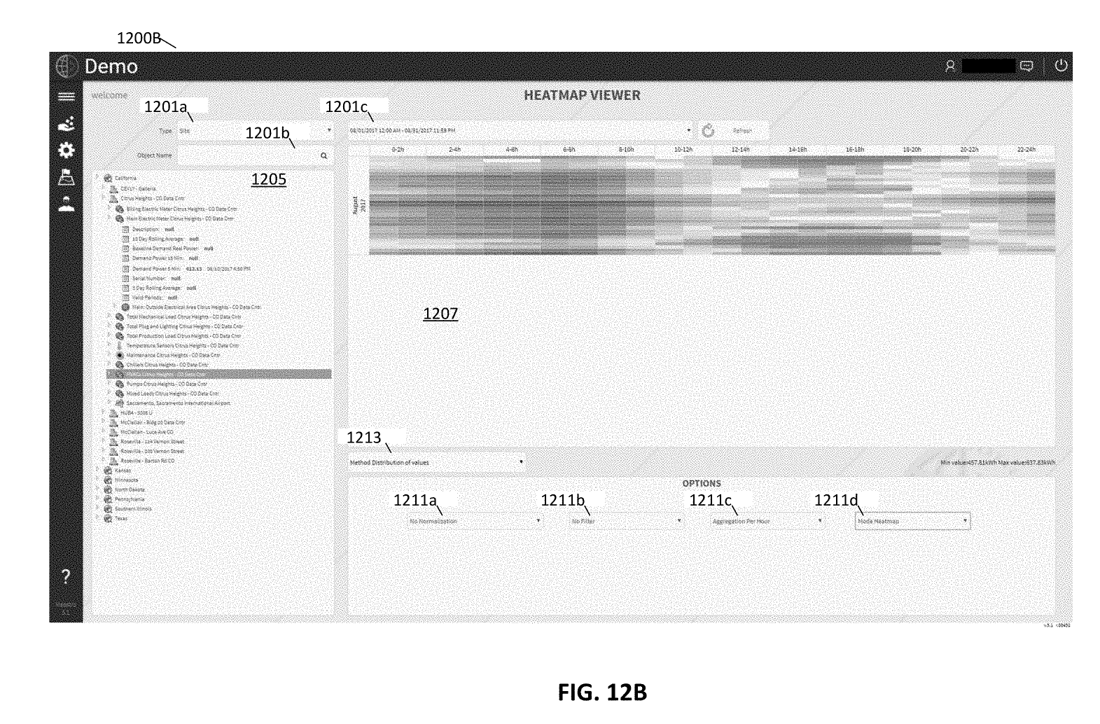

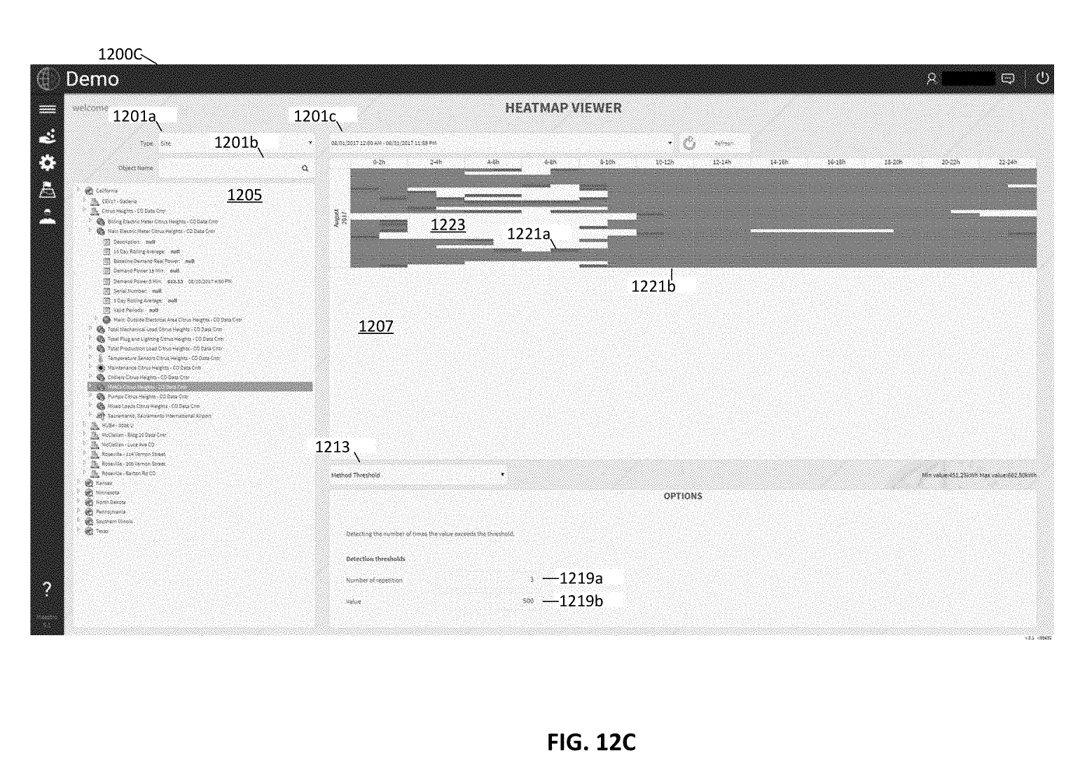

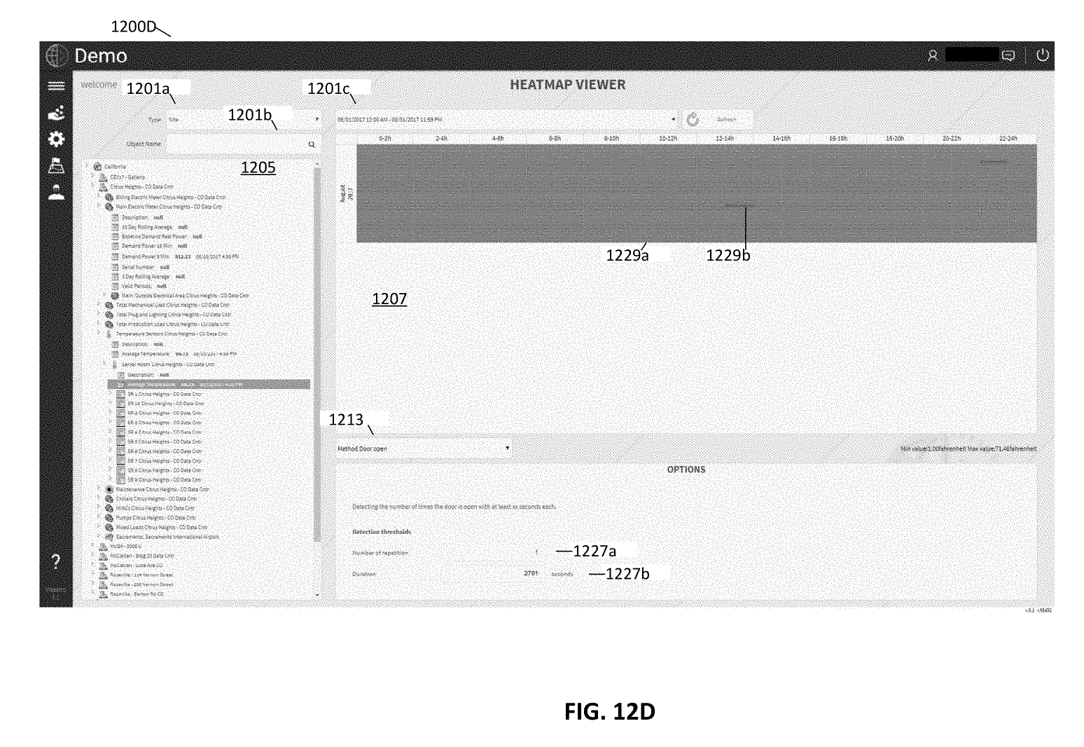

FIGS. 12A-12D show, respectively, illustrative pages 1200A-D of a heat map viewer dashboard, in accordance with some embodiments. For instance, the page 1200A may be a version of a landing page that a user may reach by activating a heat map viewer option from a side menu, such as the side menu of the illustrative page 700A in the example of FIG. 7A. The pages 1200B-D may be reached from the page 1200A by activating one or more user interface features.

In some embodiments, the heat map viewer dashboard may use a color gradient (e.g., from red to orange, to yellow, to chartreuse, to green) to display different data points in a data series. For instance, the color gradient may include a plurality of colors, starting with a first color (e.g., red) and ending with a second color (e.g., green). The first color may be used to display a data point having a maximum value in the data series, whereas the second color may be used to display a data point having a minimum value in the data series. A range between the maximum value and the minimum value may be divided into a plurality of equal intervals, such that there are as many intervals as there as colors in the color gradient, and each interval corresponds to a respective color in an order-preserving manner. Thus, a user may be able to see, at one glance, where in a data series extreme (or moderate) values occur. For instance, an average data value may be shown in yellow, whereas a data value far above (or far below) average may be shown in red (or green).

In some embodiments, the page 1200A may include an object tree 1205, which may be similar to the object tree 1109 in the example of FIG. 11A. The heat map viewer dashboard may allow a user to select one or more data sources from the object tree 1205, for example, using one or more user interface features similar to those described with reference to FIG. 11A. For instance, filters 1201a-b may be provided that are similar to, respectively, the filters 1101a-b in the example of FIG. 11A. Likewise, the heat map viewer dashboard may allow a user to select a time period for which to display data, for example, using one or more user interface features similar to those described with reference to FIG. 11A. For instance, a menu 1201c may be provided that is similar to the menu 1103 in the example of FIG. 11A.

In some embodiments, the page 1200A may include a heat map display 1207, and/or one or more user interface features for configuring the heat map display 1207. For instance, there may be a menu 1213 for selecting a display method. Examples of display methods include, but are not limited to, distribution of values, threshold, and door open.

In some embodiments, one or more options may be provided when the distribution of values display method is selected. As one example, a user may use an option menu 1211a to choose whether to normalize data points, and/or which normalization method to use (e.g., normalize with respect to site area or air temperature). The inventors have recognized and appreciated that normalized data may allow more meaningful comparisons between different data series. For instance, a large site may consume more resource for cooling purposes than a small site, even if the large site is running more efficiently than the small site. Normalizing with respect to site area may allow a more meaningful comparison between the two sites.

As another example, a user may use an option menu 1211b to choose whether to filter data, and/or which filter method to use (e.g., based on time, load category, equipment type, etc.). For instance, the option menu 1211b may allow the user to include open hours only, or closing hours only. In this manner, the user may focus on time periods with similar conditions, which may allow the user to spot trends that may otherwise be missed if there is no filtering.

As another example, a user may use an option menu 1211c to choose a granularity of data. For instance, the user may choose to aggregate all data points from a same hour (e.g., a same day) into a single data point, and display only the aggregated data points. Any suitable aggregation method may be used, such as average (mean, medium, or mode), sum, maximum, minimum, etc. Upon the user's selection, the heat map display 1207 may be updated so that a smallest visual unit represents a selected aggregation time period.

As another example, a user may use an option menu 1211d to choose a display mode (e.g., chart vs. heat map). FIG. 12B shows an illustrative page 1200B that is similar to the page 1200A in the example of FIG. 12A, except the heat map display 1207 is set to a heat map mode in FIG. 12B, as opposed to a chart mode in FIG. 12A.

In the example of FIG. 12B, the heat map display 1207 shows a grid in which each row represents a time period (e.g., a day), and each column represents a smaller time period (e.g., an hour in the day). Thus, each block in the grid may correspond to a particular time period (e.g., a particular one-hour period on a particular day), and a color of that block may correspond to an aggregate data value (e.g., total resource consumption, average temperature, etc.) for that particular time period. In this manner, a user may be able to see, at one glance, where in a data series extreme (or moderate) values occur. For instance, in the example of FIG. 12B, higher values may be observed in the afternoons at a beginning of August 2017 and towards an end of the same month.

FIG. 12C shows an illustrative page 1200C that is similar to the page 1200A in the example of FIG. 12A, except the heat map display 1207 is set to use the threshold display method in FIG. 12C, as opposed to the distribution of values display method in FIG. 12A.

In some embodiments, one or more options may be provided when the threshold display method is selected (e.g., via the menu 1213). In the example shown in FIG. 12C, a text box 1219b may be provided to allow a user to enter a value threshold against which values in a data series may be compared. For instance, one or more values reported during a time period corresponding to a block in the grid shown in the heat map display 1207 may be compared against the value threshold, and a count of one or more values that exceed the value threshold may be obtained. If this count exceeds a frequency threshold provided by the user via a text box 1219b, the corresponding block in the heat map display 1207 may be shown in a first color (e.g., red, as shown at 1221b). If the count is non-zero, but does not exceed the frequency threshold, the corresponding block may be shown in a second color (e.g., green, as shown at 1221a). If the count is zero, the corresponding block may be blank (e.g., as shown at 1223). In this manner, time periods exhibiting different behaviors may be visually distinguished.

FIG. 12D shows an illustrative page 1200D that is similar to the page 1200A in the example of FIG. 12A, except the heat map display 1207 is set to use the door open display method in FIG. 12D, as opposed to a distribution of values display method in FIG. 12A.

In some embodiments, the door open display method may be used to illustrate frequency and/or duration of wasteful events, such as an exterior door of an air-conditioned or heated space being left open. One or more options may be provided when the door open display method is selected (e.g., via the menu 1213). For instance, text boxes 1227a-b may be provided to allow a user to enter, respectively, a frequency threshold and a duration threshold. If, during a time period corresponding to a block in the grid shown in the heat map display 1207, a door is left open for a duration longer than the duration threshold (e.g., 2701 seconds) X number of times, and X is greater than the frequency threshold (e.g., 1), the corresponding block in the heat map display 1207 may be shown in a first color (e.g., red, as shown at 1229a). If X is non-zero, but does not exceed the frequency threshold, the corresponding block may be shown in a second color (e.g., green, as shown at 1229b). If X is zero, the corresponding block may be blank.

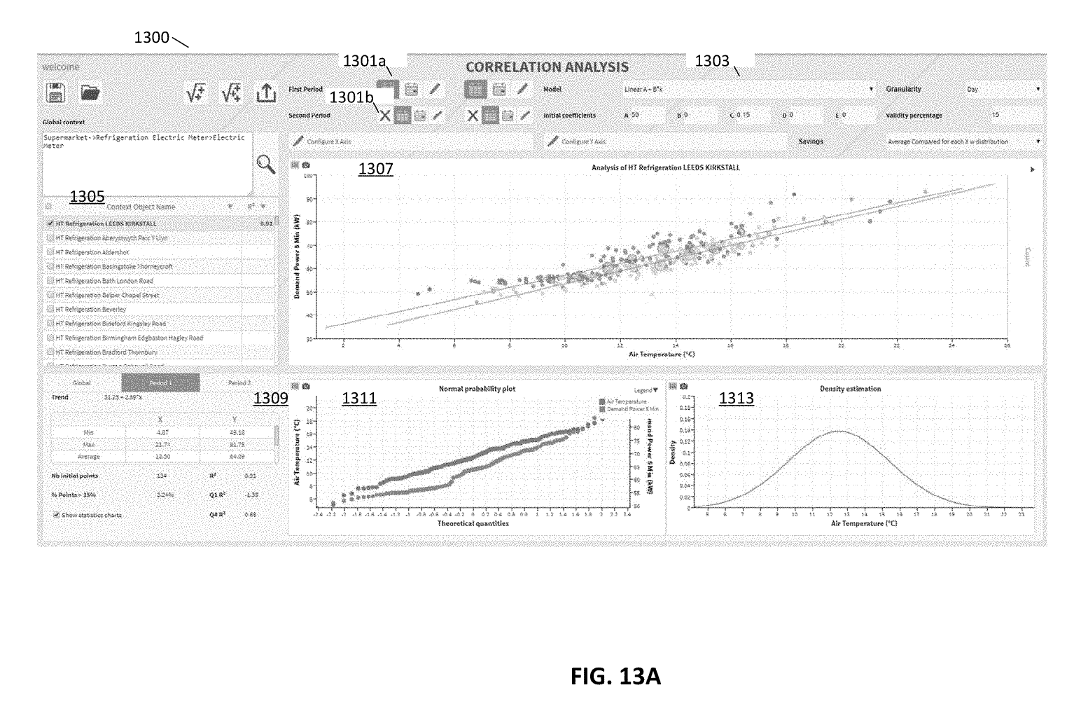

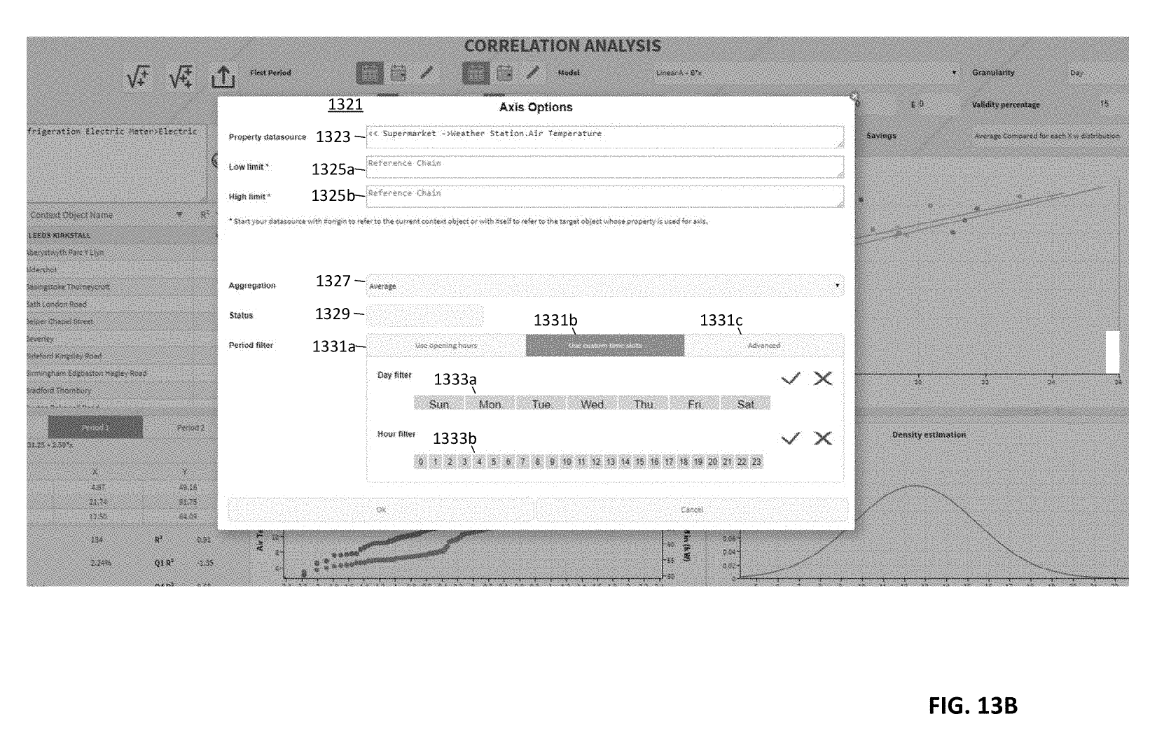

FIG. 13A shows an illustrative page 1300A of a correlation dashboard, according to some embodiments. The correlation dashboard may allow a user to perform in-depth statistical analysis with customizable model types, granularities, input variables, and/or statistical coefficients. For instance, the correlation dashboard may allow the user to create and/or interact with statistical regression models, for example, between air temperature and demand power for refrigeration assets. In some embodiments, the correlation dashboard may provide a regression display, a normal probability plot, and/or a probability density estimation for one or more selected data sources. Modeling may be automated, for example, to provide evaluation of accuracy and/or scalability of a correlation model between relevant sites of an enterprise. For example, models may be evaluated using a selected group of sites, assets, and/or data sources which exhibit similar characteristics.

In the example shown in FIG. 13A, a user may use input areas 1301a-b to select time periods to be used in statistical modeling. Additionally, or alternatively, the user may use input area 1303 to specify a type of model (e.g., linear or higher degree polynomial regression) and/or one or more parameters. An input area 1305 may allow the user to select a data source to be modeled. The user may select any suitable data source, for example, any object in an object tree. A display 1307 may show a result of applying a model selected in the input area 1303 to the data source selected in the input area 1305 for both time periods selected in the input areas 1301a-b. Each time period may be a separate data series on which the selected model is applied. In some embodiments, the user may select an independent variable, and compare the selected data source against the independent variable. In some embodiments, air temperature may be provided as a default independent variable, although that is not required.

In the example shown in FIG. 13A, the correlation dashboard includes a table 1309 of summary statistics for the selected data source and time periods. Additionally, or alternatively, the correlation dashboard may include a normal probability display 1311 shows a normal probability plot, and/or a probability density estimation display 1313 shows an estimated probability density function, for the selected data source.

FIG. 13B shows an illustrative page 1300B for configuring an axis of the illustrative display 1307 in the example of FIG. 13A. In some embodiments, an axis may be configured by selecting a property data source (1323), a lower limit data source (1325a), and/or a lower limit data source (1325b). The data sources may be specified in any suitable manner, for example, as was discussed with reference to the illustrative data source section 1155 of FIG. 11G. In some embodiments, the user may specify an aggregation method using input 1327, for example, as discussed with reference to FIG. 11B. Additionally, or alternatively, the user may specify a status (1329), and/or a time period (e.g., using interface features 1331a-c and 1333a-b, for example, as discussed with reference to FIGS. 11D-E).

It should be appreciated that the various user interface features shown in the drawings and described herein are provided solely for purposes of illustration, as aspects of the present disclosure are not limited to the use of any particular user interface feature. Furthermore, such user interface features may be used in any suitable combination and/or for any suitable purpose. In some embodiments, one or more of the illustrative pages shown in the drawings and described herein may be adapted to display savings in maintenance costs, in addition to, or instead of, resource consumption.

As one example, one or more pages displaying consumption management event values (e.g., monetary amounts and/or amounts of resource) may be adapted to display, additionally, or alternatively, savings in maintenance costs achieved by implementing one or more maintenance improvement measures. Similarly, one or more pages displaying a list of consumption management events may be adapted to display, additionally, or alternatively, a list of maintenance management events, where each maintenance management event may include one or more maintenance improvement measures. In some embodiments, a toggle button (e.g., with a wrench icon) may be provided to allow a user to switch from a consumption management view to a maintenance management view.

As another example, a site plan dashboard may be provided to display building information and/or equipment information (e.g., age of building or equipment, condition of building or equipment, equipment manufacturer details, etc.). For instance, one or more floor plans for a building may be displayed in response to a user selecting a building from a site map. In some embodiments, equipment information for the building may be displayed alongside a floor plan.

As another example, a maintenance performance dashboard may be provided to display one or more key performance indicators that are related to maintenance. Any one or more suitable representations of data may be used, such as progress bars, speedometer graphs, etc. This may allow a user to see, at one glance, whether any maintenance-related improvements may be made.

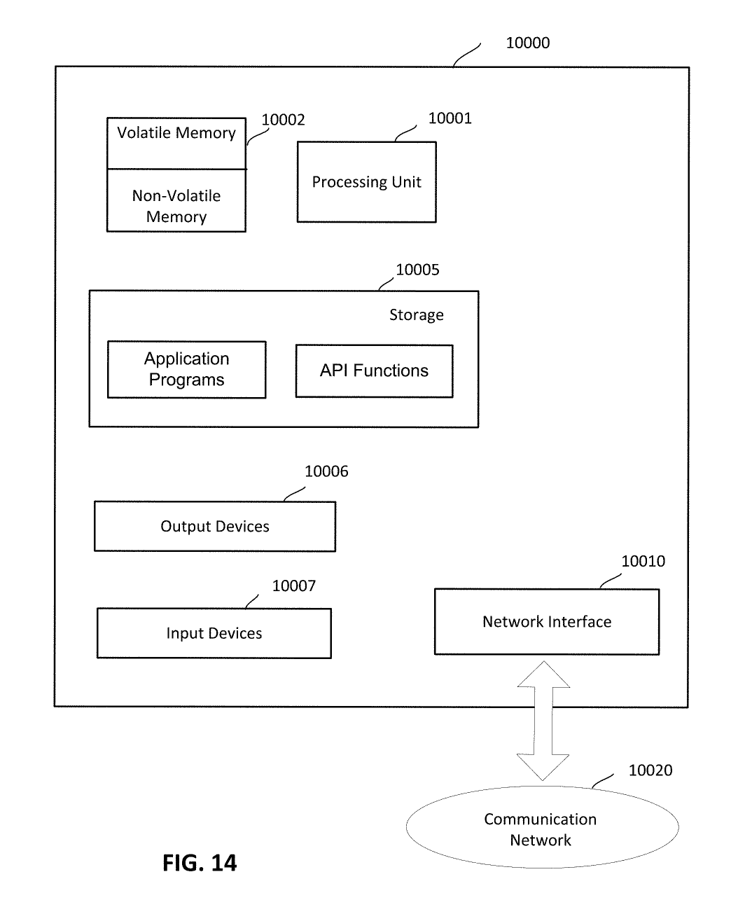

FIG. 14 shows, schematically, an illustrative computer 10000 on which any aspect of the present disclosure may be implemented. In the embodiment shown in FIG. 14, the computer 10000 includes a processing unit 10001 having one or more processors and a non-transitory computer-readable storage medium 10002 that may include, for example, volatile and/or non-volatile memory. The memory 10002 may store one or more instructions to program the processing unit 10001 to perform any of the functions described herein. The computer 10000 may also include other types of non-transitory computer-readable medium, such as storage 10005 (e.g., one or more disk drives) in addition to the system memory 10002. The storage 10005 may also store one or more application programs and/or external components used by application programs (e.g., software libraries), which may be loaded into the memory 10002.

The computer 10000 may have one or more input devices and/or output devices, such as devices 10006 and 10007 illustrated in FIG. 14. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, the input devices 10007 may include a microphone for capturing audio signals, and the output devices 10006 may include a display screen for visually rendering, and/or a speaker for audibly rendering, recognized text.

As shown in FIG. 14, the computer 10000 may also comprise one or more network interfaces (e.g., the network interface 10010) to enable communication via various networks (e.g., the network 10020). Examples of networks include a local area network or a wide area network, such as an enterprise network or the Internet. Such networks may be based on any suitable technology and may operate according to any suitable protocol and may include wireless networks, wired networks or fiber optic networks.

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing description and drawings are by way of example only.

The above-described embodiments of the present disclosure can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure discussed above. The computer-readable medium or media can be transportable, such that the program or programs stored thereon can be loaded onto one or more different computers or other processors to implement various aspects of the present disclosure as discussed above.

The terms “program” or “software” are used herein to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various features and aspects of the present disclosure may be used alone, in any combination of two or more, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

In some embodiments, one or more of the following aspects may be provided, in any suitable combination.

1. A consumption management system comprising: at least one storage medium storing data associated with a hierarchical display layout, the hierarchical display layout comprising first, second, and third areas, wherein each of the second and third areas is nested within the first area; and at least one processor programmed to: detect a display size; determine a size of the first area based at least in part on the detected display size; and determine a size of the second area based at least in part on a size of the first area and stored data associated with the second area.
2. The system of aspect 1, wherein the at least one processor is further programmed to monitor for changes in display size; and in response to detecting a change in display size, repeat (b) and (c).
3. The system of aspect 1, wherein: the second and third areas are arranged vertically in the first area; and the at least one processor programmed to determine a height of the second area based at least in part on a height of the first area and the stored data associated with the second area.
4. The system of aspect 1, wherein: the second and third areas are arranged horizontally in the first area; and the at least one processor programmed to determine a width of the second area based at least in part on a width of the first area and the stored data associated with the second area.
5. The system of aspect 1, wherein: the hierarchical display layout further comprises fourth and fifth areas; and each of the fourth and fifth areas is nested within the second area.
6. The system of aspect 1, wherein the at least one processor is programmed to determine the size of the second area as a proportion of the size of the first area.
7. The system of aspect 6, wherein the at least one processor is programmed to determine the proportion based on the stored data associated with the second area.
8. The system of aspect 1, wherein the at least one processor is programmed to determine the size of the second area based at least in part on the size of the first area, a size of the third area, and the stored data associated with the second area.
9. The system of aspect 8, wherein the at least one processor is programmed to: determine the size of the third area based on stored data associated with the third area; and determine the size of the second area based at least in part on a difference between the size of the first area and the size of the third area.
10. The system of aspect 1, wherein the at least one processor is further programmed to: cause at least one user interface feature to be displayed in the second area, wherein a size of the at least one user interface feature matches the size of the second area.
11. The system of aspect 1, wherein the at least one processor is further programmed to: select, based at least in part on the detected display size, the display layout from a plurality of candidate layouts.
12. The system of aspect 11, wherein the at least one processor is further programmed to select the display layout from the plurality of candidate layouts at least in part by: comparing the detected display size against at least one threshold.
13. The system of aspect 11, wherein: the plurality of candidate layouts comprises a first layout comprising a first plurality of user interface features; and the plurality of candidate layouts further comprises a second layout comprising a second plurality of user interface features different from the first plurality of user interface features.
14. A method performed by the system of any of aspects 1-13.
15. At least one computer-readable storage medium storing executable instructions that, when executed, cause at least one processor to perform the method of aspect 14.
16. A consumption management system comprising: at least one storage medium storing a plurality of event records corresponding, respectively, to a plurality of consumption management events, wherein each event record of the plurality of event records comprises: information indicative of a current state of the corresponding consumption management event; and information indicative of a time at which the corresponding consumption management event moved into the current state from a prior state; at least one processor programmed to cause a state transition diagram to be displayed based on at least event record of the plurality of event records, wherein: the state transition diagram comprises a plurality of states and a plurality of transitions; the plurality of states comprises a first state and a second state; and the plurality of transitions comprises a transition from the first state to the second state.
17. The consumption management system of aspect 16, wherein the at least one processor is programmed to cause the first state to be displayed with a label indicative of a number of consumption management events that are currently in the first state.
18. The consumption management system of aspect 17, wherein the at least one processor is further programmed to: receive user input indicative of one or more filter criteria; and in response to receiving the user input indicative of the one or more filter criteria, update the label to indicate a number of consumption management events that match the one or more filter criteria and are currently in the first state.
19. The consumption management system of aspect 16, wherein the at least one processor is programmed to cause the transition to be displayed with a label indicative of a number consumption management events that moved from the first state to the second state over a selected period of time.
20. The consumption management system of aspect 19, wherein the selected period of time is a first period of time, and wherein the at least one processor is further programmed to: receive user input indicative of a second period of time; and in response to receiving the user input indicative of the second period of time, update the label to indicate a number of consumption management events that moved from the first state to the second state over the second period of time.
21. The consumption management system of aspect 16, wherein the at least one processor programmed to cause the first state to be displayed with a label indicative of a dwell time for the first state.
22. The consumption management system of aspect 21, wherein the at least one processor is further programmed to calculate the dwell time for the first state at least in part by taking an average, over all consumption management events that are currently in the first state, of an amount of time a consumption management event has spent in the first state.
23. The consumption management system of aspect 21, wherein the at least one processor is further programmed to calculate the dwell time for the first state at least in part by taking an average, over all consumption management events that moved through the first state over a selected period of time, of an amount of time a consumption management event spent in the first state.

What is claimed is:

1. A consumption management system comprising:
at least one storage medium storing a plurality of event records corresponding, respectively, to a plurality of consumption management events, wherein each event record of the plurality of event records comprises:
information indicative of a current state of the corresponding consumption management event; and
information indicative of a time at which the corresponding consumption management event moved into the current state from a prior state; and
at least one processor programmed to cause a state transition diagram to be displayed based on at least one event record of the plurality of event records, wherein:
the state transition diagram comprises a plurality of states and a plurality of transitions;
the plurality of states comprises a first state and a second state; and
the plurality of transitions comprises a transition from the first state to the second state.

2. The consumption management system of claim 1, wherein the at least one processor is programmed to cause the first state to be displayed with a label indicative of a number of consumption management events that are currently in the first state.

3. The consumption management system of claim 2, wherein the at least one processor is further programmed to:
receive user input indicative of one or more filter criteria; and
in response to receiving the user input indicative of the one or more filter criteria, update the label to indicate a number of consumption management events that match the one or more filter criteria and are currently in the first state.

4. The consumption management system of claim 1, wherein the at least one processor is programmed to cause the transition to be displayed with a label indicative of a number consumption management events that moved from the first state to the second state over a selected period of time.

5. The consumption management system of claim 4, wherein the selected period of time is a first period of time, and wherein the at least one processor is further programmed to:
receive user input indicative of a second period of time; and
in response to receiving the user input indicative of the second period of time, update the label to indicate a number of consumption management events that moved from the first state to the second state over the second period of time.

6. The consumption management system of claim 1, wherein the at least one processor programmed to cause the first state to be displayed with a label indicative of a dwell time for the first state.

7. The consumption management system of claim 6, wherein the at least one processor is further programmed to calculate the dwell time for the first state at least in part by taking an average, over all consumption management events that are currently in the first state, of an amount of time a consumption management event has spent in the first state.

8. The consumption management system of claim 6, wherein the at least one processor is further programmed to calculate the dwell time for the first state at least in part by taking an average, over all consumption management events that moved through the first state over a selected period of time, of an amount of time a consumption management event spent in the first state.

9. A consumption management method comprising:
storing, using at least one storage medium, a plurality of event records corresponding, respectively, to a plurality of consumption management events, wherein each event record of the plurality of event records comprises:
information indicative of a current state of the corresponding consumption management event; and
information indicative of a time at which the corresponding consumption management event moved into the current state from a prior state; and
causing, using at least one processor, a state transition diagram to be displayed based on at least one event record of the plurality of event records, wherein:
the state transition diagram comprises a plurality of states and a plurality of transitions;
the plurality of states comprises a first state and a second state; and
the plurality of transitions comprises a transition from the first state to the second state.

10. The consumption management method of claim 9, further comprising:
causing, using the at least one processor, the first state to be displayed with a label indicative of a number of consumption management events that are currently in the first state.

11. The consumption management method of claim 10, further comprising:
receiving user input indicative of one or more filter criteria; and
in response to receiving the user input indicative of the one or more filter criteria, updating, using the at least one processor, the label to indicate a number of consumption management events that match the one or more filter criteria and are currently in the first state.

12. The consumption management method of claim 9, further comprising:
causing, using the at least one processor, the transition to be displayed with a label indicative of a number consumption management events that moved from the first state to the second state over a selected period of time.

13. The consumption management method of claim 12, wherein the selected period of time is a first period of time, and wherein the method further comprises:
receiving user input indicative of a second period of time; and
in response to receiving the user input indicative of the second period of time, updating, using the at least one processor, the label to indicate a number of consumption management events that moved from the first state to the second state over the second period of time.

14. The consumption management method of claim 9, further comprising:
causing, using the at least one processor, the first state to be displayed with a label indicative of a dwell time for the first state.

15. The consumption management method of claim 14, further comprising:
calculating, using the at least one processor, the dwell time for the first state at least in part by taking an average, over all consumption management events that are currently in the first state, of an amount of time a consumption management event has spent in the first state.

16. The consumption management method of claim 14, further comprising:
calculating, using the at least one processor, the dwell time for the first state at least in part by taking an average, over all consumption management events that moved through the first state over a selected period of time, of an amount of time a consumption management event spent in the first state.

17. At least one computer-readable storage medium storing executable instructions that, when executed, cause at least one processor to perform the method of:
storing a plurality of event records corresponding, respectively, to a plurality of consumption management events, wherein each event record of the plurality of event records comprises:
information indicative of a current state of the corresponding consumption management event; and
information indicative of a time at which the corresponding consumption management event moved into the current state from a prior state; and
causing a state transition diagram to be displayed based on at least one event record of the plurality of event records, wherein:
the state transition diagram comprises a plurality of states and a plurality of transitions;
the plurality of states comprises a first state and a second state; and
the plurality of transitions comprises a transition from the first state to the second state.

18. The at least one computer-readable storage medium of claim 17, wherein the method further comprises:
causing, using the at least one processor, the first state to be displayed with a label indicative of a number of consumption management events that are currently in the first state.

19. The at least one computer-readable storage medium of claim 18, wherein the method further comprises:
receiving user input indicative of one or more filter criteria; and
in response to receiving the user input indicative of the one or more filter criteria, updating the label to indicate a number of consumption management events that match the one or more filter criteria and are currently in the first state.

20. The at least one computer-readable storage medium of claim 17, wherein the method further comprises:
causing the transition to be displayed with a label indicative of a number consumption management events that moved from the first state to the second state over a selected period of time.

21. The at least one computer-readable storage medium of claim 20, wherein the selected period of time is a first period of time, and wherein the method further comprises:
receiving user input indicative of a second period of time; and
in response to receiving the user input indicative of the second period of time, updating the label to indicate a number of consumption management events that moved from the first state to the second state over the second period of time.

22. The at least one computer-readable storage medium of claim 17, wherein the method further comprises:
causing the first state to be displayed with a label indicative of a dwell time for the first state.

23. The at least one computer-readable storage medium of claim 22, wherein the method further comprises:
calculating the dwell time for the first state at least in part by taking an average, over all consumption management events that are currently in the first state, of an amount of time a consumption management event has spent in the first state.

24. The at least one computer-readable storage medium of claim 22, wherein the method further comprises:
calculating the dwell time for the first state at least in part by taking an average, over all consumption management events that moved through the first state over a selected period of time, of an amount of time a consumption management event spent in the first state.
